(19) United States
(12) Patent Application Publication
(10) Pub. No.: US 2026/0120491 A1
(43) Pub. Date: Apr. 30, 2026

(54) OPTICAL INFORMATION READING DEVICE

(71) Applicant: KEYENCE CORPORATION, Osaka (JP)

(72) Inventor: Shusuke Oki, Osaka-shi (JP)

(73) Assignee: KEYENCE CORPORATION, Osaka (JP)

(21) Appl. No.: 19/371,487

(22) Filed: Oct. 28, 2025

(30) Foreign Application Priority Data
Oct. 29, 2024 (JP) 2024-189623

(51) Int. Cl. G06V 30/14; G06V 30/142; G06V 30/146; G06V 30/19

(52) U.S. Cl. CPC G06V 30/1444; G06V 30/142; G06V 30/1468; G06V 30/1473; G06V 30/19093

(57) ABSTRACT

To provide an optical information reading device capable of narrowing down to the character strings to be output from multiple character strings attached to a target object. The imaging unit 31 of the optical information reading device 10 captures an image of the target object 11 with multiple character strings attached as a symbol 20, and generates an input image containing the character strings. The character string processing unit of the optical information reading device 10 obtains multiple character string candidates from the input image. Then, the character string processing unit narrows down to the output character string from the multiple character string candidates based on at least one of the character string likelihood indicating the plausibility as a character string, the distance from the aiming position, and the degree of matching with a predetermined format pattern for each of the multiple character string candidates.

### CROSS-REFERENCE TO RELATED APPLICATIONS

The present application claims foreign priority based on Japanese Patent Application No. 2024-189623, filed October 29, 2024, the contents of which are incorporated herein by reference.

### BACKGROUND OF THE INVENTION

### 1. TECHNICAL FIELD

The present disclosure relates to an optical information reading device.

### 2. DESCRIPTION OF THE RELATED ART

A handheld optical reading device, an optical reading method using the handheld optical reading device, and a computer program are disclosed in JP 6403416 B.

The handheld optical information reading device described in JP 6403416 B captures an image of a workpiece with a symbol to be read attached, and performs a reading process on the symbol within the captured image.

Since character recognition is generally more difficult compared to barcode reading, the handheld optical information reading device described in JP 6403416 B requires accurate aiming at the symbol to be read. Here, when considering the use of a machine learning model capable of detecting multiple characters substantially simultaneously from a captured image, if multiple symbols (such as character strings) are included in the image, multiple results are obtained from the reading process. In cases where there are numerous symbols, for the device, it becomes difficult to narrow down which symbol's information should be output, and for the user, the task of selecting which symbol's information should be output becomes cumbersome.

### SUMMARY OF THE INVENTION

In view of the above problem, one of the objectives of the present disclosure is to provide an optical information reading device capable of narrowing down to the output character string to be output from multiple character strings attached to a target object.

According to one aspect of the present disclosure, an optical information reading device is provided that captures an image by setting a aiming position on a target object with multiple character strings attached and reads at least one character string. The optical information reading device comprises: an imaging unit that captures an area within an imaging field of view and generates an input image containing the multiple character strings attached to the target object; a storage unit that stores a machine learning model for detecting multiple characters contained in the input image, with the input image as input; a character string processing unit that obtains multiple character string candidates from the input image based on the multiple characters detected by the machine learning model; wherein the character string processing unit narrows down the multiple character string candidates to the output character string to be output based on at least one of a character string likelihood indicating a plausibility as a character string, a distance from the aiming position in the input image, or a degree of matching with a format pattern predetermined by a user.

According to one aspect of the present disclosure, it becomes possible to narrow down to the output character string to be output from multiple character strings attached to the target object.

### BRIEF DESCRIPTION OF THE DRAWINGS

FIG. 1 is a schematic diagram showing the external appearance of an optical information reading device;

FIG. 2 is a schematic block diagram showing the configuration of an information processing system including the optical information reading device;

FIG. 3 is a schematic block diagram showing the configuration of an imaging module;

FIG. 4 is a schematic block diagram showing the configuration of a control unit;

FIG. 5 is a schematic block diagram showing the configuration of a storage unit;

FIG. 6 is a flowchart showing the overall operation of the optical information reading device;

FIG. 7 is a flowchart showing the order of character detection, character concatenation, and character string narrowing;

FIG. 8 is a diagram showing an example of the procedure for narrowing down to the output character string from multiple characters included in the input image;

FIG. 9 is a diagram explaining the character string margin;

FIG. 10 is a diagram showing a format registration screen;

FIG. 11 is a diagram showing an example of an object with multiple character strings attached;

FIG. 12 is a diagram showing a case where the output character string is narrowed down based on the character string likelihood;

FIG. 13 is a diagram showing a case where the output character string is narrowed down based on the degree of matching with the format pattern;

FIG. 14 is a diagram showing a case where the output character string is narrowed down based on the distance to the aiming position;

FIG. 15 is a schematic diagram showing the correspondence between the AI processing core and the image processing core included in the information processing unit;

FIG. 16 is a diagram showing how the AI processing core and the image processing core operate in parallel;

FIG. 17 is a flowchart showing the flow of character string processing using the first model and the second model;

FIG. 18 is a flowchart showing a part of the character string processing in FIG. 17;

FIG. 19 is a diagram explaining the character string narrowing based on the extending direction of the character string candidate;

FIG. 20 is a diagram showing an example of a first type object with multiple symbols attached;

FIG. 21 is a diagram showing an example of a second type object with multiple symbols attached;

FIG. 22 is a flowchart showing the flow of reading process including relative reading process;

FIG. 23 is a flowchart showing the flow of reading target setting for relative reading process;

FIG. 24 is a diagram showing the reading target setting screen at the start of reading target setting for the first type object;

FIG. 25 is a diagram showing the reading target setting screen in a state ready to accept the user-specified position for the first type object;

FIG. 26 is a diagram showing the reading target setting screen displaying a confirmation message for the specified position setting;

FIG. 27 is a diagram showing the setting status of the reading target for the first type object;

FIG. 28 is a diagram showing a confirmation message for the specified position setting for the second type object;

FIG. 29 is a diagram showing the setting status of the reading targets for the first type object and the second type object.

FIG. 30 is a diagram showing the reading target setting screen in a state displaying a message prompting to launch a user application;

FIG. 31 is a diagram showing an application selection screen;

FIG. 32 is a diagram showing a screen of a user application with multiple input fields;

FIG. 33 is a diagram showing a selection screen for user-specified positions corresponding to input fields;

FIG. 34 is a diagram showing the correspondence between symbols on the object and input fields of the user application;

FIG. 35 is a diagram showing an example of an object with multiple symbols attached in a matrix format;

FIG. 36 is a flowchart showing the flow of matrix processing;

FIG. 37 is a diagram showing an example of an input image obtained when an object is captured in a tilted state;

FIG. 38 is a diagram explaining the first distance between each symbol;

FIG. 39 is a diagram explaining the second distance between each symbol;

FIG. 40 is a diagram showing a case where the first reference point and the second reference point are the same;

FIG. 41 is a diagram showing an example of a pre-setting screen for matrix processing;

FIG. 42 is a diagram showing an example of a format pattern and an input image;

FIG. 43 is a diagram showing an example where structured data is used as master data;

FIG. 44 is a flowchart showing the process of excluding information that does not match the format information;

FIG. 45 is a diagram showing an example where information that does not match the format information is excluded from structured data;

FIG. 46 is a diagram explaining matrix processing considering perspective;

FIG. 47 is a diagram explaining matrix processing considering the angle between symbols.

### DETAILED DESCRIPTION

Hereinafter, embodiments of the present disclosure will be explained with reference to the drawings. In the figures, the same or equivalent parts are denoted by the same reference numerals, and repeated explanations are omitted. Also, in the following description, terms indicating position or direction such as "up", "down", "left", and "right" may be used. These terms are used for convenience to facilitate understanding of the embodiments and, unless explicitly stated otherwise, are not related to the actual direction when implemented.

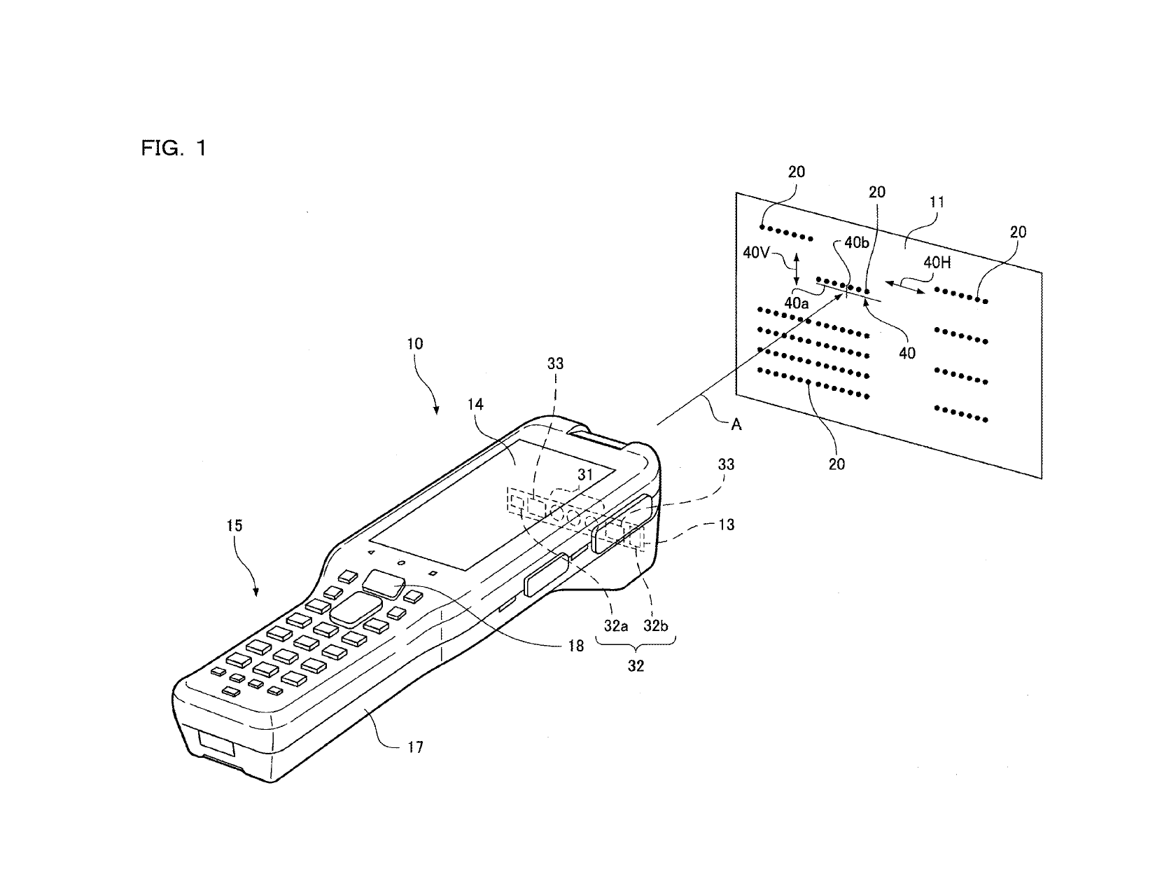

The following describes an optical information reading device 10 according to an example embodiment of the present disclosure with reference to the drawings. First, referring to FIG. 1, the configuration of the optical information reading device 10 will be explained. FIG. 1 is a schematic diagram showing the external appearance of the optical information reading device 10.

The optical information reading device 10 captures an image of the target object 11 to which the symbol 20, which is the reading target, is attached, and reads the symbol information represented by the symbol 20. The symbol 20 is a form that indicates information in an optically readable manner, and standardized codes such as barcodes and two-dimensional codes, or codes of proprietary standards are used as the symbol 20. The symbol 20 can be anything that is optically readable, for example, it may be a character string that directly represents the content of the information in characters or numbers. The symbol 20 is displayed on the surface of an item that is the subject of the operation. For example, the symbol 20 is directly printed on the surface of a commercial product, or a label printed with the symbol 20 is affixed to the surface of the item.

The optical information reading device 10 reads symbol information represented by symbol 20 by decoding encoded symbol information such as barcodes and two-dimensional codes, or by performing OCR (optical character recognition) processing on character strings.

The optical information reading device 10 is a device that can be held and carried in the hand of a user (not shown) who performs tasks using the symbol information represented by the symbol 20, and is sometimes called a handy terminal. The optical information reading device 10 comprises an imaging module 13, a display unit 14, and an operation unit 15. The optical information reading device 10 is covered with a housing 17, and the display unit 14 and the operation unit 15 are provided on the top surface of the housing 17. In addition to the handy terminal as a dedicated device for tasks using the symbol information represented by the symbol 20, a smartphone with application software installed for executing tasks using symbol information may also be used as a smartphone type optical information reading device 10.

The display unit 14 displays various types of information to the user. The display unit 14 is, for example, a liquid crystal display (LCD) or an organic EL display. The operation unit 15 accepts various inputs to the optical information reading device 10. The operation unit 15 includes a trigger key 18 that the user operates to execute imaging with the imaging module 13. In addition to the trigger key 18, the operation unit 15 also includes multiple operation keys such as a numeric keypad, a power key, and function keys. Furthermore, the display unit 14 may be a touch panel display that also functions as the operation unit 15.

The housing 17 in FIG. 1 is formed in a shape that is overall elongated in one direction (longitudinal direction). The display unit 14 is provided on the upper surface of one end portion in the longitudinal direction of the housing 17. The operation unit 15 is provided on the upper surface of the other end portion of the housing 17. The other end portion of the housing 17 has a smaller width dimension than the one end portion where the display unit 14 is located, making it easier for the user to grip the other end portion where the operation unit 15 is arranged.

The imaging module 13 is provided on the front surface of the tip portion of one end portion of the housing 17, which is directed toward the target object 11. The user grips the other end portion of the housing 17 to carry the optical information reading device 10. When the user captures an image of the target object 11 with the optical information reading device 10, the tip portion where the imaging module 13 is provided is pointed toward the target object 11.

The imaging module 13 is a module that includes an imaging unit 31 which captures an area within the imaging field of view to generate images such as input images. The imaging unit 31 is, for example, a camera unit that includes an image sensor such as CMOS or CCD that converts light into electrical signals, and an imaging optical system (such as lenses) that focuses the reflected light from the symbol 20 onto the image sensor. The imaging unit 31 shown in FIG. 1 is equipped with multiple (in this case, three) camera units. These camera units each have different focal lengths, enabling the imaging unit 31 as a whole to capture high-quality images of target objects 11 at various distances. The imaging unit 31 may include, for example, a short-distance camera unit with a short fixed focal length, a long-distance camera unit with a long fixed focal length, and a variable intermediate camera unit with a focal length that can be varied between short and long distances. The images generated by the imaging unit 31 are, for example, input images that include symbols (such as character strings) attached to the target object 11, which are used for reading symbol information by the optical information reading device 10. In addition, the imaging unit 31 may also generate images used for operational images to execute reading processes by the optical information reading device 10, or setting images for configuring the optical information reading device 10.

The imaging module 13 in FIG. 1 includes, in addition to the imaging unit 31, an aimer light irradiation unit 32 and an illumination unit 33. The aimer light irradiation unit 32 irradiates aimer light 40 in an irradiation direction A towards the target object 11. The illumination unit 33 irradiates illumination light to assist in capturing the symbol 20 by the imaging unit 31. The imaging module 13 in FIG. 1 is equipped with multiple (in this case, two) light sources as the illumination unit 33. By irradiating illumination light from multiple directions, shadows on the target object 11 are reduced, improving the reading accuracy of the symbol 20.

The irradiation direction A towards the target object 11 is the direction from the front surface of the tip of the housing 17 directed at the target object 11 to the target object 11. The imaging unit 31 has an imaging field of view directed in this irradiation direction A and captures the area within the imaging field of view. The aimer light 40 determines the aiming position of the optical information reading device 10. The aiming position is treated as the position that the user is aiming at with respect to the target object 11 in the information processing performed by the optical information reading device 10. For example, when multiple symbols 20 are attached to the target object 11, the symbol 20 closer to the aimer light 40 may be treated as the target for reading.

In FIG. 1, the aimer light 40 includes a first aimer light 40a, which is a linear light extending in a first direction 40H, and a second aimer light 40b, which is a linear light intersecting the first direction 40H. In FIG. 1, the second aimer light 40b, which is shorter than the first aimer light 40a, intersects at the center of the first aimer light 40a. In FIG. 1, the second aimer light 40b extends in a second direction 40V perpendicular to the first aimer light 40a. However, depending on the attitude of the optical information reading device 10, the second aimer light 40b may intersect the first aimer light 40a at an angle that is not perpendicular. Furthermore, the aimer light 40 only needs to include at least the first aimer light 40a extending in the first direction 40H, and the second aimer light 40b is not necessarily required.

The aimer light irradiation unit 32 in FIG. 1 includes a first irradiation unit 32a that irradiates a first aimer light 40a extending in a first direction 40H, and a second irradiation unit 32b that irradiates a second aimer light 40b extending in a direction intersecting the first direction 40H. The first irradiation unit 32a and the second irradiation unit 32b are each units including light-emitting elements such as LEDs (Light Emitting Diodes).

The first direction 40H intersects with the irradiation direction A, and the first aimer light 40a extends within the surface of the target object 11 where the symbol 20 is displayed. The second direction 40V intersects with both the irradiation direction A and the first direction 40H, and in FIG. 1, it is perpendicular to the first direction 40H within the surface where the symbol 20 is displayed.

The orientation of the first direction 40H changes according to the inclination of the optical information reading device 10 and the target object 11. For example, when a user points the optical information reading device 10 horizontally towards a target object 11 that extends vertically, the first direction 40H becomes horizontal within the plane of the target object 11.

Among the aimer light 40, the first direction 40H of the first aimer light 40a is sometimes used as a reference for determining the reading direction of the symbol 20 when the optical information reading device 10 reads the symbol 20. Therefore, it is preferable for the user to irradiate the aimer light 40 onto the target object 11 so that the first aimer light 40a aligns with the arrangement direction of the symbol 20. In the following explanation, it is assumed that the first aimer light 40a is irradiated to align with the arrangement direction of the symbol 20. Also, unless specifically mentioned, the aiming position defined by the aimer light 40 is assumed to be the position where the first aimer light 40a and the second aimer light 40b intersect on the target object 11 (the central part of the first aimer light 40a).

In addition, the optical information reading device 10 may include a power supply unit (not shown) and other components. The power supply unit supplies drive power to the optical information reading device 10. For example, a detachable battery unit can be used as the power supply unit that can be attached to and detached from the housing 17.

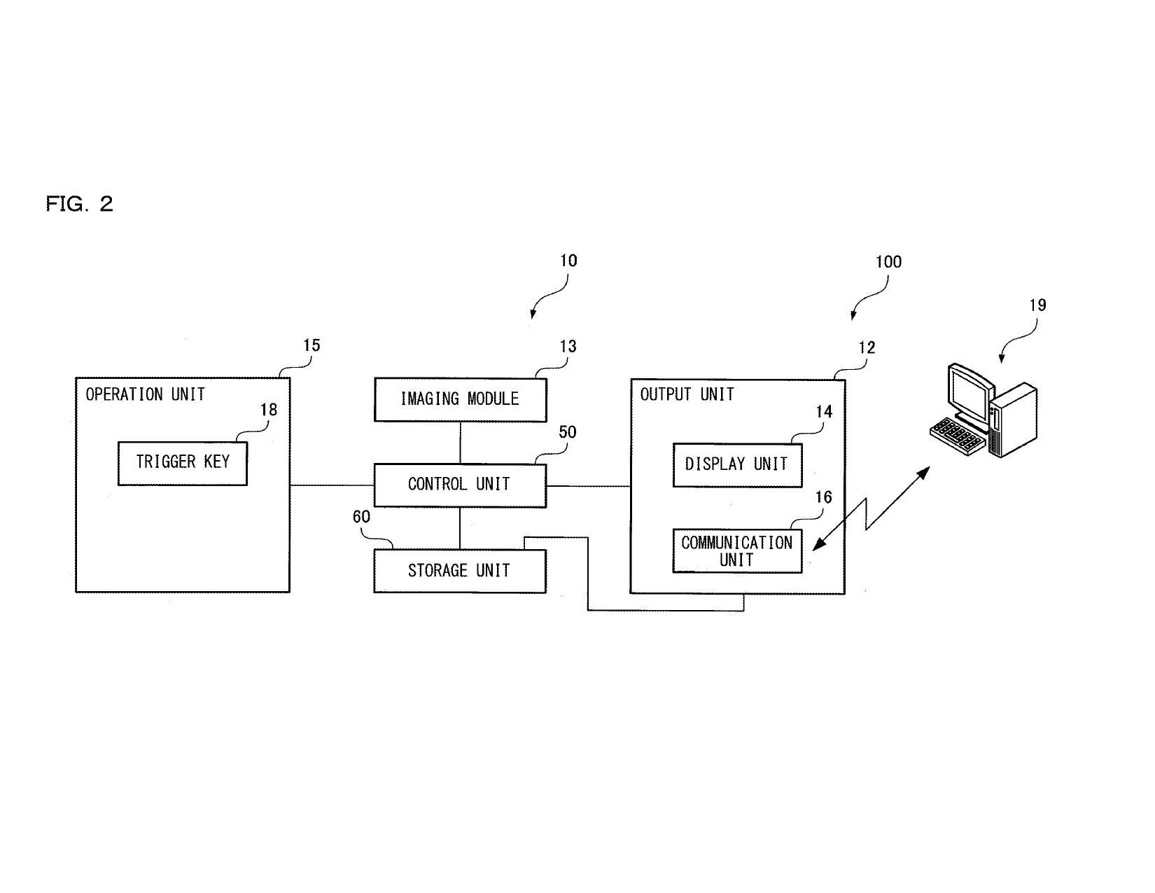

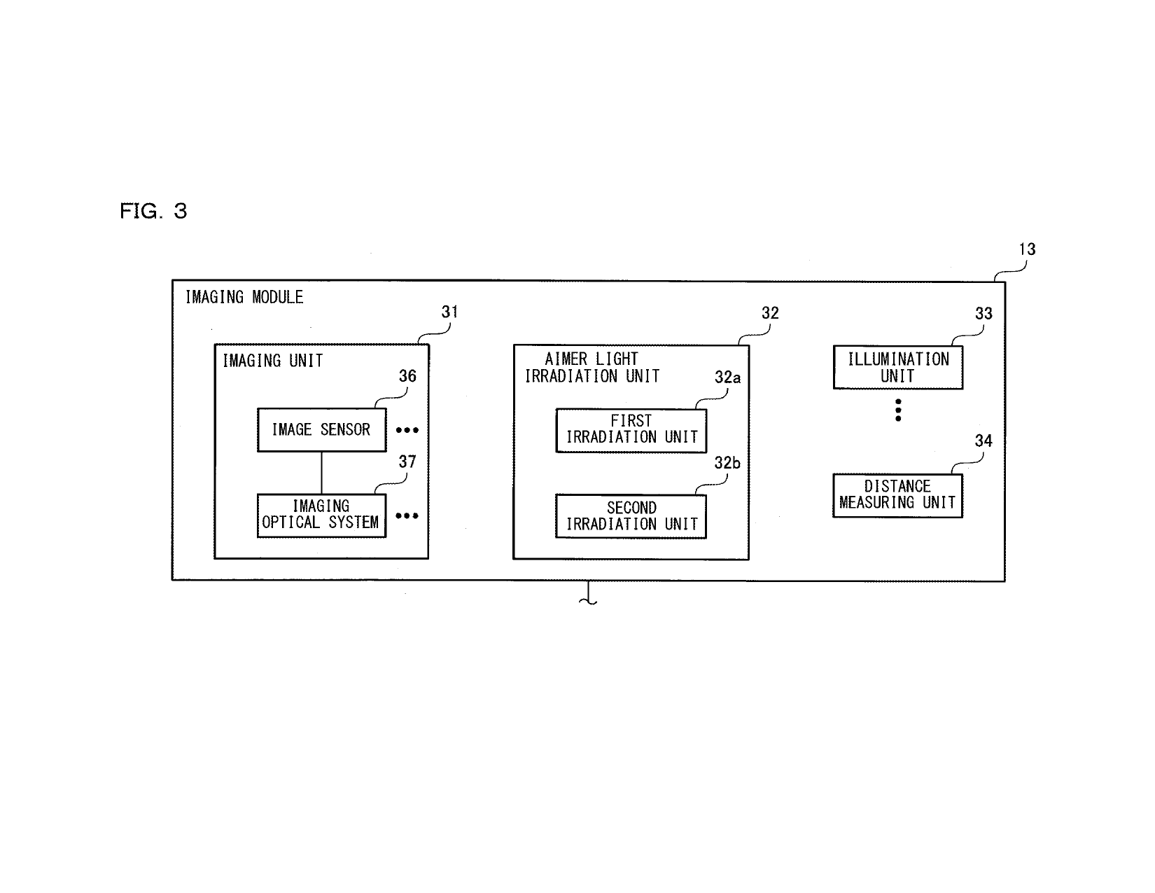

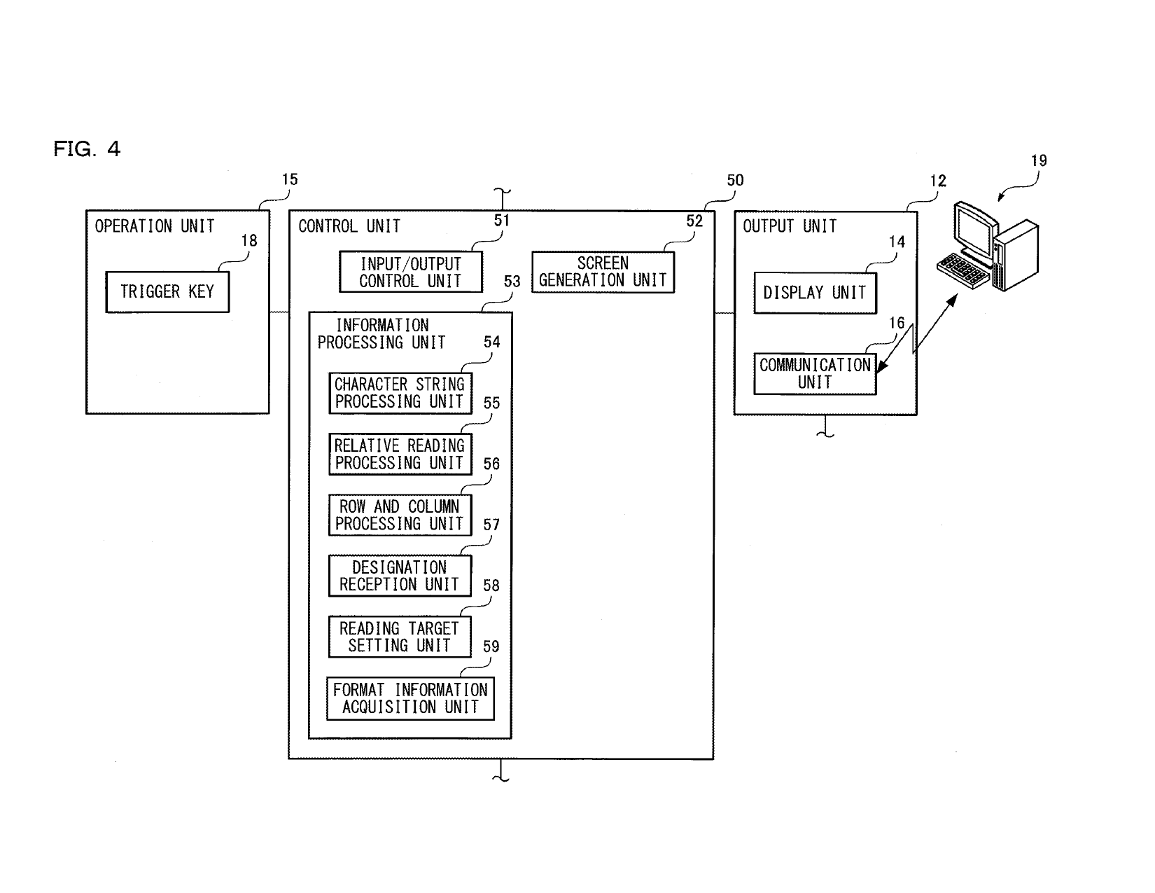

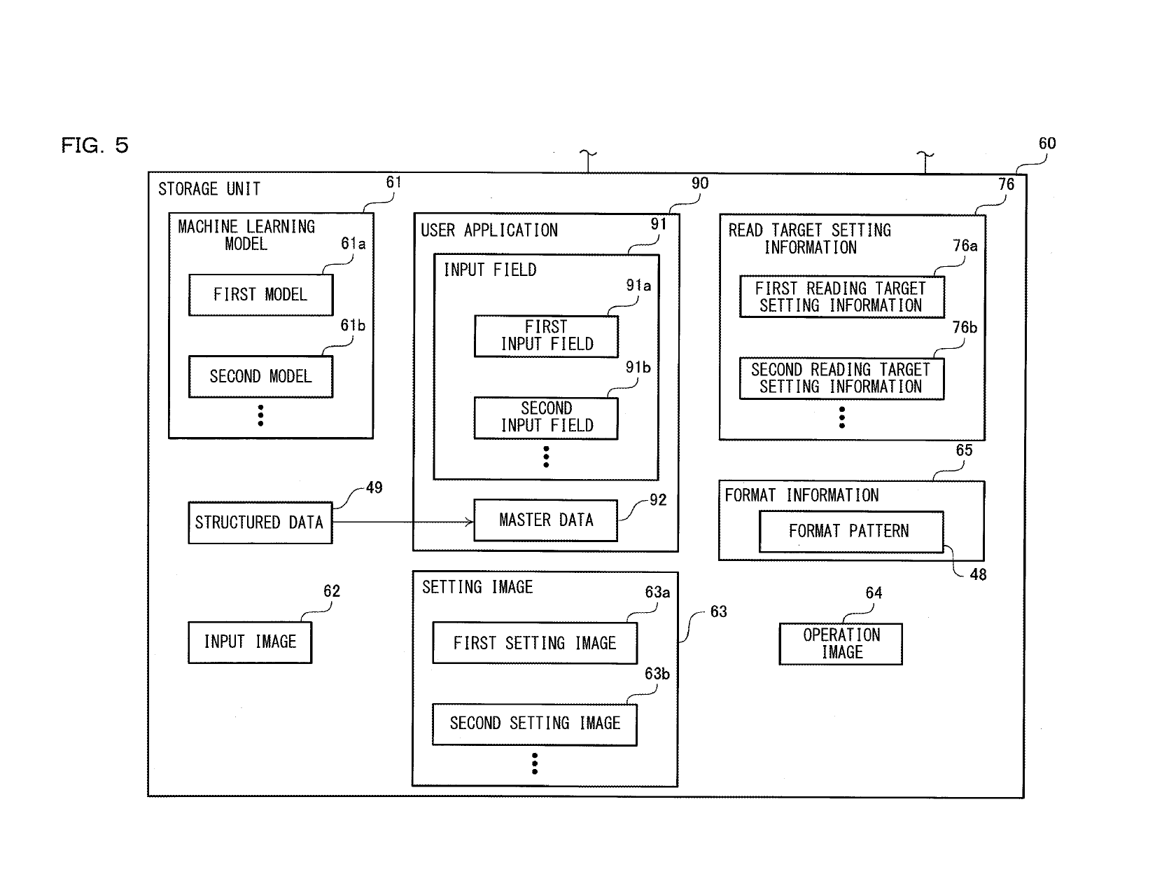

Next, referring to the block diagrams in FIG. 2, FIG. 3, FIG. 4, and FIG. 5, the configuration of the information processing system 100 including the optical information reading device 10 will be explained. FIG. 2 is a block diagram schematically showing the configuration of the information processing system 100 including the optical information reading device 10. FIG. 3 is a block diagram schematically showing the configuration of the imaging module 13. FIG. 4 is a block diagram schematically showing the configuration of the control unit 50. FIG. 5 is a block diagram schematically showing the configuration of the storage unit 60.

The optical information reading device 10 comprises an imaging module 13, a display unit 14, an operation unit 15, as well as an output unit 12, a control unit 50, and a storage unit 60. The display unit 14 is part of the output unit 12.

The output unit 12 is a unit that performs signal processing to output data processed within the optical information reading device 10 to the outside of the optical information reading device 10. The output unit 12 includes a communication unit 16 in addition to the display unit 14, and the optical information reading device 10 communicates with external devices, for example, a host computer 19, via the communication unit 16. The communication unit 16 is a communication interface unit for data communication between the optical information reading device 10 and other devices, and performs data communication, for example, through wireless communication (such as wireless LAN). The communication unit 16 of the optical information reading device 10 specifically communicates with the host computer 19 of the information processing system 100. It should be noted that as long as data is communicated between the optical information reading device 10 and the host computer 19 via the communication unit 16, the communication unit 16 does not necessarily need to communicate directly with the host computer 19. For example, there may be a device (such as a router or gateway device) that relays communication between the optical information reading device 10 and the host computer 19.

The host computer 19 is equipped with input devices such as a keyboard and mouse, and a display device (monitor). The information processing system 100 can transmit information of inputs made by a user operating the host computer 19 to the input devices, to the optical information reading device 10 via the communication unit 16. Additionally, the information processing system 100 can convey information output from the optical information reading device 10 to the user via the display device. Furthermore, the user operating the host computer 19 may be the same user as the user carrying the optical information reading device 10, or may be a different user.

The imaging module 13 includes, as shown in FIG. 3, an imaging unit 31, an aimer light irradiation unit 32, and an illumination unit 33. As mentioned earlier, the imaging unit 31 includes multiple combinations (camera units) of image sensors 36 and imaging optical systems 37. The aimer light irradiation unit 32 includes a first irradiation unit 32a and a second irradiation unit 32b. The illumination unit 33 includes multiple light sources for illumination light (such as LED lighting units).

Furthermore, the imaging module 13 in FIG. 3 also includes a distance measuring unit 34 that measures the distance from the optical information reading device 10 to the target object 11. The distance measuring unit 34 is, for example, a unit that includes a processor for performing calculations and a memory for storing information. The distance between the optical information reading device 10 and the target object 11 can be detected, for example, using LiDAR technology (Light Detection and Ranging technology). Specifically, the distance to the target object 11 can be calculated based on, for example, the Time of Flight of the illumination light emitted by the illumination unit 33 or the aimer light 40 emitted by the aimer light irradiation unit 32. It should be noted that the distance measuring unit 34 does not necessarily need to be included in the imaging module 13 as an independent unit, but may be part of the functions realized in the control unit 50.

The control unit 50 shown in FIG. 4 is a unit that controls the operation of the optical information reading device 10. The control unit 50 is connected to the output unit 12, the imaging module 13 (FIG. 3), the operation unit 15, and the storage unit 60 (FIG. 5). The control unit 50 includes an input/output control unit 51, a screen generation unit 52, and an information processing unit 53.

The input/output control unit 51 is an input/output interface that controls the data input to and output from the optical information reading device 10. For example, the input/output control unit 51 generates input data representing information on how the operation keys (such as the trigger key 18) included in the operation unit 15 were operated, and sends the input data to units that require it. Additionally, the input/output control unit 51 sends data representing symbol information read from the symbol 20 through information processing by the information processing unit 53 to the output unit 12. Furthermore, the input/output control unit 51 controls all input/output processes performed in the optical information reading device 10, such as sending images captured by the imaging unit 31 of the imaging module 13 as input images to the information processing unit 53, or sending commands to perform imaging to the imaging unit 31.

The screen generation unit 52 generates data for the screen to be displayed on the display unit 14 based on the image captured by the imaging unit 31 and the results of information processing by the information processing unit 53. For example, the screen generation unit 52 performs processes such as compositing display components generated by the information processing unit 53 onto the image captured by the imaging unit 31.

The input/output control unit 51 and the screen generation unit 52 should preferably be dedicated units (input/output processor, image processor, etc.) that execute input/output control processing and screen generation processing independently of the information processing unit 53. However, the input/output control unit 51 and the screen generation unit 52 may also be part of the functions realized by the information processing unit 53.

The information processing unit 53 is a unit that includes a processor such as a CPU (Central Processing Unit). The information processing unit 53 realizes functions such as the character string processing unit 54, the relative reading processing unit 55, the row and column processing unit 56, the designation reception unit 57, the reading target setting unit 58, and the format information acquisition unit 59 by reading and executing program data stored in the storage unit 60.

The storage unit 60 in FIG. 5 is a unit such as ROM that stores electronic data. The storage unit 60 stores a machine learning model 61, input images 62, setting images 63, operation images 64, user applications 90, reading target setting information 76, and so on. As mentioned earlier, program data for realizing the functions of the information processing unit 53 is also stored in the storage unit 60, but for the purpose of explanation, the various functions of the information processing unit 53 are shown as being included in the control unit 50 in FIG. 4.

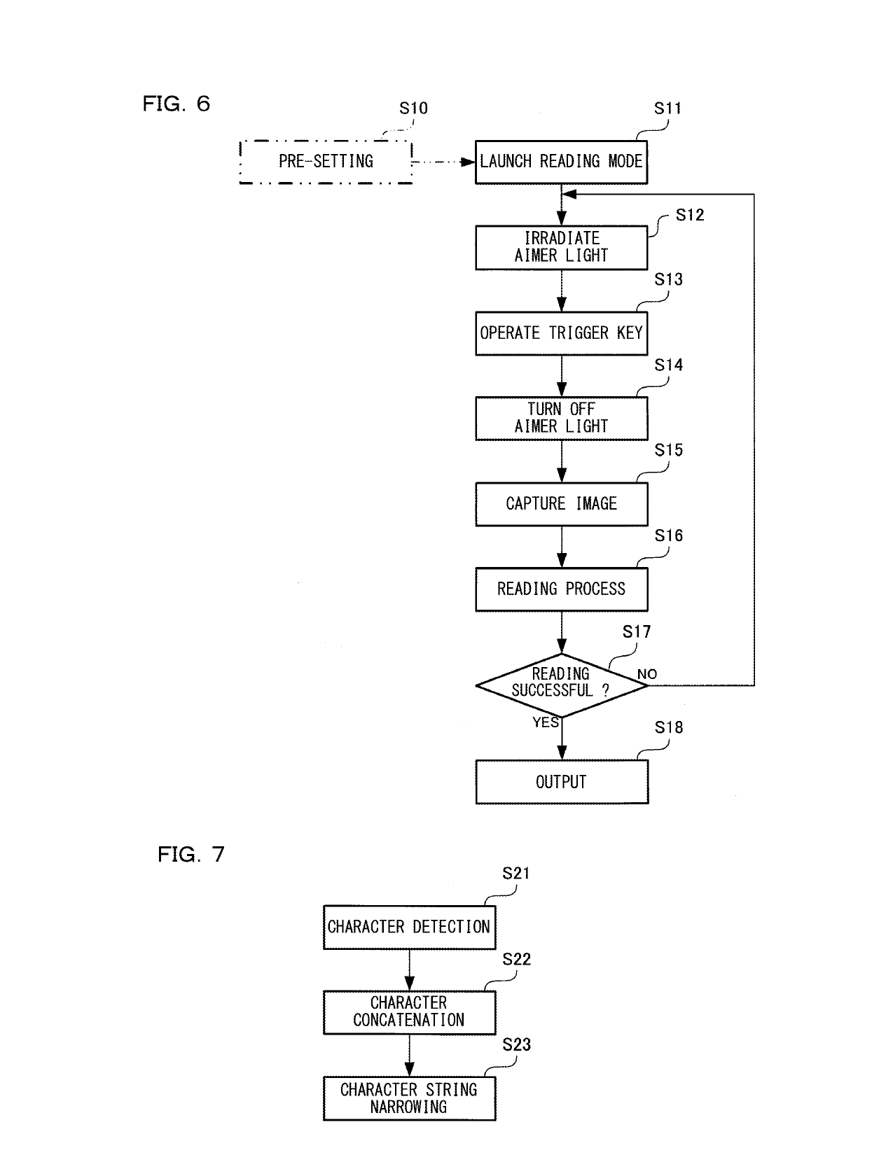

Next, referring to the flowchart in FIG. 6, the overall operation flow of the optical information reading device 10 will be explained. When a user uses the optical information reading device 10 to read a symbol 20, before executing the reading, first in step S10, pre-settings are made. Through these pre-settings, various matters that should be predetermined for reading the symbol 20 are set. For example, according to the form of the symbol 20, it would be good if information such as the format of the character string and the standard type of the barcode, which are format information of the symbol 20, and information related to the arrangement of the symbol 20 such as the number of rows/columns in a tabular document, are registered through pre-settings. Additionally, the relative positional relationship between the aiming position of the aimer light 40 and the position of the symbol 20 that is the reading target may be registered through pre-settings. The content registered through pre-settings is stored in the storage unit 60.

If pre-setting has been completed, in step S11, the reading mode of the optical information reading device 10 is launched. For example, it is preferable that the reading mode is launched when the user operates a key for launching the reading mode included in the operation unit 15. Alternatively, the reading mode may be launched when the user selects an icon for launching the reading mode from the settings menu screen displayed on the display unit 14.

When the reading mode is launched, in step S12, the optical information reading device 10 irradiates the aimer light 40 onto the target object 11. The user operates the trigger key 18 in step S13 when the aimer light 40 is irradiated at the target aiming position, such as the position of the symbol 20 desired to be read or the position to be centered in the imaging field of view. However, in the case where the optical information reading device 10 is of a smartphone type, it may not be equipped with an aimer light irradiation unit 32. In such cases, the optical information reading device 10 may not irradiate the aimer light 40, but instead display a live view of the image generated by the imaging unit 31 on the display unit 14, and superimpose a virtual aimer to define the aiming position at a specific position (e.g., the center) on the image displayed as a live view on the display unit 14. The virtual aimer is preferably of the same shape as the aimer light 40. Specifically, it is desirable that a virtual aimer including a figure imitating the first aimer light 40a as a linear light extending in the first direction 40H, and a figure imitating the second aimer light 40b as a linear light intersecting the first direction 40H, is displayed on the display unit 14. The user can adjust the orientation of the optical information reading device 10 (the direction in which the imaging unit 31 is pointing) to bring the virtual aimer displayed on the display unit 14 closer to the symbol 20 desired to be read on the live view image, thereby defining the aiming position.

When the trigger key 18 is operated, the optical information reading device 10 turns off the aimer light 40 in step S14, and then in step S15, captures the target object 11 with the imaging unit 31. It should be noted that step S14 for turning off the aimer light 40 immediately before the imaging is performed in step S15 does not necessarily need to be executed. For example, the aimer light 40 may be constantly blinking (repeating turning on and off) in the reading mode. In this case, step S14 is not executed, and imaging may be performed at the moment when the aimer light 40 is turned off. In step S15, the imaging unit 31 captures the area within the imaging field of view and generates an input image that includes the symbol 20 attached to the target object 11. When a virtual aimer is displayed on the display unit 14 instead of irradiating the aimer light 40, step S14 is not executed, and the area within the imaging field of view at the time when the trigger key 18 is operated is captured.

When the target object 11 is captured, a reading process is executed on the input image obtained by this imaging in step S16. The details of this reading process vary depending on the form of the symbol 20 that is the reading target. In the reading process, for example, character string processing to narrow down to the symbol 20 that becomes the output character string from multiple character string candidates, relative reading processing to read the symbol 20 based on the relative position between the aiming position and the reading target, and row and column processing to read the symbol 20 attached as a matrix are executed.

After the reading process, in step S17, it is determined whether the reading of symbol 20 was successful or not. If the reading of symbol 20 is successful (YES in step S17), the process proceeds to step S18, and the read symbol information is output to the storage unit 60 or the output unit 12. If the reading of symbol 20 fails (NO in step S17), the process returns to step S12, and imaging is performed again.

In step S17, whether the reading of symbol 20 was successful or not may be automatically determined or may be determined by manual operation of the user. As an example of automatic determination, it is preferable to determine that reading was successful if symbol information could be obtained from symbol 20 (decoding was successful, or a character string was obtained by OCR processing). As an example of determination by manual operation, it is preferable that the display unit 14 displays the symbol information obtained by the reading process, and displays options for the user to select whether the symbol information is as intended by the user. If the symbol information obtained is not as intended by the user, the user performs an operation indicating that the obtained symbol information is not as intended. Then, the determination in step S17 becomes "NO", and the obtained symbol information is discarded. After that, the process returns to step S12, and imaging is performed again.

Next, referring to the flowchart in FIG. 7, an example of the reading process in step S16 will be explained. For instance, when an object 11 with multiple character strings as symbol 20 is captured, the input image obtained by imaging contains multiple characters. The optical information reading device 10 performs character detection processing to detect multiple characters included in the input image in step S21, which is included in the reading process.

Next, at step S22, the optical information reading device 10 performs a character concatenation process to obtain multiple character string candidates from the input image based on these multiple characters. Then, at step S23, the optical information reading device 10 performs a character string narrowing process to narrow down the multiple character string candidates to the output character string that should be output. Here, the output character string that should be output refers to a character string that should be output to a device or component other than the control unit 50 that executes the reading process. For example, character strings that should be displayed on the display unit 14, or character strings that should be transmitted to the host computer 19, which are used for processing through the output unit 12, become output character strings. Additionally, character strings that should be output to and stored in the storage unit 60 may also become output character strings. If the narrowing down results in only one output character string, the information represented by that output character string becomes the symbol information obtained by the reading process. If there are multiple output character strings, the information represented by any one of them becomes the symbol information obtained by the reading process. Which output character string's information is read as symbol information may be manually selected by the user or automatically selected by the optical information reading device 10.

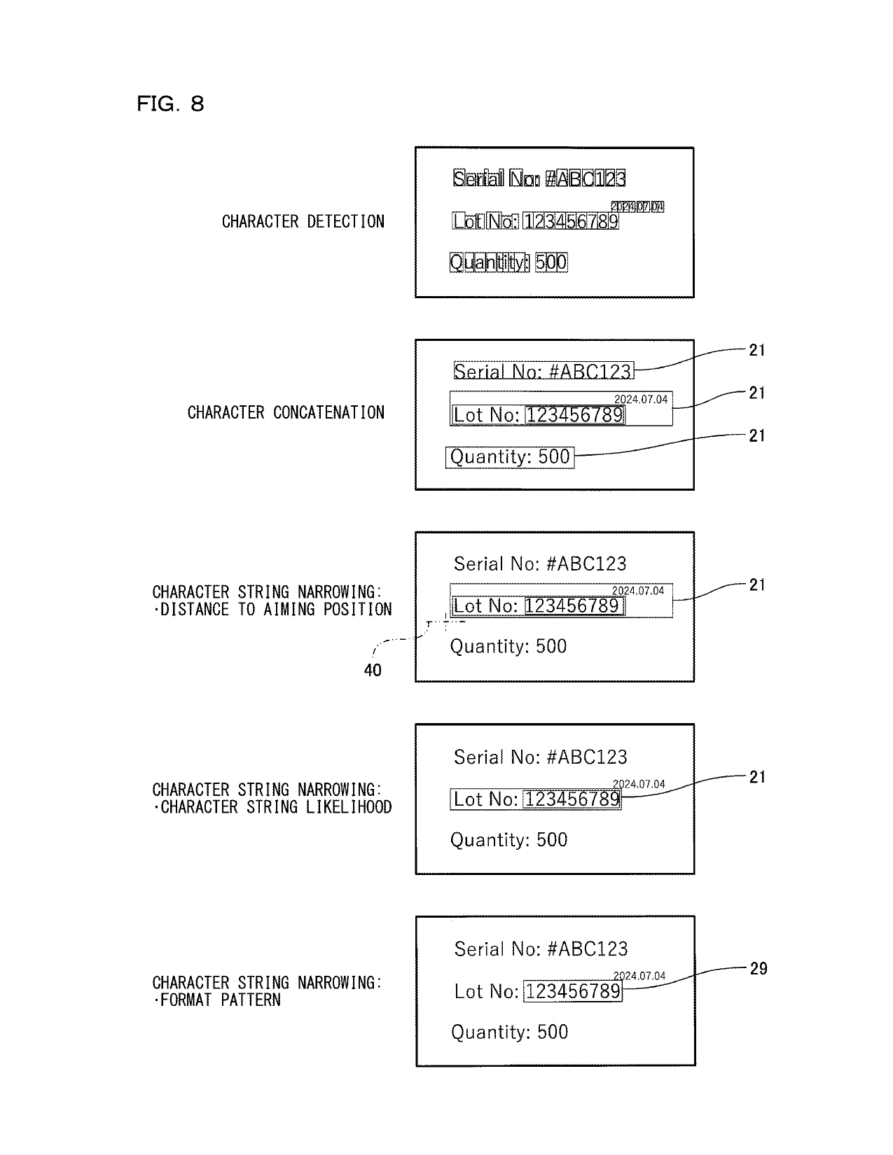

FIG. 8 shows an example of a procedure for narrowing down to the output character string 29. When an input image containing multiple character strings is generated by the imaging unit 31, as shown in FIG. 8, the input image contains multiple characters as symbol 20. For an input image containing multiple characters, the character string processing unit 54 (FIG. 4) of the control unit 50 executes a reading process (character string processing) related to the character string. The character string processing unit 54 first detects (performs character detection of) multiple characters contained in the input image using the machine learning model 61 (FIG. 5) stored in the storage unit 60.

The machine learning model 61 is an input-output model that detects multiple characters contained in an input image, using the input image as input. For example, the machine learning model 61 can be an input-output model that has been trained on the input-output relationship to output information about characters contained in an image, using images containing various characters as input. It is preferable that the character information output by the machine learning model 61 includes information on the position of each character in the input image (such as coordinate data), the size of each character, and information on the type of each character (such as character codes).

After character detection is performed by the machine learning model 61, the character string processing unit 54 (FIG. 4) obtains (concatenates) multiple character string candidates 21 from the input image based on the multiple characters detected by the machine learning model 61. When concatenating characters, the character string processing unit 54 groups multiple characters estimated to have high relevance to each other as character string candidates 21 based on the relative positions of characters to each other, the relationship of sizes between characters, and so on, for each of the multiple characters obtained from character detection. For example, if multiple characters of approximately the same size are arranged in the horizontal direction with small intervals in the input image, and the characters are at approximately the same position in the vertical direction, those characters are estimated to have high relevance to each other. Specifically, as shown in FIG. 8, the character string processing unit 54 concatenates a series of horizontally aligned characters as one character string candidate 21.

The character string processing unit 54 performs a process of narrowing down to the output character string from multiple character string candidates 21 obtained through character concatenation. If only one character string candidate 21 is obtained, that character string candidate 21 becomes the output character string. It is preferable to use multiple indicators as criteria for narrowing to down the output character string. Examples of indicators include character string likelihood, distance to the aiming position in the input image, and degree of matching with format patterns. Among the above indicators, at least one indicator may be used, and it is not necessarily required to use multiple indicators. For example, the output character string may be narrowed down based solely on the distance to the aiming position.

For example, in FIG. 8, among multiple character string candidates 21, the character string candidate 21 in the second row, which is closest to the aiming position, is shown as being narrowed down as a candidate for the output character string. The aiming position is determined by the aimer light 40, but since the aimer light irradiation unit 32 is turned off at the moment the input image is captured, the aimer light 40 is not included in the input image. The optical information reading device 10 calculates the position where the aimer light 40 was irradiated until just before imaging, and treats that position as the aiming position corresponding to the aimer light 40 in the input image. Although the aimer light 40 is not included in the input image, for the purpose of explanation, the aimer light 40 is displayed in the figures below. Additionally, the aiming position may be determined by a virtual aimer on the display unit 14, rather than the aimer light 40 from the aimer light irradiation unit 32. Both the virtual aimer and the aimer light 40 may be collectively referred to as aimer light 40 in the following description.

The optical information reading device 10 can, for example, calculate the position where the aimer light 40 is irradiated on the target object 11 (or the position where the virtual aimer is displayed) as the aiming position based on the distance between the optical information reading device 10 and the target object 11, and the inclination of the optical information reading device 10. The distance between the optical information reading device 10 and the target object 11 is measured by the distance measuring unit 34 of the imaging module 13. The inclination of the optical information reading device 10 is specifically detected, for example, by an acceleration sensor placed inside the housing 17.

Alternatively, the imaging unit 31 may capture both an input image that does not include the aimer light 40 and a reference image that includes the aimer light 40, and the aiming position may be calculated by comparing the input image and the reference image.

The character string likelihood, which is one of the indicators for narrowing down to the output character string by the character string processing unit 54, is an indicator showing the likelihood (plausibility) as a character string. The character string processing unit 54 calculates the character string likelihood using, for example, the result of evaluating each of the multiple character string candidates 21 based on predetermined likelihood conditions.

The character string processing unit 54 calculates the character string likelihood based on at least one of the following as likelihood conditions: a score indicating character likelihood output by the machine learning model 61, variation in typeface of each character included in the character string candidate 21, character string margin, reading history information, and information related to date.

The score indicating the character likelihood output by the machine learning model 61 is part of the information returned as output by the machine learning model 61 when given an input image, and is a numerical value indicating how reliably each of the multiple characters detected by the machine learning model 61 has been detected as a character. The higher this score, the more likely it is that the detected character is correctly a natural language character. Therefore, a character string candidate 21 composed of characters with high scores indicating character likelihood has a high probability of being a correct natural language character string, and thus, its character string likelihood is calculated to be high.

The variation in typeface for each character included in the character string candidate 21 refers to the variation in at least one of spacing, height, or contrast related to each character. Multiple characters belonging to the same character string are likely to have consistent spacing between characters, character height, and character contrast. Therefore, character string candidates 21 with low variation in spacing, height, and contrast for each character are more likely to be the character strings desired by the user as output character strings, resulting in a higher calculated character string likelihood. For example, in FIG. 8, among the character string candidates 21 in the second row, the part containing numbers in the upper right, "2024.07.04", has a different character height compared to other parts. Therefore, this part is less likely to be an output character string, so the "2024.07.04" part is excluded from the character string candidate 21.

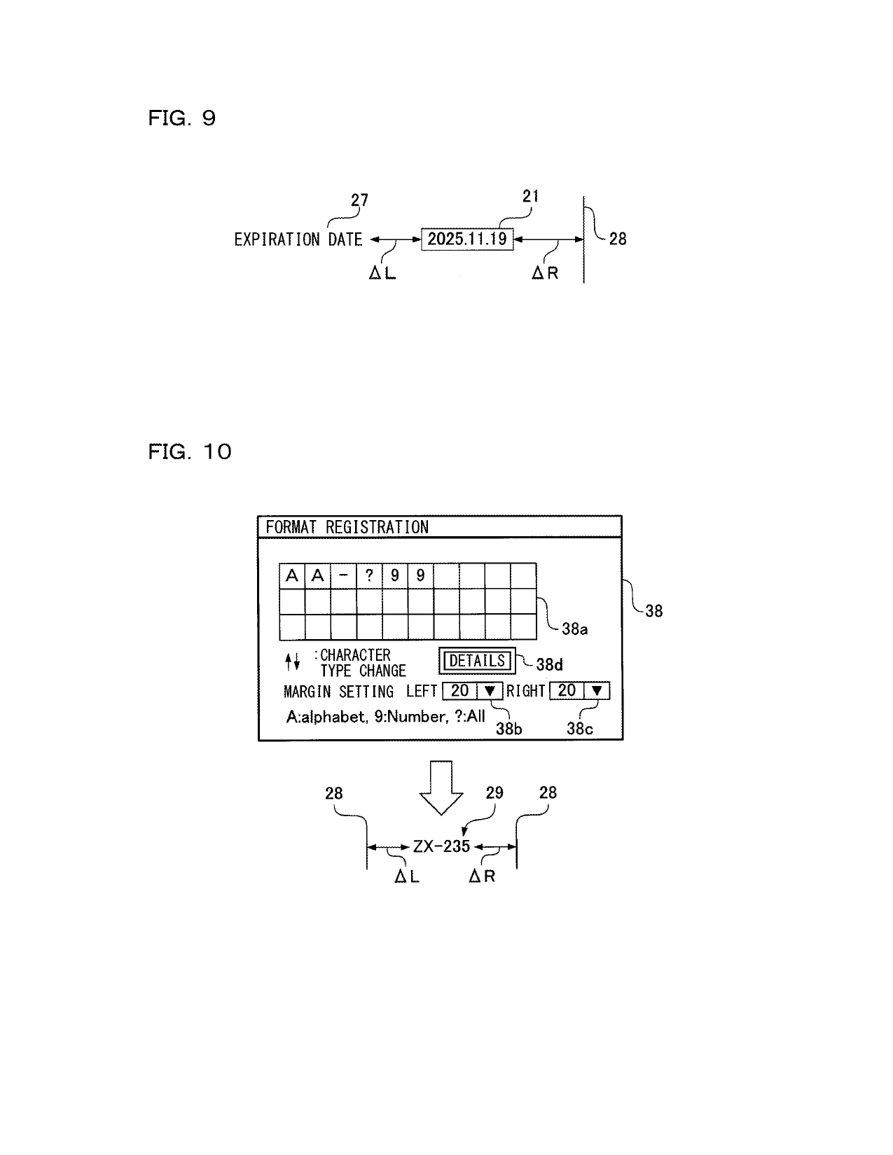

A character string margin is the size of a blank area before and after the arrangement of characters included in the character string candidate 21. For the character string candidate 21 "2025.11.19" shown in FIG. 9, there is another character string 27 "expiration date" on the left side, and a frame line 28 on the right side. In this case, the character string margin is the distance from the end of the character string candidate 21 to the position where another character string 27 or frame line 28 is found when the character string processing unit 54 searches along the direction of character arrangement. The character string processing unit 54 may, for example, recognize the position where a contrast change of a certain level or more occurs in the input image as the position where another character string 27 or frame line 28 exists when searching along the direction of character arrangement. In this case, in addition to the position where a ruled line is actually drawn on the target object 11, the edge of the paper surface, i.e., the edge of the target object 11 where the symbol 20 is attached, is also recognized as the frame line 28. In the case of FIG. 9, the blank area between the character string candidate 21 and the other character string 27 on the left side is the left character string margin ΔL, and the blank area between the character string candidate 21 and the frame line 28 on the right side is the right character string margin ΔR. If these character string margins are sufficiently large (larger than a predetermined margin threshold), the character string candidate 21 can be considered as an independent character string separate from other character strings 27, resulting in a high character string likelihood being calculated.

Reading history information refers to information about character strings that have been read in the past. The storage unit 60 of the optical information reading device 10 accumulates reading history information related to character strings that have been read in the past. The character string processing unit 54 compares the character string candidate 21 with the reading history information and calculates a higher character string likelihood the more similar the character string candidate 21 is to a character string read in the past (past character string). It is preferable to consider the similarity especially with character strings read in the recent period (for example, within 24 hours) among the past character strings. For example, in a situation where multiple workpieces (target objects) with 10-digit character strings attached need to be read sequentially, and each workpiece contains multiple 10-digit character strings, it becomes easier to identify which character string should be narrowed down as the output character string based on the reading history information.

Furthermore, elements other than the character likelihood score, typeface variation, character string margin, and reading history information may be considered as criteria for calculating the character string likelihood. For example, when the character string to be read is a date string, it is preferable to consider information related to dates. Specifically, it is beneficial to consider whether separator characters for separating year, month, and day are included in the string, and whether kanji characters or English words indicating "year," "month," and "day" are included in the string. Additionally, it is advantageous to consider comparison information between the date (time) indicated by the target date string and the current time, or, in cases where multiple date strings exist, the chronological order between the dates represented by each date string. For instance, the manufacturing date will be in the past compared to the current time, while the expiration date or best-before date will be in the future compared to the current time. Moreover, between the manufacturing date and expiration date, the expiration date will be a later date in chronological order. Depending on the type of target date desired to be read, considering such date-related information makes it easier to narrow down and output the intended date as the output character string more reliably.

The degree of matching with the format pattern, which is one of the indicators for narrowing down to the output character string by the character string processing unit 54, is the degree of matching between the format pattern predetermined as the format of the character string that should be output and the character string candidate 21. It is preferable that the format pattern is set in advance by the user as to what format the character string to be read is, before the character string is read using the optical information reading device 10.

For example, in FIG. 8, when "9-digit number" (a character string in which numbers are arranged consecutively 9 times) is set as the format pattern, the part "Lot No:" among the character string candidates 21 that does not match the format pattern is excluded from the character string. Then, "123456789" which matches the format pattern is narrowed down as the output character string 29.

Here, for the degree of matching with the format pattern, a numerical value indicating simply "whether it matches or not" may be used, or a numerical value indicating to what extent it matches the format pattern may be used. As a numerical value indicating "whether it matches or not", for example, "1" representing "matches" and "0" representing "does not match" are used. Also, as a numerical value indicating to what extent it matches the format pattern, for example, a value between "0" and "1" is used.

When the degree of matching with the format pattern is used as one of the indicators for narrowing down to the output character string 29, it is preferable to determine whether the degree of matching exceeds a predetermined matching degree threshold. For example, if the matching degree threshold is set to "0.5", even if it does not completely match the format pattern, there is a possibility that it will become an output character string 29 if it matches to some extent. On the other hand, if the matching degree threshold is set to "0.9", almost all character string candidates 21 other than those that completely match the format pattern are excluded.

When multiple indicators such as character string likelihood, distance to the aiming position, and degree of matching with format patterns are used as indicators for the character string processing unit 54 to narrow down to the output character string 29, it is preferable that the output character string 29 be narrowed down by comprehensively evaluating these indicators. For example, it is preferable that a composite score be calculated based on multiple indicators, and the character string candidate 21 with a high composite score be narrowed down as the output character string 29.

On the other hand, these indicators may have a priority order assigned to them. For example, it is preferable that the character string processing unit 54 first calculates the degree of matching with the format pattern for each character string candidate 21, and determines whether or not the degree of matching exceeds a matching degree threshold. Then, it is preferable that the character string processing unit 54 narrows down to the output character string 29 based on at least one of the character string likelihood or the distance to the aiming position, from the character string candidates 21 that exceed the matching degree threshold with the format pattern (matching the format pattern or having a high degree of matching).

Furthermore, a priority order may also be established between the character string likelihood and the distance to the aiming position. For example, if there are multiple character string candidates 21 whose degree of matching with the format pattern exceeds the matching degree threshold, it would be good to calculate the character string likelihood for those character string candidates 21 next. Regarding the character string likelihood, it would be preferable to have a predetermined likelihood threshold. The likelihood threshold is a value indicating that if the character string likelihood exceeds this number, there is a high possibility that the character string candidate 21 is appropriate as the character string to be read. Then, if there are multiple character string candidates 21 whose character string likelihood exceeds the likelihood threshold among the character string candidates 21 whose degree of matching with the format pattern exceeds the matching degree threshold, it would be good for the character string processing unit 54 to output the character string candidate 21 with the shortest distance to the aiming position as the output character string 29.

Furthermore, instead of sequentially performing narrowing down using character string likelihood and narrowing down using distance to the aiming position, the character string processing unit 54 may perform narrowing down using character string likelihood and distance to the aiming position comprehensively. For example, the character string processing unit 54 may calculate a composite score based on the character string likelihood and the distance to the aiming position for character string candidates 21 whose degree of matching with the format pattern exceeds the matching degree threshold. Hereinafter, the composite score calculated based on the character string likelihood and the distance to the aiming position is referred to as the character string position likelihood. The character string position likelihood is, for example, calculated by a function with the character string likelihood and the distance to the aiming position as variables. The character string position likelihood becomes a higher score as the character string likelihood of the character string candidate 21 is higher and as the distance to the aiming position is shorter. The character string processing unit 54 may output as the output character string 29 the character string candidate 21 with the highest character string position likelihood among the character string candidates 21 whose degree of matching with the format pattern exceeds the matching degree threshold.

Furthermore, the priority order of indicators for narrowing down to the output character string 29 is not limited to the above order of degree of agreement with the format pattern, character string likelihood, and distance to the aiming position. For example, the distance to the aiming position may have the highest priority.

For example, the character string processing unit 54 should sort multiple character string candidates 21 in order of shorter distance to the aiming position. Then, the character string processing unit 54 determines, for each of the sorted multiple character string candidates 21 in the sorted order, whether the degree of matching with the format pattern exceeds a predetermined matching degree threshold, and whether the character string likelihood exceeds a predetermined likelihood threshold. As a result of the determination, if a character string candidate 21 is found that exceeds the matching degree threshold for the format pattern and also exceeds the likelihood threshold for the character string likelihood, the character string processing unit 54 should set that character string candidate 21 as the output character string 29. For example, in FIG. 8, it can be said that the narrowing down to the output character string 29 is performed by this procedure.

Next, referring to FIG. 10, the setting of format patterns and margin thresholds will be explained. It is preferable that the optical information reading device 10 is equipped with a function for setting format patterns and margin thresholds as part of the pre-settings. For example, when a setting screen key included in the operation unit 15 (FIG. 1) is operated, a settings menu screen (not shown) for configuring various settings of the optical information reading device 10 is displayed on the display unit 14. This settings menu screen includes an item "Format Registration", and when the "Format Registration" item is selected by the user, a format registration screen 38 shown in FIG. 10 is displayed on the display unit 14 (or the monitor of the host computer 19).

In the format registration screen 38, a format pattern and margin threshold are set by the user's operation. The format registration screen 38 includes a format registration field 38a, a left margin threshold field 38b, a right margin threshold field 38c, and a detailed settings button 38d.

A format pattern indicating the format of the character string that can become the output character string 29 to be output is registered by the format registration field 38a. In FIG. 10, "AA-?99" is registered as the format pattern. In this format registration field 38a, "A" represents an alphabet, "-" (hyphen) represents a separator, "9" represents a number (Number). And "?" represents an arbitrary character (All) used in the character string. Therefore, the pattern "AA-?99" represents a character string where characters are arranged in the order of two alphabets, a separator, an arbitrary character, and two numbers. The symbol representing an arbitrary character is not limited to "?". The symbol representing an arbitrary character is preferably different from the characters expected as the reading target, but it can be any symbol that the user can understand as representing an arbitrary character. For example, the kanji character "全" may be used as a symbol representing an arbitrary character, or a unique symbol that fits the string "All" within a single character frame may be used.

The user can change the character type displayed in the format registration field 38a by operating the up direction key and down direction key (not shown) included in the operation unit 15. In other words, the user can set any arrangement of alphabets, numbers, arbitrary characters, and separators as the format pattern.

Furthermore, the user can define margin thresholds related to the blank areas (character string margins) before and after the arrangement of characters in the character string candidate 21 using the left margin threshold field 38b and the right margin threshold field 38c. For example, the user can set thresholds for the left character string margin ΔL and the right character string margin ΔR by inputting numerical values or selecting values from pull-down lists in the left margin threshold field 38b and the right margin threshold field 38c. The user can also set the margin threshold to "none". By setting the margin threshold to "none", there is a possibility that character string candidates 21 without left or right margins can be narrowed down as output character strings 29.

When the settings on the format registration screen 38 are made as shown in FIG. 10, for example, a character string "ZX-235" is determined to match the format pattern. Furthermore, if the distance from the arrangement of characters in this character string to the frame line 28 before and after, that is, the left character string margin ΔL and the right character string margin ΔR, each exceed the set margin threshold, "ZX-235" is narrowed down as the output character string 29.

When the detailed settings button 38d of the format registration screen 38 is operated, the display of the display unit 14 transitions to a detailed settings screen (not shown) where detailed settings of the format registration screen 38 can be changed. In the detailed settings screen, for example, it is preferable to select the character types used in the character string. For instance, if kanji is used in addition to alphabets, numbers, and separators in the reading target character string, it is preferable to configure the settings so that kanji can also be registered in the format pattern.

Furthermore, it is desirable that in the detailed settings screen, it is possible to register characters that are considered as separator characters. For example, in addition to "-" (hyphen) as a separator character, it is preferable that other characters that can be used as separators such as "/" (slash), "," (comma), "." (dot), and ":" (colon) are also registered. Also, a certain interval of blank spaces may be registered as a separator character. It is also desirable that it can be set whether "arbitrary characters" are character types other than separator characters, or whether separator characters are included in "arbitrary characters". Moreover, in the detailed settings screen, it may be possible to set a threshold for contrast changes that are determined as frame lines 28 in the input image.

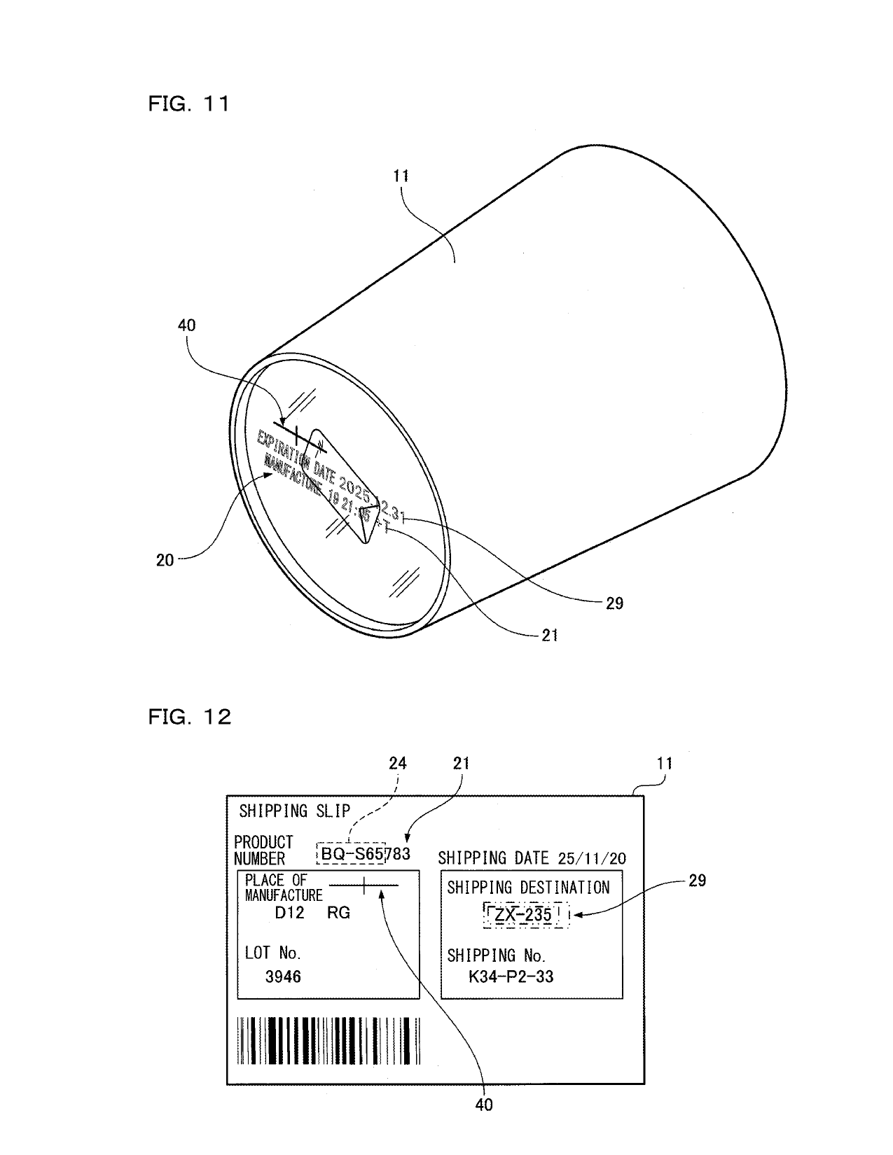

Next, referring to FIG. 11, a specific example will be explained where the output character string 29 is narrowed down based on the distance to the aiming position of the character string candidate 21. FIG. 11 shows an example of a target object 11 with multiple character strings attached. The target object 11 in FIG. 11 is a tubular product (for example, a food case), and multiple character strings are attached to its bottom as symbol 20. Furthermore, a transparent film and seal are affixed to cover the symbol 20 on the bottom of the target object 11, but the optical information reading device 10 can read the symbol 20 through the film and seal.

The character string as the symbol 20 in FIG. 11 includes a date string indicating "expiration date" and a numeric string indicating information related to "manufacture". When the user intends the date string of the "expiration date" as the output character string 29, the optical information reading device 10 is directed so that the aimer light 40 is irradiated near the date string of the "expiration date".

The input image obtained by capturing the bottom of the target object 11 includes a date string representing the "expiration date" and a numeric string indicating information related to "manufacturing". In this case, the date string of the "expiration date" has a shorter distance to the aiming position (the position where the aimer light 40 is irradiated). The character string processing unit 54 (FIG. 4) of the optical information reading device 10 acquires these strings as character string candidates 21 from the input image. The character string processing unit 54 narrows down to the date string representing the "expiration date", which has a shorter distance to the aiming position, as the output character string 29 from the character string candidates 21 based on the distance to the aiming position.

Next, referring to FIG. 12, a case where a character string candidate 21 with high character string likelihood becomes an output character string 29 will be explained. In FIG. 12, a shipping slip of a product becomes the target object 11. Multiple character strings are attached to this shipping slip. In FIG. 12, as in FIG. 10, it is assumed that a format pattern has been predetermined in which characters are arranged in the order of two alphabets, a separator, arbitrary characters, and two numbers ("AA-?99") as the character string pattern.

In FIG. 12, the aimer light 40 is irradiated near the character string candidate 21 "BQ-S65783" representing the "product number". Among this character string candidate 21, the string fragment 24 "BQ-S65" matches the format pattern. On the other hand, the character string "ZX-235" representing the "shipping destination", which is located away from the aiming position of the aimer light 40, not only matches the format pattern but also has sufficiently large character string margins before and after in the character alignment direction. Therefore, the character string likelihood of the character string "ZX-235" becomes higher than that of the string fragment 24 "BQ-S65". Here, if narrowing down to the output character string 29 is performed based on a composite score calculated from the character string likelihood and the distance to the aiming position, and if the composite score of the character string "ZX-235" becomes larger than that of the string fragment 24 "BQ-S65", the character string "ZX-235" will be narrowed down as the output character string 29.

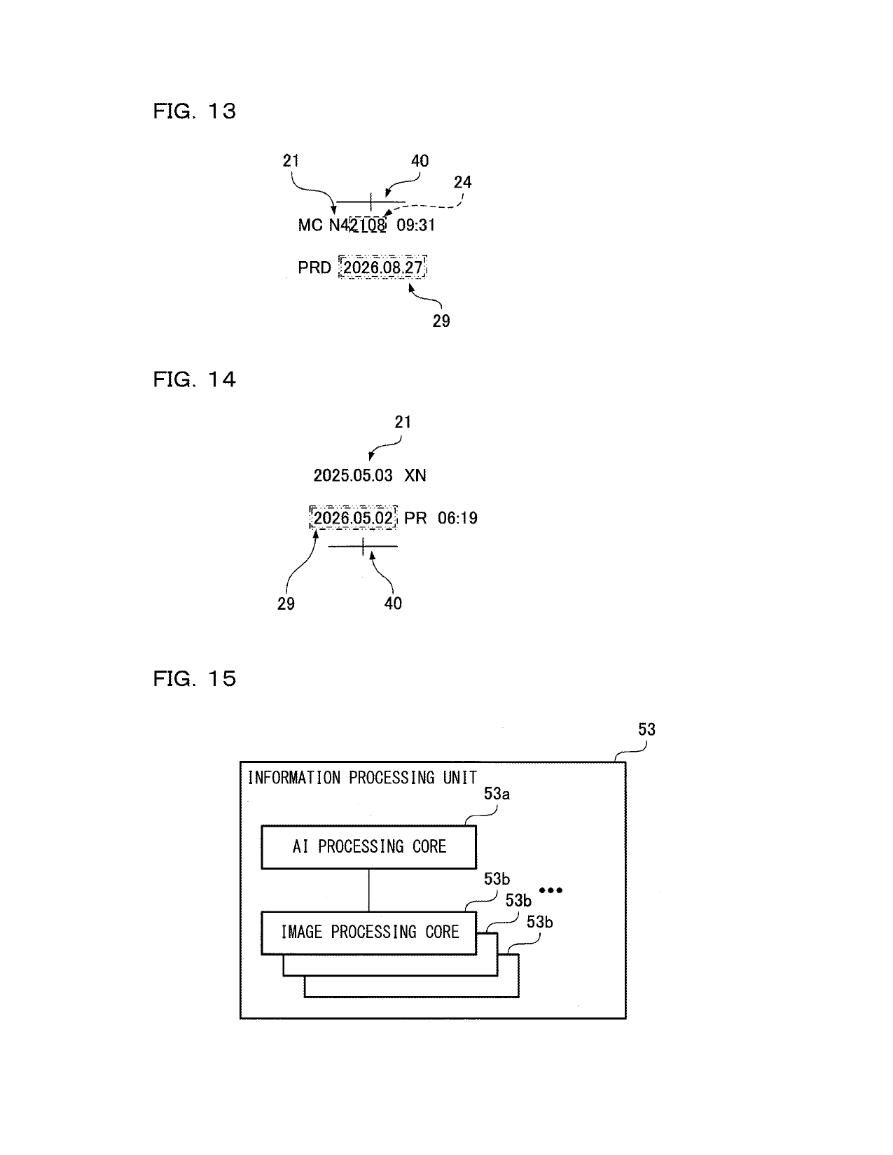

Next, referring to FIG. 13, we will explain the case where the output character string 29 is narrowed down based on the degree of matching with the format pattern. In FIG. 13, it is assumed that a format pattern ("9999.99.99") consisting of four numeric characters, a separator, two numeric characters, a separator, and two numeric characters has been predetermined for reading a date string representing a date. In FIG. 13, the aimer light 40 is irradiated near the character string candidate 21 "N42108". Among the character string candidates 21 near this aiming position, the string fragment 24 "2108" is a valid string as a date (August 2021), but its degree of matching with the format pattern is low. On the other hand, the character string "2026.08.27", which is located far from the aiming position of the aimer light 40, has a high degree of matching with the format pattern. Here, if the degree of matching with the format pattern for the string fragment 24 "2108" does not exceed the matching degree threshold, while the character string "2026.08.27" exceeds the matching degree threshold, then the character string "2026.08.27" is narrowed down as the output character string 29. Furthermore, if the calculation criteria for character string likelihood consider whether or not a separator is included in the date string, the string "2026.08.27", which includes separators, will be preferentially narrowed down as the output character string 29 from the viewpoint of character string likelihood.

Next, referring to FIG. 14, we will explain the case where the output character string 29 is narrowed down based on the distance to the aiming position. In FIG. 14, it is assumed that a format pattern similar to FIG. 13 has been predetermined for reading date strings. In FIG. 14, there are two character strings that could be date strings. For example, the upper character string "2025.05.03" represents the manufacturing date of the product, and the lower character string "2026.05.02" represents the expiration date of the product. When the user desires to read the lower character string representing the expiration date, the aimer light 40 is irradiated near the lower character string. In this case, both the upper character string (character string candidate 21) and the lower character string have similar degrees of matching with the format pattern, and both exceed the matching degree threshold. Additionally, the character string likelihood of both the upper and lower character strings is similar, and both exceed the predetermined likelihood threshold. In this case, since the character string with the shortest distance to the aiming position is the lower character string, the character string processing unit 54 can narrow down to the lower character string "2026.05.02" as the output character string 29. Furthermore, the character string processing unit 54 can also narrow down to the output character string 29 using the character string position likelihood, which is calculated based on the character string likelihood and the distance to the aiming position. While the upper and lower character strings have similar degrees of matching with the format pattern and character string likelihood, the character string position likelihood is higher for the lower character string, which has a shorter distance to the aiming position. Therefore, the character string processing unit 54 can narrow down to the lower character string "2026.05.02" as the output character string 29, which has the highest character string position likelihood.

Next, as another example of character string processing related to character strings, processing using the AI processing core 53a and multiple image processing cores 53b corresponding to the AI processing core 53a, which are possessed by the information processing unit 53 (FIG. 4), will be explained. FIG. 15 schematically shows the correspondence relationship between the AI processing core 53a and the image processing cores 53b included in the information processing unit 53.

The information processing unit 53 (processor such as CPU) of the control unit 50 preferably has, as shown in FIG. 15, an AI processing core 53a and multiple image processing cores 53b corresponding to the AI processing core 53a. Although multiple image processing cores 53b correspond to one AI processing core 53a, the number of AI processing cores 53a is not limited to one, and there may exist multiple combinations of AI processing cores 53a and image processing cores 53b. In other words, it is desirable to have multiple AI processing cores 53a, with multiple image processing cores 53b corresponding to each of the AI processing cores 53a. The character string processing unit 54 included in the information processing unit 53 also has these AI processing cores 53a and image processing cores 53b.

The AI processing core 53a possessed by the character string processing unit 54 executes character detection processing using the machine learning model 61 (FIG. 5). Specifically, the AI processing core 53a inputs an input image into the machine learning model 61 (artificial intelligence model, AI model). The machine learning model 61 detects multiple characters included in the input image and outputs information related to the detected multiple characters. The AI processing core 53a transmits the output of the machine learning model 61, that is, the information related to the detected multiple characters, to multiple image processing cores 53b. This character detection processing by the AI processing core 53a is executed at high speed.

The image processing core 53b executes character concatenation processing and calculation of character string likelihood. First, based on the information about multiple characters detected by the AI processing core 53a, the image processing core 53b obtains multiple character string candidates 21 by grouping multiple characters estimated to have high relevance to each other as character string candidates 21, based on the relative positions of characters and the relationship of sizes between characters. Furthermore, this character concatenation processing to obtain multiple character string candidates 21 based on the detected multiple characters may be executed by the AI processing core 53a.

The image processing core 53b calculates a character string likelihood for each of the acquired character string candidates 21 based on predetermined likelihood conditions. The likelihood conditions include, for example, a score indicating character likelihood, variation in typeface for each character, character string margin, and reading history information.

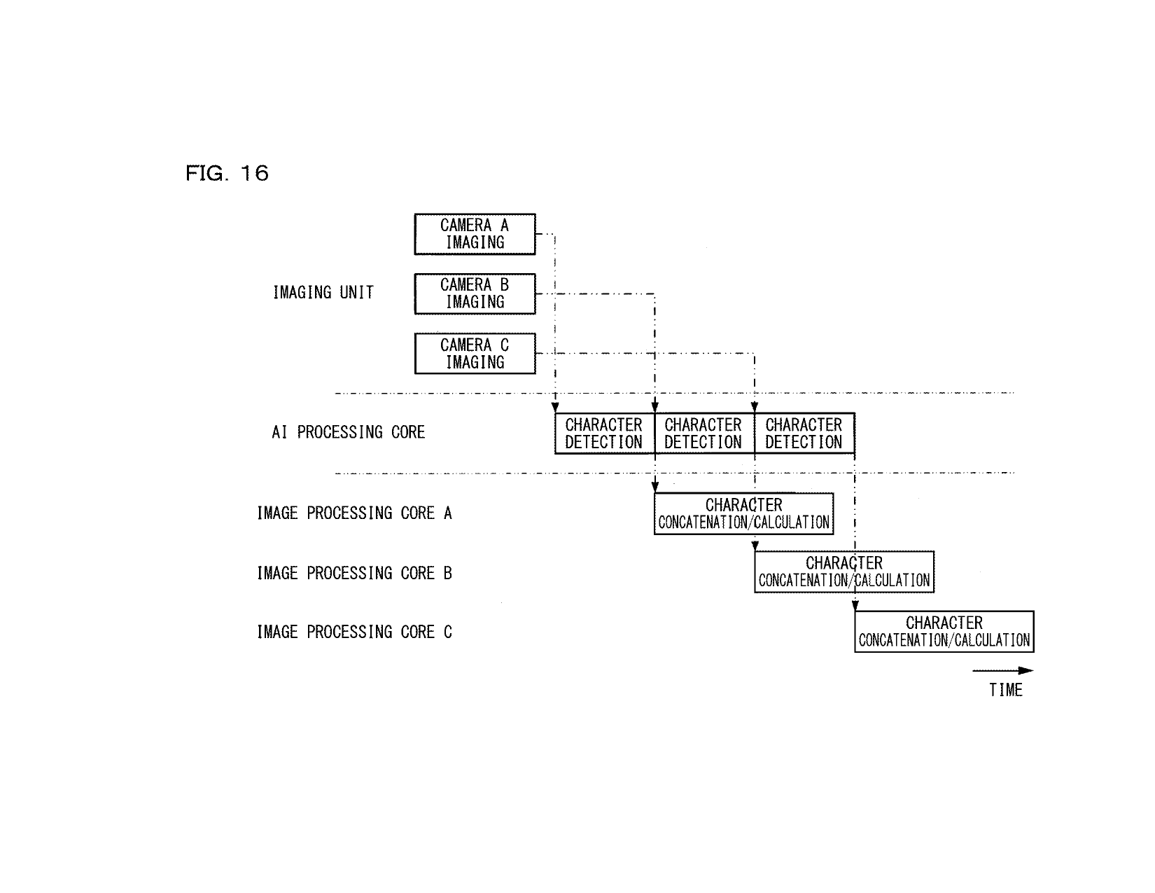

The processing by this image processing core 53b may take time compared to the processing in the AI processing core 53a. Therefore, as shown in FIG. 16, parallel processing is performed by multiple AI processing cores 53a to improve the overall processing speed of the optical information reading device 10. FIG. 16 shows the AI processing core 53a and the image processing core 53b operating in parallel.

For example, as shown in FIG. 16, suppose that the imaging unit 31 includes multiple camera units (here, three: Camera A, Camera B, and Camera C) each having an image sensor 36 and an imaging optical system 37. The input images captured by each camera unit are sequentially input to the AI processing core 53a. Furthermore, if there are multiple AI processing cores 53a, the input images from each camera unit may be input in parallel to each respective AI processing core 53a.

When character detection from the input image of the first camera unit (Camera A) is completed, information related to the detected characters is input to the image processing core 53b. The information related to the characters is sent to one of the multiple image processing cores 53b (in FIG. 16, there are three: image processing core A, image processing core B, and image processing core C) that is not performing other processing at that time (in this case, image processing core A).

While the image processing core A performs character concatenation processing and character string likelihood calculation, the AI processing core 53a performs character detection from the input image of the second camera unit (camera B). Therefore, the processing of the image processing core A for the input image of camera A and the processing of the AI processing core 53a for the input image of camera B are executed in parallel.

While character detection by the AI processing core 53a is processed at high speed, processing by the image processing core A takes more time compared to the AI processing core 53a, so there may be cases where the processing by the image processing core A has not been completed at the point when character detection from the input image of camera B is finished. Therefore, the AI processing core 53a transmits information regarding multiple characters detected from the input image of camera B to another image processing core 53b (image processing core B in FIG. 16) that is not performing processing.

As a result, the processing of image processing core A for the input image of camera A and the processing of image processing core B for the input image of camera B are executed in parallel. Similarly, AI processing core 53a sends information about multiple characters detected from the input image of camera C to image processing core C, enabling the processing of image processing core B and image processing core C to be executed in parallel.

As described above, by the AI processing core 53a sending information regarding multiple detected characters to multiple image processing cores 53b, the processes of character concatenation and character string likelihood calculation for multiple input images captured by multiple camera units are executed in parallel. This allows other image processing cores 53b and the AI processing core 53a to operate in parallel while one image processing core 53b is executing the character concatenation and character string likelihood calculation processes, thereby improving the overall processing speed of the optical information reading device 10.

The optical conditions (distance, angle, brightness of illumination, etc.) of the target object 11 relative to the optical information reading device 10 vary. Therefore, to correctly read the symbol information (in this case, the output character string 29) of the symbol 20, it may be necessary to repeatedly acquire multiple input images with different imaging conditions and perform reading processes. For example, input images are captured by multiple camera units with different focal lengths, and reading processes are executed for each input image. Here, parallel processing by the AI processing core 53a and the image processing core 53b enables high-speed execution of reading processes for multiple input images.

Furthermore, even if there is only one camera unit, the reading process is accelerated by parallel processing using the AI processing core 53a and the image processing core 53b. For example, it is preferable that imaging is repeated multiple times by one camera unit, and the captured input images are sequentially input to the AI processing core 53a. In this case as well, parallel processing by the AI processing core 53a and the image processing core 53b is performed, allowing the imaging by the camera unit, character detection by the AI processing core 53a, and character concatenation and character string likelihood calculation by the image processing core 53b to be executed in parallel, thereby improving the overall speed of the reading process.

Next, as another example of character string processing related to character strings, we will explain the case where a two-stage machine learning model 61 (FIG. 5) is used. As shown in FIG. 5, the machine learning model 61 should include a first model 61a and a second model 61b with a larger number of parameters than the first model 61a. Furthermore, the machine learning model 61 may include even more models with different numbers of parameters.

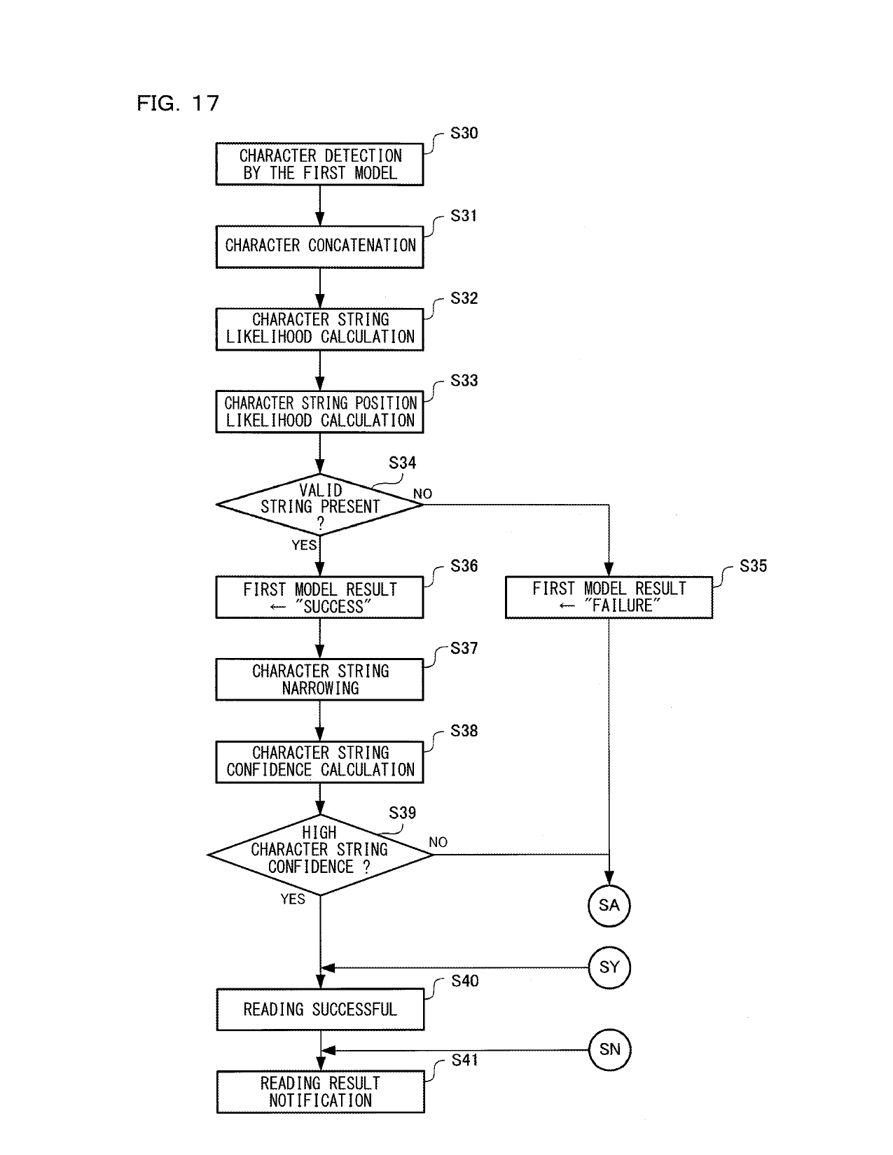

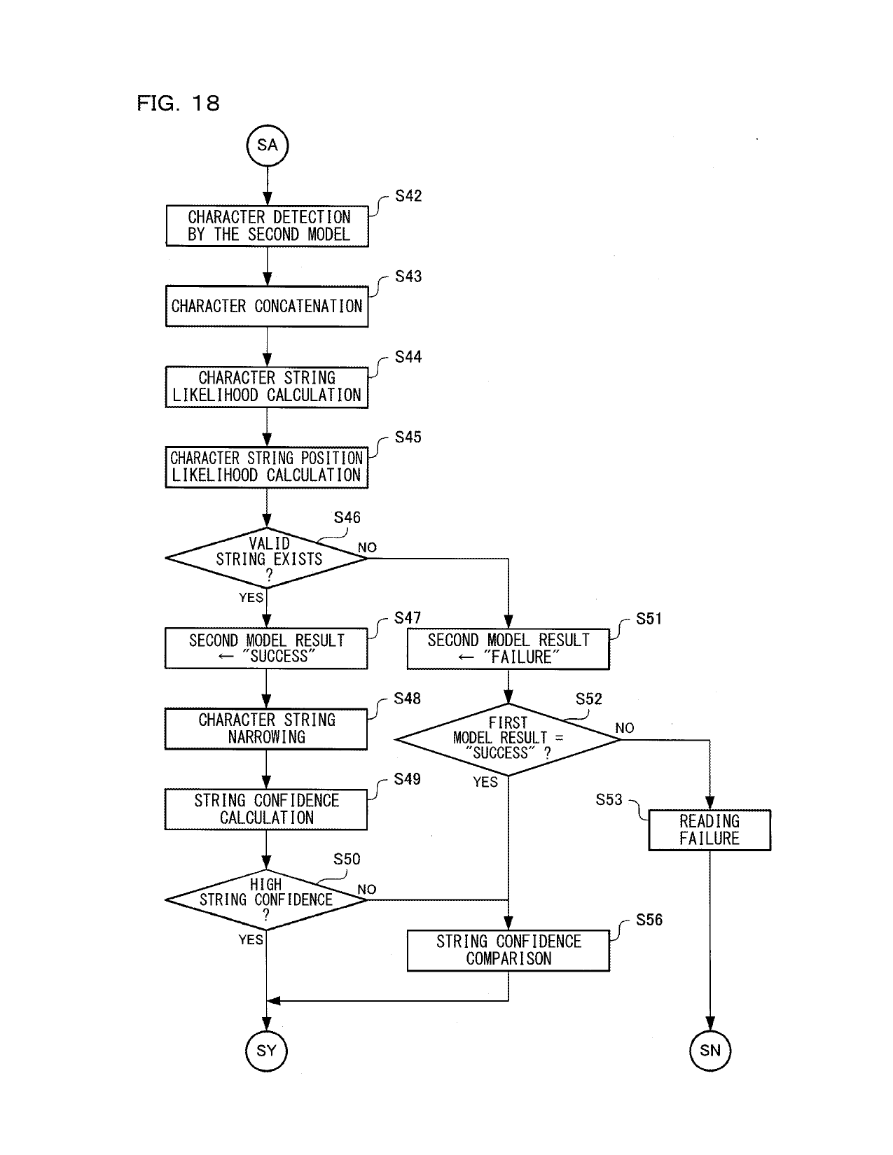

In character string processing, models with a large number of parameters (heavy models) generally enable detection with higher accuracy than models with a fewer number of parameters (lightweight models), while tending to take more time for processing. Therefore, the optical information reading device 10 achieves both high-accuracy reading and high-speed processing by using the first model 61a and the second model 61b in combination. The flowcharts shown in FIG. 17 and FIG. 18 illustrate the flow of character string processing using the first model 61a and the second model 61b. FIG. 18 shows a part of the character string processing in FIG. 17.

In step S30 of FIG. 17, the character string processing unit 54 first performs character detection processing to detect multiple characters contained in the input image using the first model 61a. Next, in step S31, the character string processing unit 54 performs character concatenation processing to obtain multiple character string candidates 21 from the input image based on the multiple characters detected by the first model 61a.

Then, in step S32, the character string processing unit 54 calculates the character string likelihood for each of the multiple obtained character string candidates 21 based on scores indicating the character likelihood, variation in typeface for each character, character string margins, reading history information, and so on. Furthermore, in step S33, the character string processing unit 54 calculates a composite score, which is the character string position likelihood, for each of the character string candidates 21 based on the character string likelihood and the distance to the aiming position.

When the character string position likelihood is calculated, the character string processing unit 54 determines in step S34 whether there exists a valid string (valid string) that can become an output character string 29 among multiple character string candidates 21. The determination of whether a valid string exists may be, for example, based on whether there exists a character string candidate 21 with a sufficiently high character string position likelihood (whether there exists a character string candidate 21 that exceeds a predetermined threshold).

If no valid character string exists (NO in step S34), the character string processing unit 54 proceeds to step S35 and stores information (such as a flag) indicating that the acquisition result of the character string candidate 21 using the first model 61a was "failed" in the storage unit 60. After that, the character string processing unit 54 proceeds to step SA and performs the acquisition of the character string candidate 21 using the second model 61b. The details of the processing using the second model 61b will be described later with reference to FIG. 18.

On the other hand, when a valid string exists (YES in step S34), the character string processing unit 54 proceeds to step S36 and stores information indicating that the acquisition result of the character string candidate 21 using the first model 61a was "successful" in the storage unit 60. Then, the character string processing unit 54 proceeds to step S37 and narrows down to the output character string 29. When there are multiple character string candidates 21, the character string processing unit 54 narrows down to the output character string 29 from the multiple character string candidates 21 based on the character string likelihood, distance to the aiming position, degree of matching with the format pattern, and so on.

Next, in step S38, the character string processing unit 54 calculates a string confidence score, which serves as an indicator for determining whether the narrowed-down output character string 29 has sufficient reliability for output. The string confidence score is an indicator showing the appropriateness as an output character string 29, and is calculated considering not only calculation criteria similar to the likelihood conditions of the character string likelihood (such as scores indicating character likelihood) but also the reliability of the input image itself. For example, if the lighting conditions during image capture by the imaging unit 31 are inappropriate and the character contrast (brightness difference between character parts and background parts) in the input image is insufficient, the string confidence score becomes low. In addition, even if the character string likelihood is high, the string confidence score may be low in cases where the input image itself has low reliability, such as when halation occurs in the input image due to light reflection.

Next, in step S39, the character string processing unit 54 determines whether the calculated string confidence is sufficiently high or not (for example, whether it exceeds a predetermined confidence threshold). If the string confidence is low (NO in step S39), the character string processing unit 54 proceeds to step SA and performs acquisition of character string candidates 21 using the second model 61b, which will be described later.

On the other hand, when the string confidence is sufficiently high (YES in step S39), the character string processing unit 54 proceeds to step S40 and determines that the reading of the character string from the input image has succeeded, and in step S41, notifies the reading result to the outside. For example, the information of the read output character string 29 may be displayed on the display unit 14 of the output unit 12, transmitted to the host computer 19 via the communication unit 16, or stored in the storage unit 60.

On the other hand, when the acquisition result of the character string candidate 21 using the first model 61a fails, or when the string confidence of the narrowed down output character string 29 is low, the acquisition of the character string candidate 21 using the second model 61b is performed. FIG. 18 shows a flowchart showing the flow of the process of acquiring the character string candidate 21 using the second model 61b, which is a part of the character string processing.

From step S42 to step S45 in FIG. 18, the character string processing unit 54 performs character detection, character concatenation, character string likelihood calculation, and character string position likelihood calculation using the second model 61b in the same manner as when using the first model 61a.

Then, in step S46, it is determined whether there is a valid string among the multiple character string candidates 21 obtained using the second model 61b. The second model 61b has more parameters than the first model 61a and can detect characters that are difficult to detect with the first model 61a. Therefore, even when a valid string could not be obtained by acquiring character string candidates 21 using the first model 61a, a valid string may be obtained using the second model 61b.

In the case where a valid character string exists (YES in step S46), the character string processing unit 54 proceeds to step S47 and stores information indicating that the acquisition result of the character string candidate 21 using the second model 61b was "successful" in the storage unit 60. Subsequently, the character string processing unit 54 performs the process of narrowing down to the output character string 29 and calculating the string confidence from step S48 to step S49.

Next, in step S50, the character string processing unit 54 determines whether the calculated string confidence is sufficiently high. If the string confidence is low (NO in step S50), the character string processing unit 54 proceeds to step S56 described later and compares the string confidence by the first model 61a with the string confidence by the second model 61b.

On the other hand, when the character string confidence is sufficiently high (YES in step S50), the character string processing unit proceeds to step SY and joins steps S40 and S41 in FIG. 17, and notify to the external device the successful reading result, considering that the reading of the character string from the input image has succeeded.

On the other hand, when no valid string exists in step S46 (NO in step S46), the character string processing unit 54 proceeds to step S51 and stores information indicating that the acquisition result of the character string candidate 21 using the second model 61b was a "failure" in the storage unit 60.

Subsequently, the character string processing unit 54 proceeds to step S52 and determines whether information indicating that the acquisition result of the character string candidate 21 using the first model 61a was "successful" is stored in the storage unit 60.

When the determination in step S52 is "NO", that is, when a valid string cannot be obtained as a character string candidate 21 using either the first model 61a or the second model 61b, the character string processing unit 54 proceeds to step S53 and considers the reading of the character string to have failed.

If the reading of the character string fails, the character string processing unit 54 proceeds to step SN and joins step S41 in FIG. 17 to notify that "reading has failed" as the reading result. For example, information indicating that "reading has failed" may be displayed on the display unit 14, sent to the host computer 19, or stored in the storage unit 60.

On the other hand, if the determination in step S52 is "YES", or if the determination in step S50 is "NO", the character string processing unit 54 proceeds to step S56 and compares the character string confidence obtained by the first model 61a with the character string confidence obtained by the second model 61b.

In step S56, either only one of the first model 61a and the second model 61b has succeeded in obtaining the character string candidate 21, or both models have succeeded in obtaining the character string candidate 21 but the string confidence of the output character string 29 is low.

Based on the comparison between the character string confidence obtained by the first model 61a and the character string confidence obtained by the second model 61b, the character string processing unit 54 proceeds to step SY with the output character string 29 obtained by the model with the higher character string confidence as the reading result, and notifies the external device of the reading result. In the case where only one of the first model 61a and the second model 61b succeeds in obtaining the character string candidate 21, it is preferable that the character string confidence of the output character string 29 obtained by the successful model is considered to be higher. Additionally, the reading result notified after comparing the character string confidences may include information indicating that the character string confidence is low.

When character string processing is performed using both the first model 61a and the second model 61b as described above, since the first model 61a is capable of high-speed processing, if a reading result with high character string confidence is obtained by the first model 61a, the processing can be completed quickly.

On the other hand, the second model 61b with many parameters takes more time to process compared to the first model 61a, but it is capable of reading with high accuracy. For example, characters directly attached to the object surface and covered with a film, as shown in FIG. 11, are difficult to read, and the lightweight first model 61a may not be able to read them successfully. Therefore, by using the heavyweight second model 61b, correct reading becomes possible. In this way, what can be read by the first model 61a is read at high speed, and character strings with high reading difficulty are read by the second model 61b, thereby achieving both high speed and high accuracy reading.

Furthermore, when the machine learning model 61 includes even more models (three or more) with different numbers of parameters, by using these models in combination, high speed can be maintained for character strings with low reading difficulty, while also being able to handle character strings with higher reading difficulty.

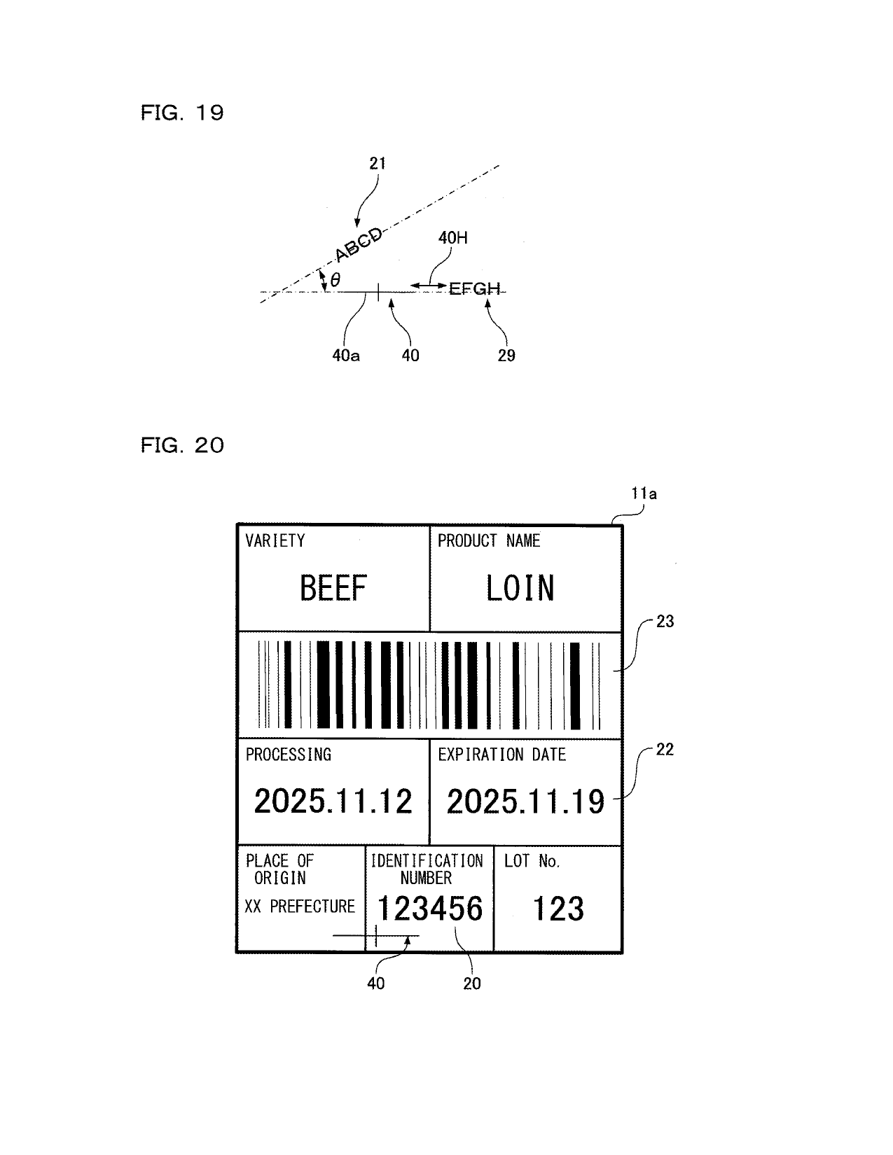

Furthermore, in the narrowing down to the output character string 29, it is preferable to also refer to the extending direction (character alignment direction) of the character string candidate 21. FIG. 19 is a diagram explaining the character string narrowing based on the extending direction of the character string candidate 21. As shown in FIG. 19, we will explain a case where the target object 11 (not shown in FIG. 19) has a character string "ABCD" as the character string candidate 21, and a character string "EFGH" that the user desires to set as the output character string 29. Here, the character string "ABCD" and the character string "EFGH" have different character alignment directions.

In this way, when multiple character strings with different character alignment directions exist, the user irradiates the aimer light 40 so that the extending direction of the character string desired to be the output character string 29 and the first direction 40H of the first aimer light 40a among the aimer light 40 match as much as possible.

Based on the position data and character size of each character included in the character string candidate 21, the character string processing unit 54 calculates the alignment direction of the characters, that is, the extending direction of the character string candidate 21. Then, the character string candidate 21 compares its extending direction with the orientation of the first aimer light 40a included in the aimer light 40.

The character string processing unit 54 calculates the degree of agreement (specifically, the smallness of the angle θ between the first direction 40H and the character alignment direction) between the extending direction of the character string candidate 21 and the first direction 40H. Then, the character string processing unit 54 narrows down to the output character string 29 based on the distance to the aiming position of the character string candidate 21 and the degree of directional agreement. For example, a composite score of the distance to the aiming position and the degree of directional agreement is calculated.

In FIG. 19, the character string "ABCD" is closer to the aiming position (corresponding to the position of the aimer light 40) than the character string "EFGH", but the character string "EFGH" has a higher degree of agreement (smaller angle) in the alignment direction of characters with respect to the first direction 40H. Character strings with a high degree of agreement with the first direction 40H are more likely to be the output character string 29 that the user desires to read. In this case, the character string "EFGH" will have a higher composite score, and the character string "EFGH" will be narrowed down as the output character string 29.

Thus, by referencing the extending direction of the character string candidate 21 in narrowing down to the output character string 29, when multiple character strings with different alignment directions exist, the character string in the alignment direction desired by the user is narrowed down as the output character string 29.

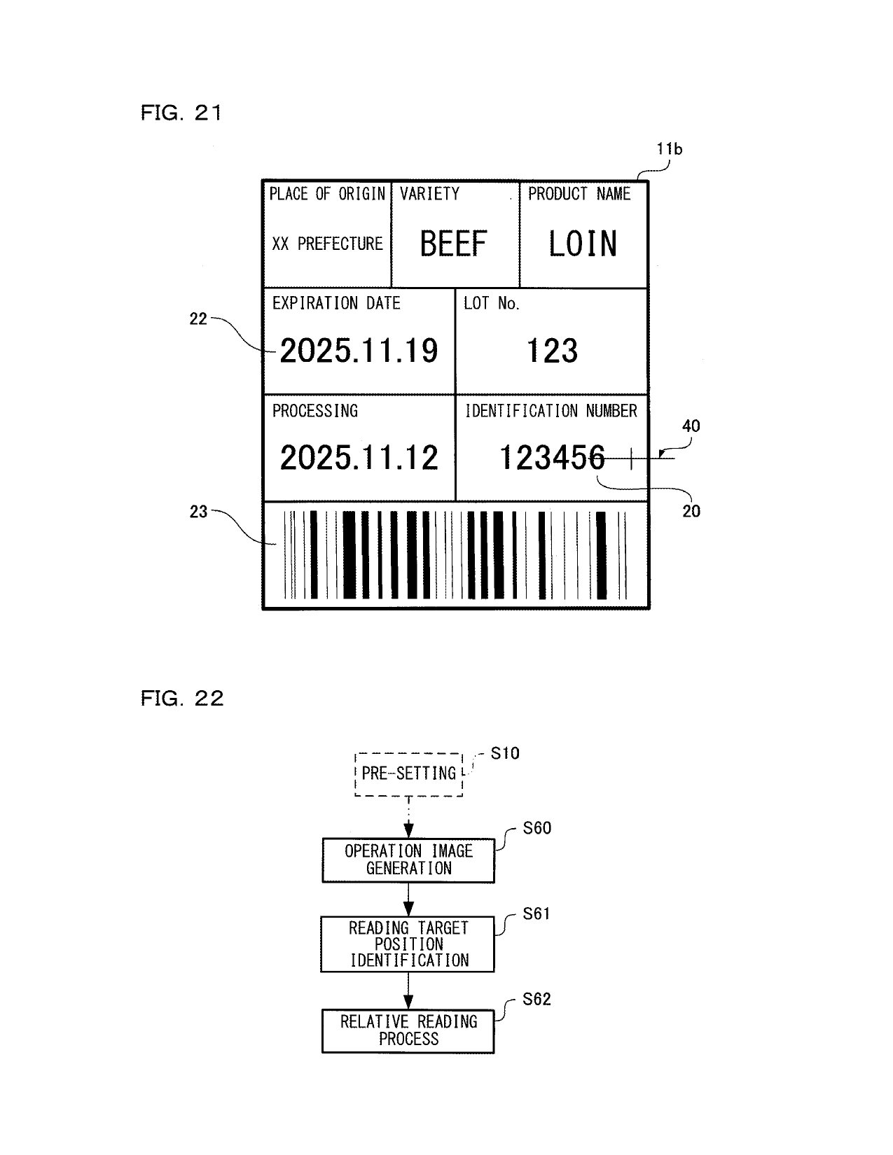

Next, another example of the reading process in step S16 of FIG. 6 will be explained. The following description is for a case where there are multiple types of target objects 11, including a first type object 11a as shown in FIG. 20 and a second type object 11b as shown in FIG. 21. However, in the following description, the first type object 11a and the second type object 11b may be collectively referred to as the target object 11 as necessary. FIG. 20 shows the first type object 11a with multiple symbols 20 attached. The first type object 11a is, for example, a receiving slip in warehouse management.

In the first type object 11a in FIG. 20, multiple character strings and a barcode 23 are attached as symbols 20. On the first type object 11a, multiple character strings indicating symbol information related to products stored in the warehouse are attached, such as the name of "variety", the name of "product name", the date when "processing" was performed, the date of "expiration date", the name of "place of origin", the numbers of "identification number", and the numbers of "lot No.". Additionally, the barcode 23 shows different symbol information (for example, the price of the product, etc.) encoded. The symbol information shown by the barcode 23 may include the same information shown in the character strings. Furthermore, the first type object 11a may include multiple symbols 20 other than character strings, such as two-dimensional codes, in addition to the barcode 23.

When multiple symbols 20 are attached to the first type object 11a as the reading target of the optical information reading device 10, the user may desire to read two or more symbols 20. For example, in expiration date management of products stored in a warehouse, information on the "identification number" of a product and its corresponding "expiration date" may be necessary.

In this case, the user desires to read the number "123456" representing the "identification number" and irradiates the aimer light 40 near the position of the "identification number" (or adjusts the position of the virtual aimer). At this time, it is preferable that not only the numbers of the "identification number" become the reading target, but also the date of the "expiration date" shown at a different position from the "identification number" becomes a reading target.

There may also be cases where the aiming position where the user irradiates the aimer light 40 of the optical information reading device 10 differs from the position of the symbol 20 indicating the symbol information necessary for the user's task. For example, in an environment where users are instructed to always irradiate the aimer light 40 on the barcode 23, the symbol information actually needed for the task may be the "expiration date", and this date may not be encoded in the barcode 23.

In this case, when the user irradiates the aimer light 40 at the position of the barcode 23, it is preferable for the optical information reading device 10 to read the date of the "expiration date" located at a different position from the barcode 23 as the reading target. Hereinafter, among the symbols 20 that are the reading targets, the position of the symbol 20 attached at a position different from the position (aiming position) where the aimer light 40 is irradiated may be referred to as the reading target position 22.

It is preferable that the optical information reading device 10 is capable of reading symbol information at a reading target position 22, which is different from the aiming position. The reading target position 22 is a position determined based on the aiming position and the reading target setting information generated according to user specification. For example, the user specifies the relative position of the reading target position 22 with respect to the aiming position where the aimer light 40 is irradiated. The optical information reading device 10 can identify the reading target position 22 based on the specified relative position and the aiming position. Hereinafter, regarding a target object 11 with at least one or more symbols 20 attached, the process of reading symbol information of one or more symbols 20 by performing image processing on the aiming position or the reading target position 22 by the optical information reading device 10 may be referred to as relative reading processing. The relative reading process is executed by the relative reading processing unit 55 (FIG. 4) of the optical information reading device 10. The relative reading process is particularly effective when performed on standardized documents where it is predetermined what information is written in which position on the target object 11. An example of a standardized document is a form such as a receiving slip. A form is an office paper with multiple fields set up for entering various information.

Furthermore, the positional relationship (relative position) between the aiming position and the reading target position 22 may differ depending on the type of the imaging target object 11. For example, FIG. 21 shows a second type object 11b with multiple symbols 20 attached. The second type object 11b is, for example, a shipping slip in warehouse management. The arrangement of symbols 20 differs between the first type object 11a and the second type object 11b. Therefore, even if the first type object 11a and the second type object 11b indicate information about the same product, the positional relationship between the aiming position and the reading target position 22 differs for the first type object 11a and the second type object 11b.

For example, in the first type object 11a shown in FIG. 20, the "expiration date" is indicated in the upper right of the "identification number", and this position becomes the reading target position 22. However, in the second type object 11b shown in FIG. 21, the position of the "expiration date" that becomes the reading target position 22 is in the upper left of the "identification number". The optical information reading device 10 of this embodiment, by setting the reading target setting information appropriately in advance, can read the symbol information at the reading target position 22 for both the first type object 11a and the second type object 11b through relative reading processing. Furthermore, the optical information reading device 10 is also capable of reading the symbol information of the symbol 20 located at or near the aiming position during the relative reading process.

FIG. 22 is a flowchart showing the flow of the reading process when the reading process in step S16 of FIG. 6 includes relative reading processing. Prior to the relative reading processing, pre-setting (step S10) is performed. As part of this pre-setting, the reading target setting described later is performed, and the reading target setting information used in the relative reading processing is set in advance. In addition, it is preferable that which of the multiple symbols 20 attached to the target object 11 can be a reading target is determined based on conditions predetermined in the pre-setting. For example, when the symbol 20 is a character string, it is preferable that the determination of whether it is a symbol 20 as a reading target is made based on predetermined format patterns and likelihood conditions of character string likelihood.

When a reading mode including relative reading processing is launched, the optical information reading device 10 first generates, in step S60, an operation image 64 (FIG. 5) including the symbol 20 attached to the target object 11 as a type of input image generated by the imaging unit 31. At this time, the user performs imaging with the imaging unit 31 while irradiating the aimer light 40 at the position desired to be the aiming position on the target object 11 (or aligning the virtual aimer displayed on the display unit 14 with the intended position).

Next, in step S61, the optical information reading device 10 identifies the reading target position 22 based on the aiming position (position corresponding to the aimer light 40) in the operation image 64 and the preset reading target setting information, by means of the relative reading processing unit 55 (FIG. 4) included in the information processing unit 53 of the control unit 50.

The relative reading processing unit 55, which has identified the reading target position 22, executes a relative reading process to read symbol information of at least one or more symbols 20 by performing image processing on the reading target position 22 in the operation image 64 in step S62. Here, if the reading target setting information is properly set for both the first type object 11a and the second type object 11b, the symbol information of the symbol 20 at the appropriate reading target position 22 is read for both the first type object 11a and the second type object 11b.

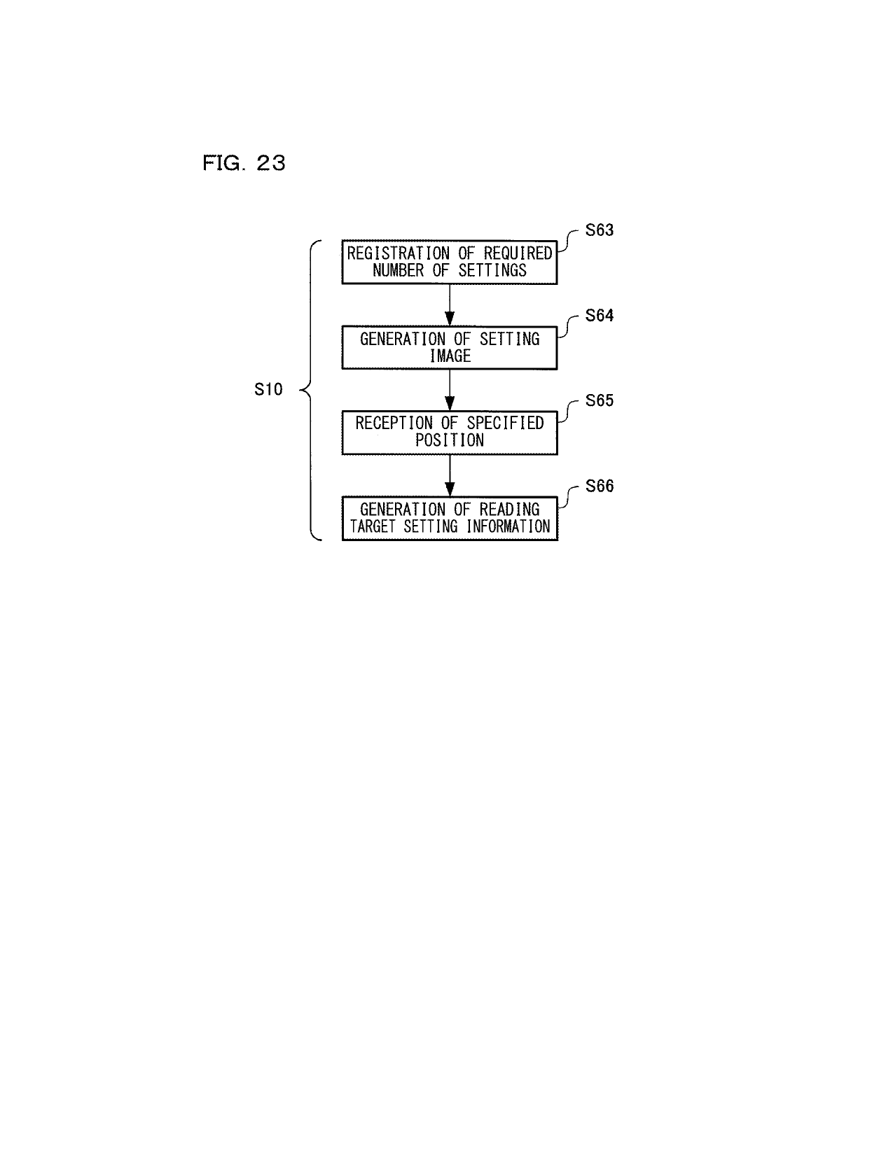

FIG. 23 is a flowchart showing the flow of reading target setting for relative reading processing. In an environment where relative reading processing is necessary (for example, a facility where warehouse management is performed), before capturing operation images in relative reading processing, a user executes reading target setting as part of pre-setting in advance. For example, reading target setting is executed when the "reading target setting" item is selected from the settings menu screen displayed on the display unit 14.

When the reading target setting is executed, the reading target setting unit 58 (FIG. 4) of the information processing unit 53 generates reading target setting information. The reading target setting unit 58 first accepts registration of the required number of settings in step S63. The required number of settings refers to the number of reading target setting information needed for the task performed by the user, specifically, the number of types of target objects 11 that are the subject of imaging in the task performed by the user, and the number of relative positions of the reading target positions 22 required for the target objects 11 are registered.

It is preferable that multiple types of reading target setting information are generated according to the number of types of target objects 11 to be imaged. For example, if there are two types of target objects 11, such as the first type object 11a and the second type object 11b, it is preferable that two types of reading target setting information are generated. The number of types of reading target setting information is registered by the user's operation in step S63.

Then, for each of the multiple types of target objects 11, the number of relative positions of the required reading target positions 22 is registered. When multiple symbols 20 are attached to the target object 11, multiple symbols 20 among them may become reading targets. The number of relative positions of the reading target positions 22 registered in step S63 corresponds to the number of symbols 20 that are reading targets.

Furthermore, in step S63, the format information and layout information of the symbol 20 to be read may be set. For example, it is preferable to set format information such as the format of the character string to be read, the standard type of barcode, the standard type of two-dimensional code, and layout information on how each symbol 20 is arranged on the target object 11. It should be noted that the required number of settings for each type does not necessarily need to be registered all at once at the start of the reading target setting, but may be registered as needed while the user proceeds with the reading target setting procedure.

Next, in step S64, the imaging unit 31 captures an area within the imaging field of view and generates a setting image 63 (FIG. 5) that includes the symbol 20 attached to the target object 11. When the setting image 63 is generated, the user (user) carrying the optical information reading device 10 irradiates the aimer light 40 onto a position on the target object 11 that will serve as the reference position for relative reading processing. Then, with the aimer light 40 irradiated at the reference position, the user operates the trigger key 18 to generate the setting image 63 that includes the symbol 20 attached to the target object 11. Although the generated setting image 63 does not necessarily need to include the aimer light 40, the optical information reading device 10 can calculate the irradiation position (reference position for relative reading processing) where the aimer light 40 was irradiated in the setting image 63.

Here, when there are multiple types of target objects 11, a setting image 63 corresponding to the type of the captured target object 11 is generated. For example, when there are two types of target objects 11, namely a first type object 11a and a second type object 11b, if the first type object 11a is captured, a first setting image 63a corresponding to the first type object 11a is generated. Similarly, when the second type object 11b is captured, a second setting image 63b corresponding to the second type object 11b is generated. Furthermore, when there are three or more types of target objects 11, it is preferable that more types of setting images 63 are generated according to the types of target objects 11.

After the setting image 63 is generated, the designation reception unit 57 (FIG. 4) accepts user designation for the setting image 63 in step S65 of FIG. 23. The user designation accepted in step S65 indicates the relative positions of multiple symbols 20 that are reading targets with respect to the aiming position. Specifically, the setting image 63 is displayed on the display unit 14 or the monitor of the host computer 19 (FIG. 2), and the user specifies the position (user-specified position) of the symbol 20 desired as the reading target from the displayed setting image 63. The designation reception unit 57 determines the position specified by the user within the setting image 63 as the user-specified position. When there are multiple symbols 20 to be read, the user specifies the positions of each of the multiple symbols 20 in the setting image 63.

When the setting image 63 is displayed on the display unit 14, the user (user) carrying the optical information reading device 10 designates a user-specified position via the operation unit 15. For example, when a cursor is displayed on the display unit 14 along with the setting image 63, it is preferable for the user to move the cursor using the direction keys included in the operation unit 15 and operate the trigger key 18 to designate the cursor position as the user-specified position. Furthermore, when the display unit 14 is integrated with the operation unit 15 as a touch panel display, it is preferable for the user to directly touch a position on the setting image 63 displayed on the display unit 14 to designate the user-specified position.

When the setting image 63 is displayed on the monitor of the host computer 19, the communication unit 16 (FIG. 4) transmits the setting image 63 to the host computer 19. Then, it is preferable for the user operating the host computer 19 to specify a position on the setting image 63 displayed on the monitor as the user-specified position using a pointing device such as a mouse. If the monitor of the host computer 19 is a touch panel display, the user may directly touch a position on the setting image 63 displayed on the monitor to specify the user-specified position. The designation reception unit 57 receives the information of the specified user-specified position via the communication unit 16.

Then, in step S66, the reading target setting unit 58 generates reading target setting information. The reading target setting information includes information on the relative positional relationship between the aiming position or the position of the symbol 20 adjacent to the aiming position in the setting image 63, and the user-specified position.

The reading target setting unit 58 generates the reading target setting information 76 (FIG. 5) based on the user-specified position on the setting image 63 accepted by the designation reception unit 57 in step S65 and the relative positional relationship between the aiming position of the aimer light 40 when the setting image 63 was captured. Here, the relative positional relationship between the user-specified position and the aiming position is included in the reading target setting information. When there are multiple types of target objects 11 (first type object 11a, second type object 11b, etc.), reading target setting information 76 (first reading target setting information 76a, second reading target setting information 76b, etc.) corresponding to the type of the captured target object 11 is generated.

Furthermore, the aiming position where the aimer light 40 is irradiated should be near the symbol 20, and it does not need to exactly match the position of the symbol 20. When there is no symbol 20 at the aiming position, the reading target setting unit 58 searches for a symbol 20 adjacent to (closest to) the aiming position within the setting image 63. Then, the position of the symbol 20 adjacent to the aiming position is treated as the reference position for relative reading processing instead of the aiming position. Hereafter, in the explanation of relative reading processing, both the aiming position and the position of the symbol 20 adjacent to the aiming position are collectively referred to as the "reference position". The reading target setting information generated in step S66 of FIG. 23 includes the relative positional relationship between the reference position and the user-specified position.

The relative reading processing unit 55 executes the relative reading process using the reading target setting information generated as described above. That is, the relative reading processing unit 55 identifies the reading target position 22 in the operation image 64 based on the relative positional relationship between the reference position and the user-specified position in the setting image 63. Specifically, the relative reading processing unit 55 first, in step S61 of FIG. 22, sets the aiming position of the aimer light 40 in the operation image 64 or the position of the symbol 20 adjacent to the aiming position as the reference position. Then, the relative reading processing unit 55 identifies the position corresponding to the user-specified position in the setting image 63 in terms of the relative positional relationship to the reference position as the reading target position 22 in the operation image 64.

Here, when there are multiple user-specified positions, multiple reading target positions 22 are identified according to their number. Additionally, when there are multiple types of reading target setting information, the type of reading target setting information corresponding to the type of captured target object 11 is used. For example, for the first type object 11a, the first reading target setting information 76a is used. The type of reading target setting information to be used may be specified by the user carrying the optical information reading device 10 or the user of the host computer 19, or it may be automatically selected by the optical information reading device 10. For instance, if layout information of the symbols 20 to be read is set for each type of target object 11, the optical information reading device 10 analyzes the layout of symbols 20 included in the operation image 64 and identifies the type of target object 11 that matches that layout. Then, the reading target setting information corresponding to the identified type of target object 11 is used for the relative reading process.

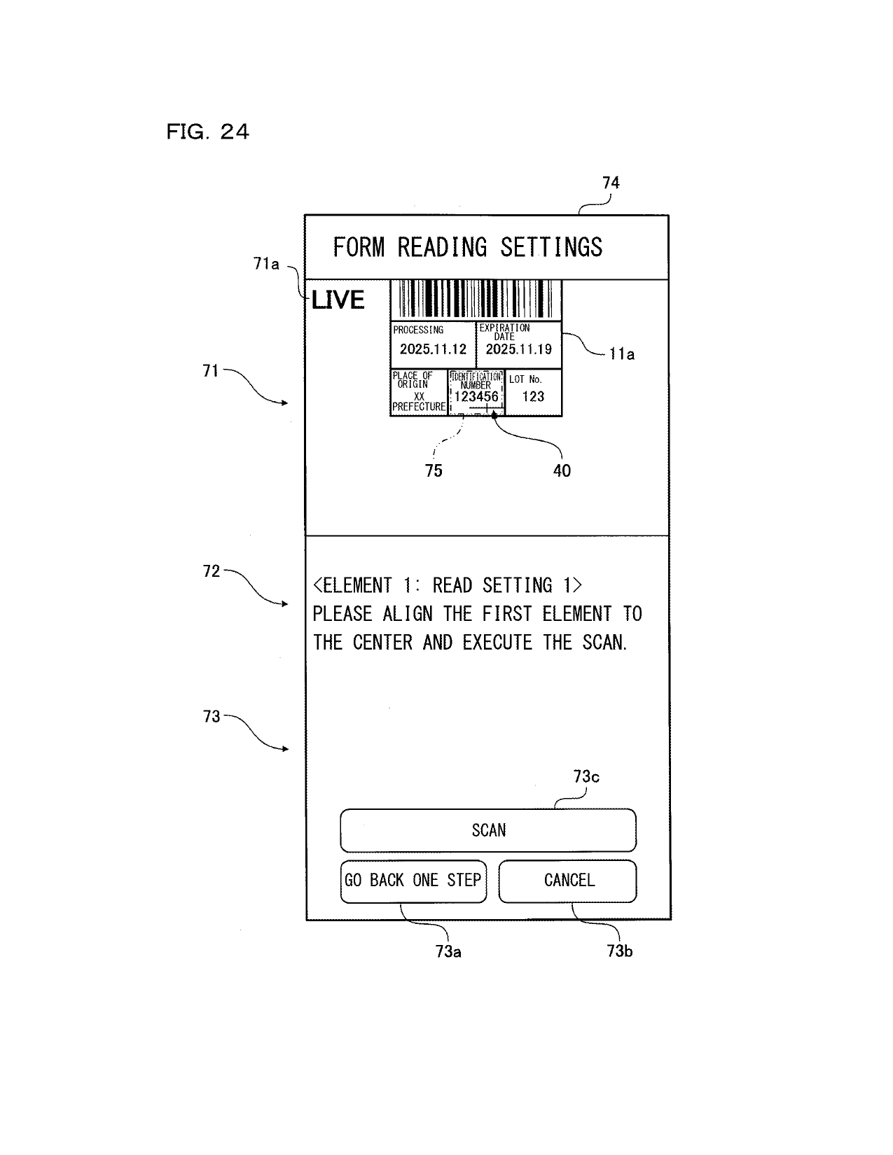

The following describes specific examples of reading target settings with reference to the drawings. FIG. 24 shows a reading target setting screen 74 for configuring reading target settings. The reading target setting screen 74 in FIG. 24 is a screen titled "Form Reading Settings". "Form Reading Settings" means configuring settings related to reading forms. When the user performs an operation to start the reading target setting in the pre-setting, the reading target setting screen 74 is displayed on the display unit 14. For example, it is preferable that the reading target setting starts when the user selects an icon for starting the reading target setting from the setting menu screen displayed on the display unit 14. When the reading target setting starts, the screen generation unit 52 (FIG. 4) of the optical information reading device 10 generates screen data for the reading target setting screen 74, and this screen data is sent to the output unit 12, resulting in the reading target setting screen 74 being displayed on the display unit 14.

The reading target setting screen 74 in FIG. 24 includes an image display area 71 where an image captured by the imaging unit 31 is displayed, a message area 72 where messages for the user are displayed, and an operation panel area 73 that accepts operations from the user.

When the reading target setting is initiated, first, a real-time video of the target object 11 (here, the first type object 11a) existing within the imaging field of view of the imaging unit 31 is displayed in the image display area 71. The real-time video represents the state within the imaging field of view at that point in time, which is currently being captured by the imaging unit 31. At this time, it is preferable that the image display area 71 includes a real-time mark 71a (here, the character string "LIVE") indicating that it is a real-time video.

In the message area 72, a message is displayed prompting the user to align the aiming position of the aimer light 40 with the position desired to be the reference position 75 for the relative reading process on the first type object 11a. In FIG. 24, the message "Please align the first element to the center and execute the scan." is displayed. This message prompts the user to align the aiming position (center of the aimer light 40) near the symbol 20 (first element) existing at the reference position 75. The aimer light 40 displayed in the image display area 71 is the aimer light reflected by the target object 11 after being irradiated by the aimer light irradiation unit 32, but it is not limited to this. In other words, the display unit 14 may superimpose a virtual aimer at the position where the aimer light reflected by the target object 11 after being irradiated by the aimer light irradiation unit 32 appears in the image display area 71. Also, if the optical information reading device 10 is not equipped with an aimer light irradiation unit 32, a virtual aimer is superimposed in the center of the image display area 71. It is preferable that the entire imaging field of view of the imaging unit 31, that is, the range to be captured by the imaging unit 31, is displayed in the image display area 71. When the aimer light 40 (or virtual aimer) is irradiated (or displayed) to use the center of the imaging field of view as the aiming position, the aimer light 40 (or virtual aimer) is displayed in the center of the image display area 71.

In the operation panel area 73, a back button 73a, a cancel button 73b, and a scan button 73c are arranged. When the back button 73a is operated, the display of the reading target setting screen 74 returns to the previous work screen (the settings menu screen in FIG. 24). When the cancel button 73b is operated, the reading target setting process is canceled, and the display of the reading target setting screen 74 returns to the settings menu screen. When the scan button 73c is operated, the generation of the setting image 63 is performed.

The user adjusts the attitude (orientation) of the carried optical information reading device 10 to align the aimer light 40 with the reference position 75. In FIG. 24, the position where the information (numbers) of the "identification number" as the symbol 20 is written is set as the reference position 75. In FIG. 24, for the purpose of explanation, the reference position 75 is surrounded by a virtual line (two-dot chain line), but the line surrounding the reference position 75 does not necessarily need to be displayed in the image display area 71.

Then, the user operates the scan button 73c with the aimer light 40 aligned with the reference position 75. As a result, the imaging unit 31 captures an image of the first type object 11a, and the first setting image 63a is generated. At this time, the position of the symbol 20 that was at or adjacent to the aiming position where the aimer light 40 was irradiated during imaging is treated as the reference position 75 in the first setting image 63a.

Furthermore, the operation in the reading target setting may be performed by a user of the host computer 19 at a location away from the optical information reading device 10. For example, when the reading target setting is initiated, screen data of the reading target setting screen 74 including real-time video of the first type object 11a captured by the imaging unit 31 is generated by the screen generation unit 52 (FIG. 4) and transmitted to the host computer 19 via the communication unit 16 of the output unit 12. Then, it is preferable that the reading target setting screen 74 including real-time video of the first type object 11a is displayed on the monitor of the host computer 19.

The user of the host computer 19 instructs the user carrying the optical information reading device 10 to align the aimer light 40 with the reference position 75, and operates the scan button 73c when the aimer light 40 is aligned with the reference position 75. Furthermore, the reference position 75 may be specified by the pointing device of the host computer 19.

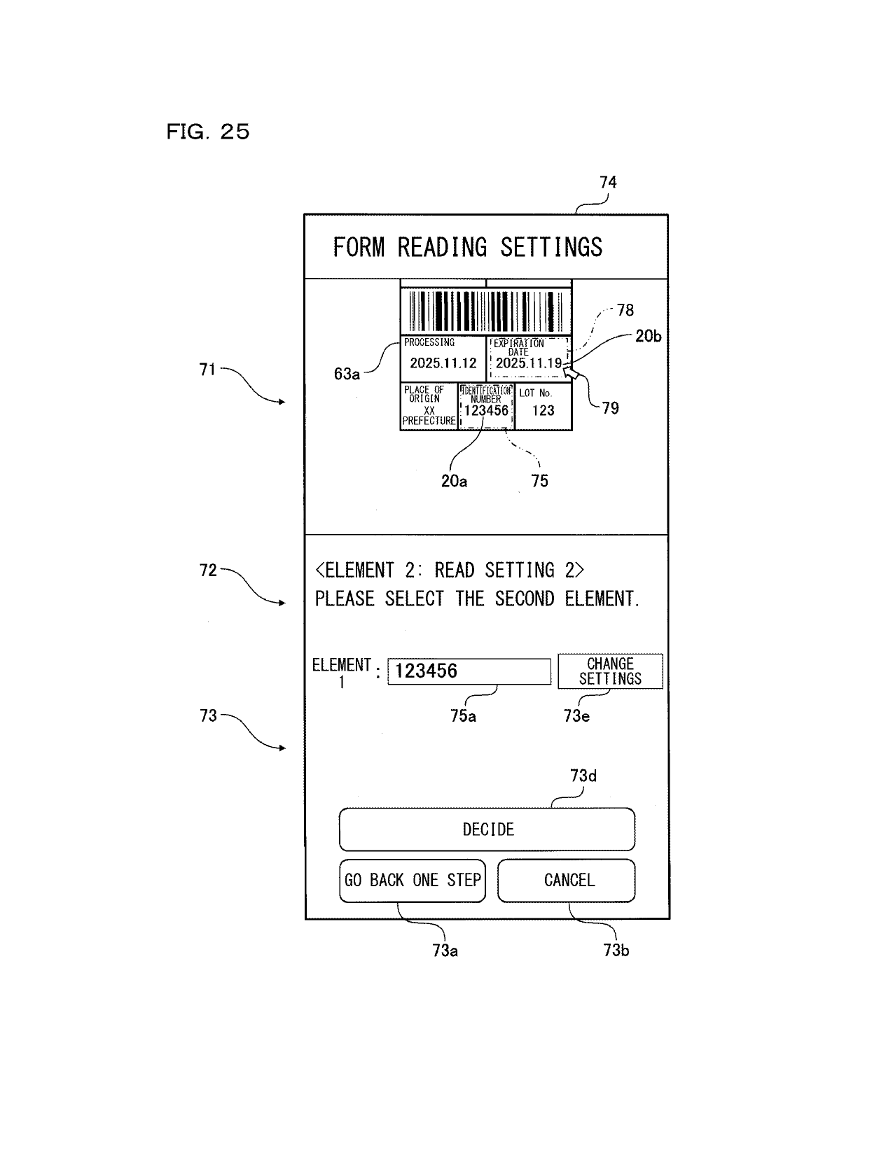

When the scan button 73c is operated, the display of the reading target setting screen 74 transitions to a state that accepts a user-specified position 78 related to the first type object 11a, as shown in FIG. 25. In this state, the first setting image 63a captured by the imaging unit 31 is displayed in the image display area 71. This reading target setting screen 74 (setting screen) including the first setting image 63a is generated by the screen generation unit 52 (FIG. 4) of the optical information reading device 10.

In the message area 72 of FIG. 25, the message "Please specify the second element." is displayed. This message prompts the user to specify the position where the second symbol 20b (the second element), which should be the target of relative reading processing in the first setting image 63a, is attached. Additionally, in FIG. 25, a decision button 73d is displayed in the operation panel area 73 instead of the scan button 73c.

Furthermore, the reading target setting screen 74, which includes the first setting image 63a in FIG. 25, contains the result of relative reading processing for the first symbol 20a at the reference position 75 (the symbol 20 that exists at the aiming position in the first setting image 63a, or the symbol 20 adjacent to the aiming position). When the first setting image 63a is captured, the relative reading processing unit 55 performs image processing on the first symbol 20a at the reference position 75 and reads the symbol information represented by the first symbol 20a.

The reading target setting screen 74 containing the first setting image 63a includes a first symbol information field 75a. In FIG. 25, the first symbol information field 75a is displayed between the image display area 71 and the message area 72. The first symbol information field 75a displays the result of the relative reading process for the first symbol 20a. Here, the numerical value "123456" is displayed in the first symbol information field 75a as the symbol information represented by the first symbol 20a. The user carrying the optical information reading device 10, or the user of the host computer 19, can confirm whether the symbol information of the first symbol 20a, which should be at the position to become the reference position 75, is correctly read by checking the content displayed in the first symbol information field 75a. Additionally, this allows the user carrying the optical information reading device 10, or the user of the host computer 19, to confirm whether the designation of the reference position 75 has been correctly performed.

Next to the first symbol information field 75a in FIG. 25, a setting change button 73e is displayed. When the setting change button 73e is operated, the display on the display unit 14 (or the monitor of the host computer 19) transitions to a screen (not shown) for changing setting information related to reading target settings. If the symbol information of the first symbol 20a is not correctly displayed in the first symbol information field 75a, the user should operate the setting change button 73e to change the setting information for reading the symbol information of the first symbol 20a.

For example, when the reading target is a character string, it would be good to change setting information such as the format pattern of the character string, margin threshold (size of blank space required to distinguish from other character strings), and character string contrast (brightness difference to distinguish between character parts and background parts). Furthermore, when the reading target is an encoded code (code in which information is encoded, such as barcodes or two-dimensional codes), it would be good to select an appropriate code standard type (such as CODE128) to decode that code.

After confirming that the symbol information of the first symbol 20a is correctly displayed in the first symbol information field 75a, the user proceeds to specify the user-specified position 78. The designation reception unit 57 (FIG. 4) of the optical information reading device 10 accepts the designation from the user (user) and determines the user-specified position 78 within the reading target setting screen 74 (setting screen).

The user designates the position where the second symbol 20b, which they wish to make the target of relative reading, is attached as the user-specified position 78 on the setting image 63 (here, the first setting image 63a) displayed on the display unit 14. For example, a cursor 79 is displayed on the display unit 14, and the user moves the cursor 79 using the direction keys included in the operation unit 15 to align the cursor 79 with the user-specified position 78. Here, the cursor 79 is aligned with the position of the second symbol 20b indicating "expiration date" located to the upper right of the reference position 75.

When an operator operates the decision button 73d while the cursor 79 is aligned with the position of the second symbol 20b, the designation reception unit 57 accepts the user's designation for the first setting image 63a and determines the position within the first setting image 63a specified by the user (in this case, the position of the second symbol 20b) as the user-specified position 78. In FIG. 25, for the purpose of explanation, the user-specified position 78 is enclosed by a virtual line (two-dot chain line), but the line enclosing the user-specified position 78 does not necessarily need to be displayed in the image display area 71.

Furthermore, the user-specified position 78 may be determined by the user of the host computer 19 specifying a position on the first setting image 63a displayed on the monitor of the host computer 19 using a pointing device. Also, when the display unit 14 (or the monitor of the host computer 19) is a touch panel display, the user (user) should touch the position on the first setting image 63a that will become the user-specified position 78.

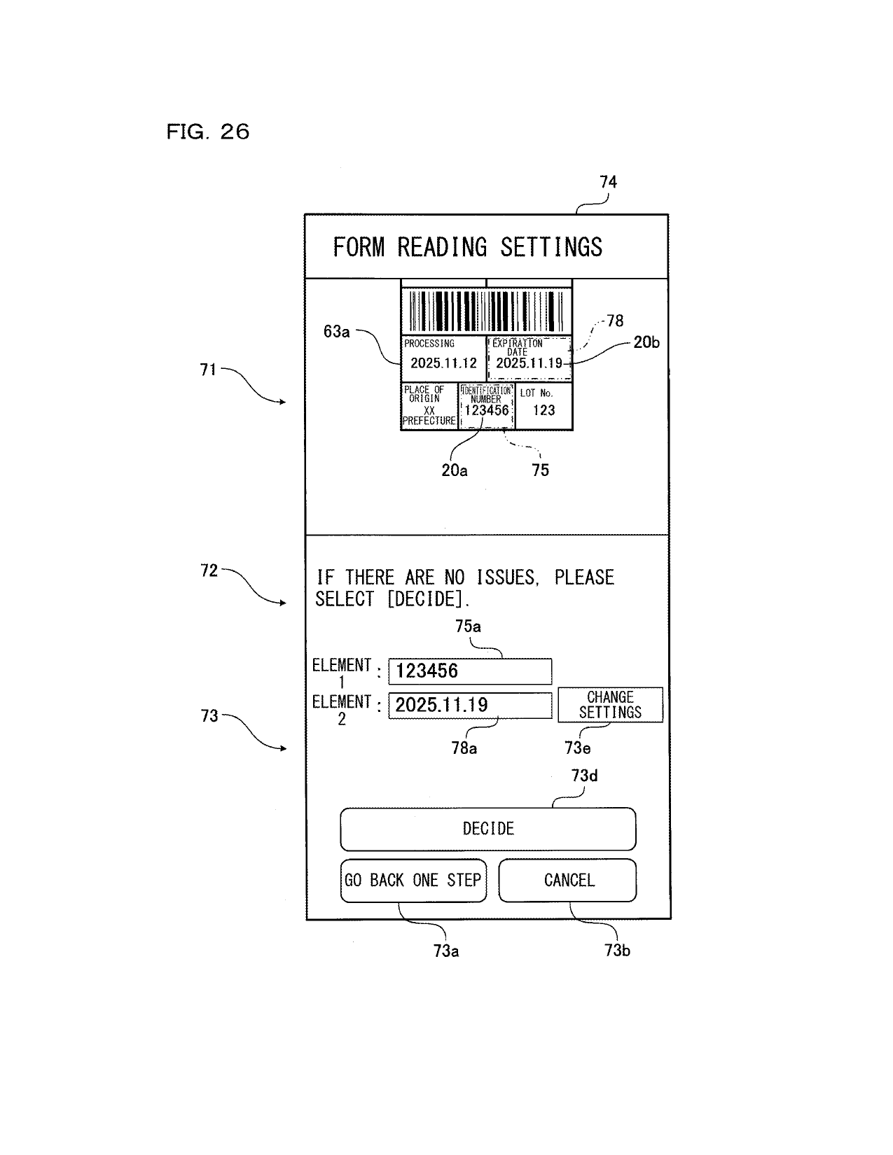

When the user-specified position 78 is determined, the display of the reading target setting screen 74 transitions to a state that displays a confirmation message for the specified position setting, as shown in FIG. 26. In FIG. 26, continuing from the state in FIG. 25, the first setting image 63a captured by the imaging unit 31 is displayed in the image display area 71.

Then, in FIG. 26, the message "Please select 'Decide' if there are no issues." is displayed in the message area 72. This message prompts the user to confirm whether there are any problems with the designation of the user-specified position 78.

The reading target setting screen 74 in FIG. 26 includes the result of relative reading processing for the second symbol 20b existing at the user-specified position 78 in the first setting image 63a. When the designation reception unit 57 determines the user-specified position 78, the relative reading processing unit 55 performs image processing on the second symbol 20b at the user-specified position 78 and reads the symbol information represented by the second symbol 20b.

The reading target setting screen 74 in FIG. 26 includes a second symbol information field 78a that displays the result of relative reading processing for the second symbol 20b. In FIG. 26, the second symbol information field 78a is displayed below the first symbol information field 75a. Here, the character string "2025.11.19" representing the expiration date as the symbol information indicated by the second symbol 20b is displayed in the second symbol information field 78a. The user carrying the optical information reading device 10 or the user of the host computer 19 can confirm whether the symbol information of the second symbol 20b existing at the position that should be the user-specified position 78 is correctly read by checking the content displayed in the second symbol information field 78a. Additionally, this allows the user carrying the optical information reading device 10 or the user of the host computer 19 to confirm whether the user-specified position 78 has been correctly specified.

Next to the second symbol information field 78a, a setting change button 73e is displayed. If the symbol information of the second symbol 20b is not correctly displayed in the second symbol information field 78a, the user (user) should operate the setting change button 73e to change the setting information for reading the symbol information of the second symbol 20b.

After confirming that the symbol information of the second symbol 20b is correctly displayed in the second symbol information field 78a, the user (user) confirms the designation of the user-specified position 78 by operating the decision button 73d in the operation panel area 73.

When the user-specified position 78 for the first setting image 63a is confirmed, the reading target setting unit 58 (FIG. 4) of the optical information reading device 10 generates reading target setting information 76 (first reading target setting information 76a) related to the first type object 11a and stores it in the storage unit 60. The reading target setting information 76 includes the relative positional relationship between the reference position 75 (aiming position or position of the first symbol 20a adjacent to the aiming position) in the setting image 63 (first setting image 63a) and the user-specified position 78. Furthermore, the positional relationship included in the reading target setting information 76 should preferably be stored as absolute coordinates within the first setting image 63a. For example, for elements within the first setting image 63a that are identified as symbols 20 existing at the reference position 75 or the user-specified position 78, the coordinates of the four corners (4 points) of the rectangle specified as the range of the symbol 20 should be stored. Alternatively, relative coordinates of the four corners of each symbol 20 with respect to that origin may be stored, using a position specified within the first setting image 63a, such as the center of the aimer light 40, as the origin.

In addition to the relative positional relationship between the reference position 75 and the user-specified position 78, the reading target setting information 76 should include various types of information used in the relative reading process. For example, the reading target setting information 76 should include the format pattern of the symbol 20 for which the relative reading process was executed (which could be the reading target) in the setting image 63, the number of reading targets (number of user-specified positions 78), layout information of the symbol 20 (arrangement of user-specified positions 78), and the size (first size) of the symbol 20 (first symbol 20a and second symbol 20b) that were subject to the relative reading process in the setting image 63. The reading target setting unit 58 should, for example, measure the number of pixels occupied by the symbol 20 in the setting image 63 to determine the first size. Additionally, at this time, the distance from the optical information reading device 10 to the object 11 (first type object 11a) may be measured by the distance measuring unit 34, and the measurement result may be included in the reading target setting information 76.

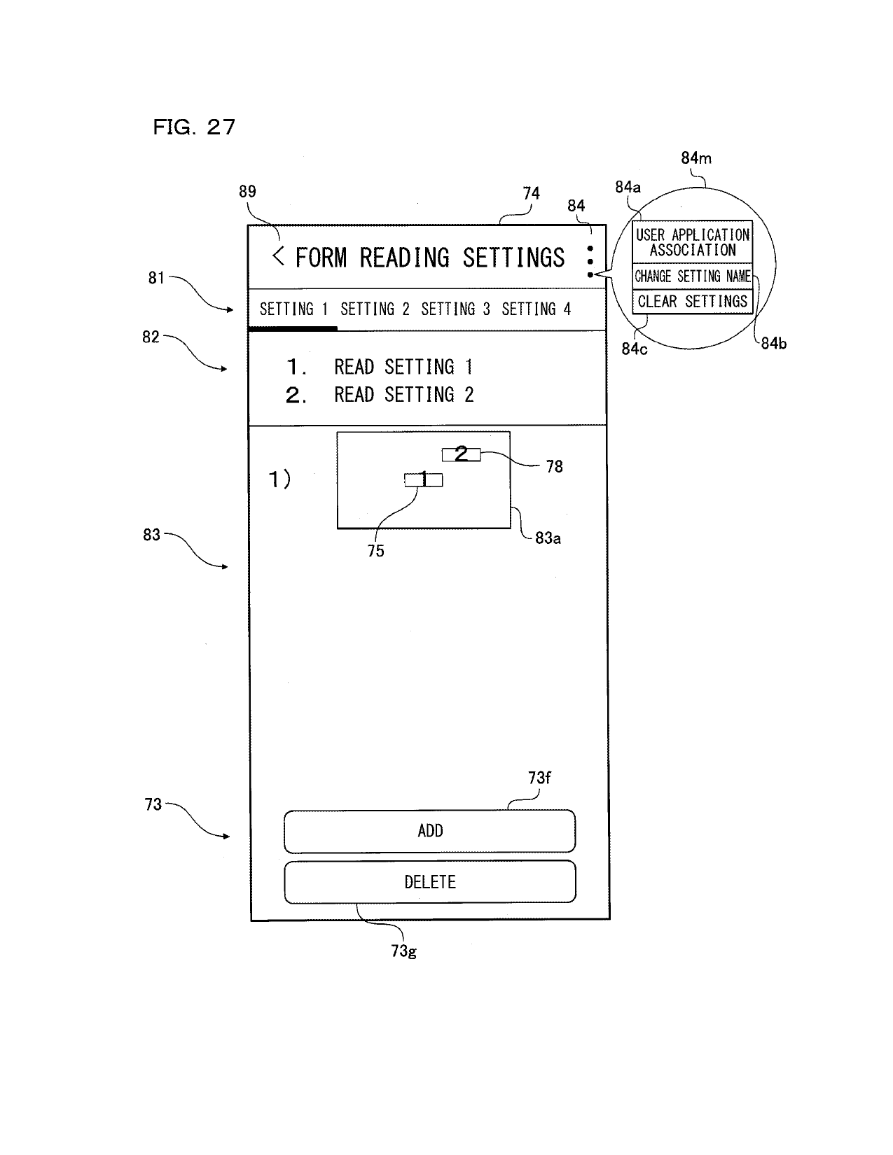

FIG. 27 shows the setting state of the reading target related to the first type object 11a. When the reading target setting unit 58 generates the reading target setting information 76, the display of the reading target setting screen 74 transitions to a state indicating the setting state of the reading target. The reading target setting screen 74 in FIG. 27 includes a preset selection area 81, a setting name display area 82, a setting state display area 83, and an operation panel area 73.

The preset selection area 81 is an area where the user selects which preset to apply from among multiple presets related to the reading target setting information 76. A preset is an existing setting prepared in advance regarding the reading target setting information 76. Multiple presets are prepared according to the type of relative reading process that the user performs. Moreover, the content of the currently applied preset can be modified by the user performing the reading target setting.

The user selects a preset to be applied to the relative reading process they will execute, or a preset whose content they want to modify. Here, four presets are shown, among which "Setting 1" preset is selected. FIG. 27 shows the state where the reading target setting information 76 included in the "Setting 1" preset has been modified by the reading target setting.

The setting name display area 82 is an area that displays names given to the reference position 75 and the user-specified position 78 set by the reading target setting. In FIG. 27, as initial names automatically assigned by the reading target setting unit 58, the name "Read Setting 1" is given to the reference position 75, and "Read Setting 2" is given to the user-specified position 78. These names can be arbitrarily changed by the user. Each of the names displayed in the setting name display area 82 is assigned a number (here, "1" and "2"). These numbers correspond to the numbers assigned to the reference position 75 and the user-specified position 78 in the setting state display area 83.

The setting state display area 83 is an area that indicates the setting state of the reading target set by the reading target setting. FIG. 27 shows a first setting FIG. 83a indicating the setting state of the reading target related to the first type object 11a. Specifically, the first setting FIG. 83a shows the relative positional relationship between the reference position 75 and the user-specified position 78.

The first setting FIG. 83a is shown as a rectangular frame, and within this frame, a rectangle indicating the reference position 75 and a rectangle indicating the user-specified position 78 are arranged. In FIG. 27, the reference position 75 is placed at the center of the first setting FIG. 83a, and it is shown that the user-specified position 78 is relatively positioned in the upper right with respect to this reference position 75. Also, the rectangles indicating the reference position 75 and the user-specified position 78 are labeled with numbers "1" and "2" respectively. These numbers indicate that each of the rectangles within the first setting FIG. 83a corresponds to the names displayed in the setting name display area 82.

On the left side of the first setting FIG. 83a, the number "1)" is shown. This number indicates that the first setting FIG. 83a corresponds to the first reading target setting information 76a based on the first setting image 63a obtained by capturing the first type object 11a. The first reading target setting information 76a is used when relative reading processing is performed on the first type object 11a.

The operation panel area 73 includes an add button 73f and a delete button 73g. When the add button 73f is operated, an addition of the setting state of the reading target is performed. Here, the process of adding reading target settings for the second type object 11b begins. When the delete button 73g is operated, the deletion of the reading target setting information 76 is performed. When there are multiple reading target setting information 76, the user can delete the reading target setting information 76 corresponding to a specific type of object 11 by selecting the figure corresponding to the reading target setting information 76 to be deleted among the figures displayed in the setting state display area 83 and then operating the delete button 73g.

In the upper left corner of the reading target setting screen 74 shown in FIG. 27, a setting screen exit icon 89 ("<" mark) is displayed. When this setting screen exit icon 89 is operated, the operation on the reading target setting screen 74 is temporarily suspended, and the display of the display unit 14 returns to the state (for example, the settings menu screen) before the reading target setting screen 74 was displayed.

An expanded menu icon 84 (a mark with three dots in a row) is displayed in the upper right corner of the reading target setting screen 74 in FIG. 27. When this expanded menu icon 84 is operated, expanded menu items 84m are displayed. The expanded menu items 84m preferably include a user application association button 84a for associating the reading target setting information 76 with the user application 90, a setting name change button 84b for changing the name displayed in the setting name display area 82, and a setting clear button 84c for erasing (clearing) various settings set in the reading target setting screen 74. For the sake of illustration, in FIG. 27, the expanded menu items 84m are shown outside the reading target setting screen 74, but in reality, the expanded menu items 84m should be displayed overlapping with the preset selection area 81, setting name display area 82, etc., inside the reading target setting screen 74.

When there are multiple types of target objects 11, the user operates the add button 73f to start the task of adding reading target settings for a different type of target object 11 (second type object 11b) from the first type object 11a. The task of adding reading target settings for the second type object 11b is similar to the task of reading target settings for the first type object 11a, except that the imaging target becomes the second type object 11b.

In other words, the user captures the second setting image 63b with the aimer light 40 aligned with the position of the first symbol 20a of the second type object 11b (similar to FIG. 24). Then, the user confirms that the symbol information of the first symbol 20a at the reference position 75 in the second setting image 63b is correctly read, and specifies the position of the second symbol 20b as the user-specified position 78 (similar to FIG. 25). As a result, a confirmation message "Please select 'Confirm' if there are no issues." regarding the specified position setting for the second type object 11b (element 2) is displayed in the message area 72 of the reading target setting screen 74.

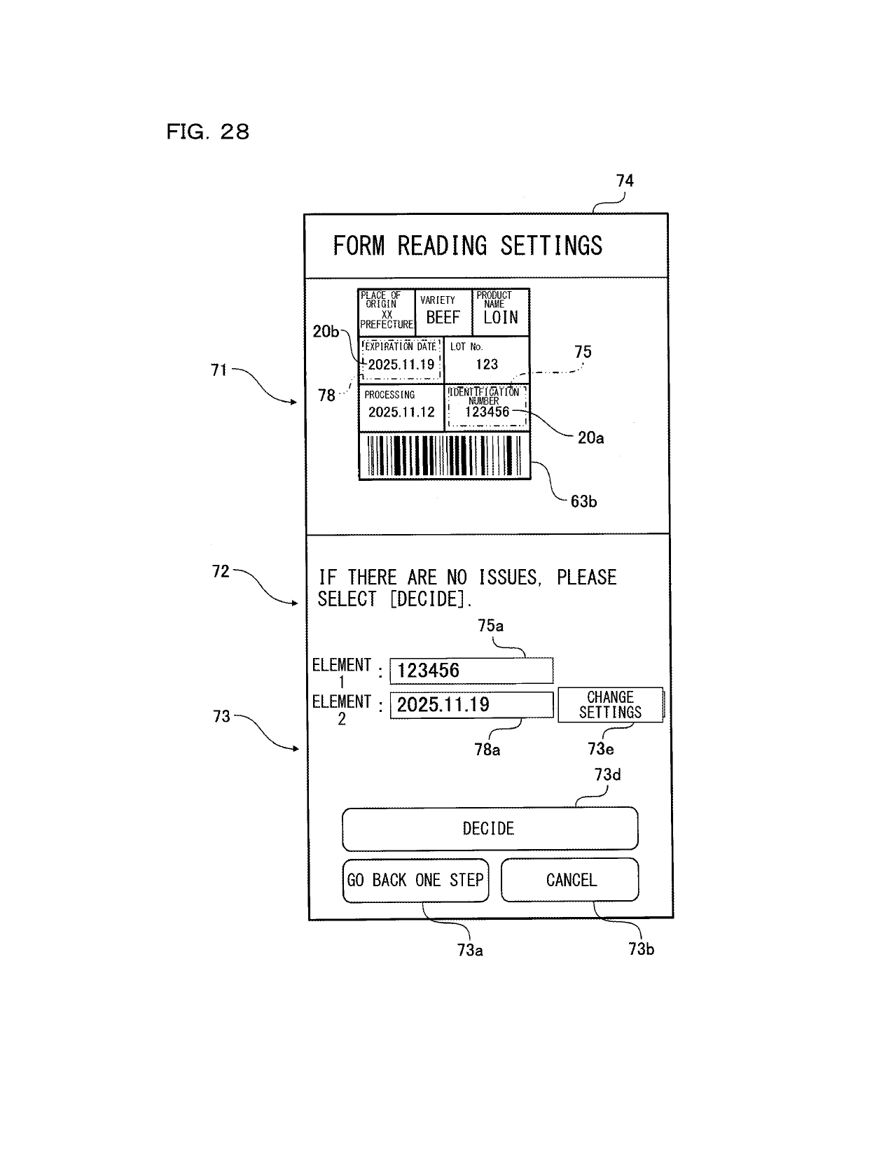

FIG. 28 shows the reading target setting screen 74 in a state where a confirmation message for the specified position setting related to the second type object 11b is displayed. In the reading target setting for the second type object 11b, the second setting image 63b is displayed in the image display area 71. In the second setting image 63b of FIG. 28, the upper left position of the central reference position 75 is specified as the user-specified position 78.

When the user confirms that the symbol information of the second symbol 20b at the user-specified position 78 is correctly displayed in the second symbol information field 78a, the user operates the decision button 73d to confirm the specification of the user-specified position 78 for the second setting image 63b.

When the user-specified position 78 for the second setting image 63b is confirmed, the reading target setting unit 58 generates the second reading target setting information 76b related to the second type object 11b and stores it in the storage unit 60. Subsequently, the display of the reading target setting screen 74 transitions to a state indicating the setting status of the reading target.

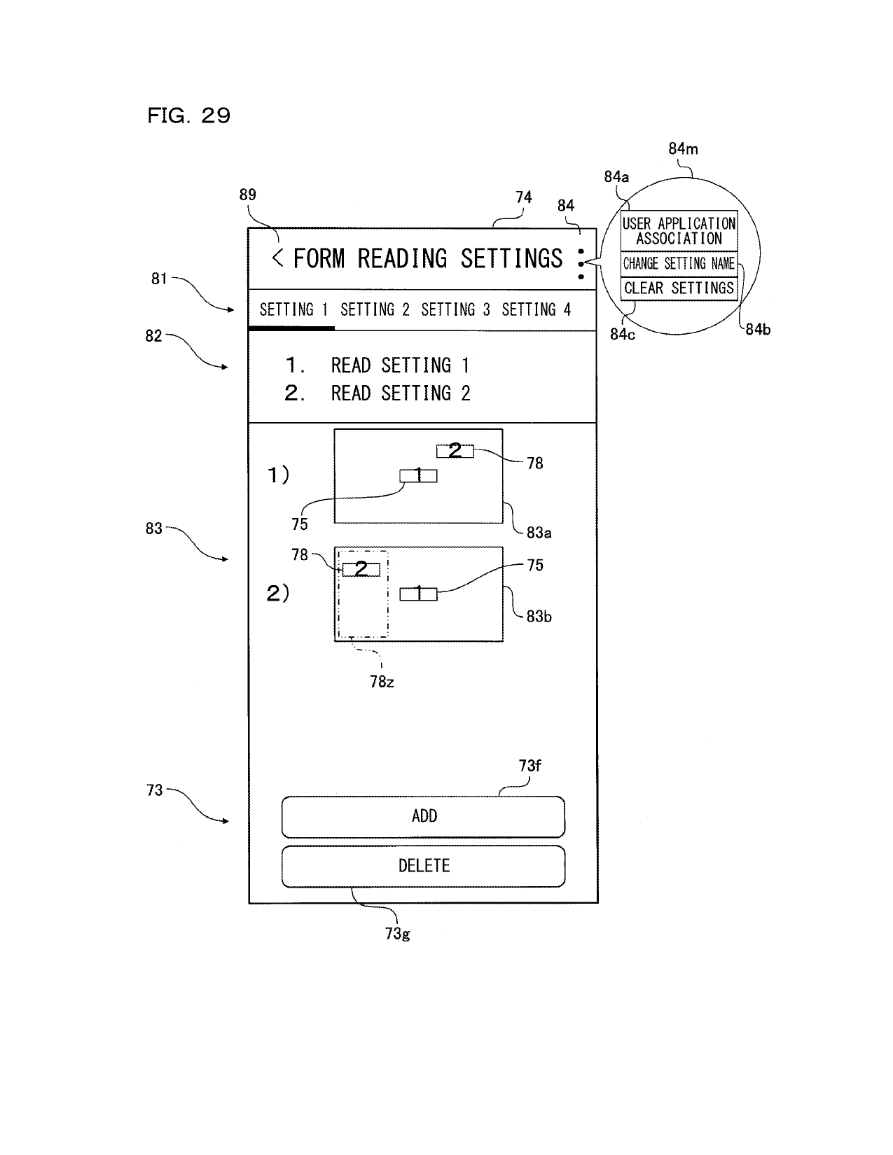

The reading target setting screen 74 in FIG. 29 shows the setting status of reading targets related to the first type object 11a and the second type object 11b. In this state, the reading target setting screen 74 displays, in addition to the display in FIG. 27, a second setting FIG. 83b in the setting state display area 83, which indicates the setting status of the reading target related to the second type object 11b. The second setting FIG. 83b shows the relative positional relationship between the reference position 75 and the user-specified position 78 set in the second setting screen 74b. In FIG. 29, it is shown that the user-specified position 78 is relatively positioned in the upper left with respect to the central reference position 75.

On the left side of the second setting FIG. 83b, the number "2)" is shown. This number indicates that the second setting FIG. 83b corresponds to the second reading target setting information 76b based on the second setting image 63b obtained by capturing the second type object 11b. The second reading target setting information 76b is used when relative reading processing is performed on the second type object 11b.

Furthermore, the reading target setting unit 58 may include in the reading target setting information the relative positional relationship between the reference position 75 (the aiming position or the position of the symbol 20 adjacent to the aiming position) in the setting image 63 and the user-specified area 78z including the user-specified position 78. The user-specified area 78z, as shown by the virtual line (two-dot chain line) in FIG. 29, is an area that includes the user-specified position 78 and is wider than the user-specified position 78. For example, if among multiple target objects 11, the user-specified position 78 is often located to the left of the reference position 75, it would be beneficial to set a user-specified area 78z that includes the user-specified position 78, instead of setting the user-specified position 78 for each of the multiple types of target objects 11.

For example, when the setting image 63 (first setting image 63a in FIG. 25, second setting image 63b in FIG. 28, etc.) is displayed in the image display area 71, it is preferable that the range of the user-specified area 78z is designated by dragging the pointing device (or flicking on the touch panel). Alternatively, as shown in FIGS. 27 and 29, when the setting status of the reading target is displayed, it may be possible to expand the range of the user-specified position 78 using a pointing device or the like to reset it as the user-specified area 78z. Additionally, the user-specified area 78z may be designated by methods such as: (1) specifying only the direction such as "right", "left", "up", or "down" relative to the reference position 75, (2) specifying a range within a predetermined distance from the reference position 75, i.e., a circular range centered on the reference position 75 as the user-specified area 78z, (3) specifying a range of a predetermined angle with respect to a horizontal axis passing through the reference position 75 as the user-specified area. Moreover, as another example of the method for setting the reading target, it is possible to set the reading target by methods such as: (4) specifying the positional relationship with the reference position 75 for only some of the multiple elements (symbols) that are reading targets, while leaving the positions of the remaining elements arbitrary (they can be anywhere), (5) designating as reading targets in order of proximity to the reference position 75, (6) treating the user-specified position 78 as a new reference position and storing the position of the third reading target element as a relative position from this new reference position. The reading target setting unit 58 should generate reading target setting information so that the relative reading processing unit 55 can read information from the reading target set by the above methods.

When performing tasks such as warehouse management that involve handling target objects 11, the user captures an operation image 64 by imaging the target object 11. At this time, the user irradiates aimer light 40 onto the target object 11 to specify the reference position 75. The relative reading processing unit 55 identifies the reading target position 22 in the operation image 64 based on the reading target setting information 76 (first reading target setting information 76a, second reading target setting information 76b) configured as described above.

Then, the relative reading processing unit 55 reads the symbol information represented by the symbol 20 existing at the reading target position 22, which is different from the reference position 75, by performing image processing on the reading target position 22. Additionally, at this time, the symbol information of the symbol 20 existing at the reference position 75 may also be read along with the symbol 20 at the reading target position 22.

Because the user specifies the reference position 75 using the aimer light 40 both when capturing the setting image 63 and when capturing the operation image 64, even if the setting image 63 and the operation image 64 are captured under different imaging conditions, the relative reading processing unit 55 can investigate the relative position from the reference position 75 in the operation image 64 and thus reliably identify the reading target position 22 corresponding to the user-specified position 78 without any problems. This enables the optical information reading device 10 to stably read symbol information.

Furthermore, the reading target setting unit 58 may measure the size (second size) of the symbol 20 that became the execution target of the relative reading target in the operation image 64. In the case where the first size of the symbol 20 that became the execution target of the relative reading process in the setting image 63 is included in the reading target setting information, the reading target setting unit 58 should identify the position in the operation image 64 corresponding to the user-specified position 78 based on the comparison result between the first size and the second size.

Furthermore, the reading target setting unit 58 may measure the distance to the target object 11 by the distance measuring unit 34 when generating the operation image 64, and specify the position in the operation image 64 corresponding to the user-specified position 78 based on the comparison result between the measured distance and the distance measured when generating the setting image 63.

For example, the reading target setting unit 58 calculates the actual dimensions of the symbol 20, which is the reading target, by comparing the distance between the imaging unit 31 and the target object 11 when the setting image 63 is captured with the first size. Then, the reading target setting unit 58 identifies the position of the symbol 20 with dimensions matching those calculated from the setting image 63 by comparing the distance between the imaging unit 31 and the target object 11 during the capture of the operation image 64 with the second size, as the position corresponding to the user-specified position 78. The reading target setting unit 58 reads the symbol information of the symbol 20 existing at the position corresponding to the user-specified position 78.

The symbol information read in this manner is used for various tasks such as warehouse management performed by users. As an example, it is preferable that the read symbol information is stored in the input field 91 of the user application 90 (FIG. 5) used by the user. By the user associating the reading target setting information 76 with the user application 90 in advance, it is determined which symbol information is stored in which input field 91.

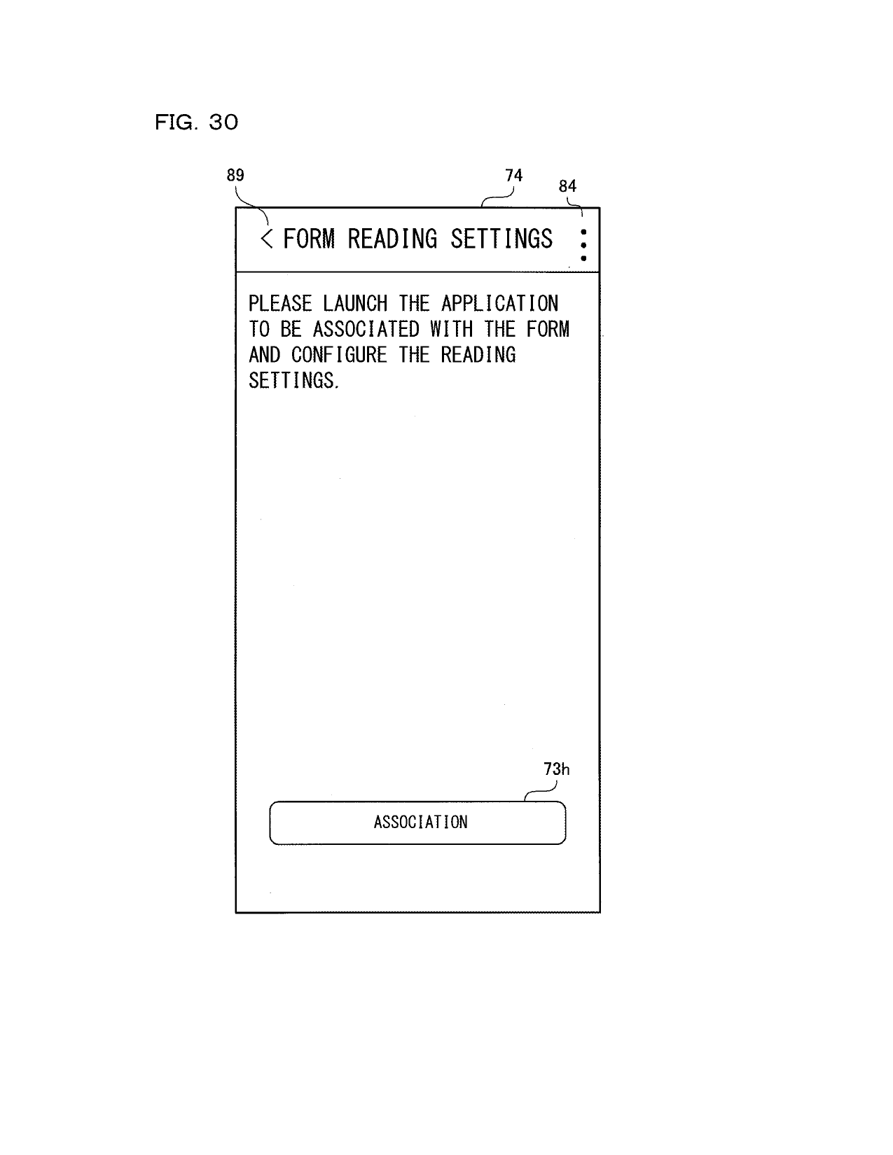

The association between the reading target setting information 76 and the user application 90 is initiated, for example, when the user operates the user application association button 84a from the extended menu item 84m in FIG. 29. When the user application association button 84a is operated, the display of the reading target setting screen 74 transitions to a screen displaying a message prompting the launch of the user application 90, as shown in FIG. 30.

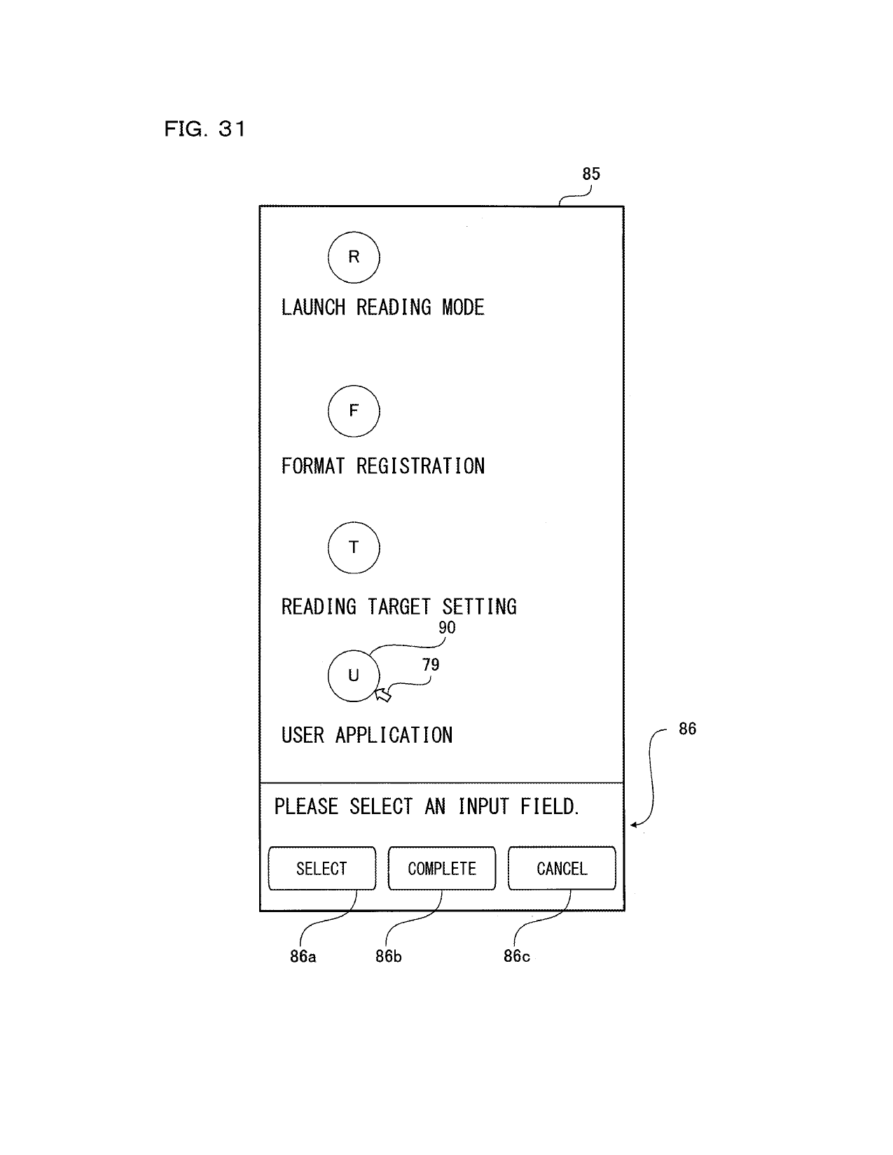

The reading target setting screen 74 in FIG. 30 displays a message saying, "Please launch the application to be associated with the form and perform the reading settings." This message prompts the user to launch the user application 90 that has an input field 91 where the symbol information of the symbol 20 attached to the imaging target object 11 (in this case, a form) should be stored. When the user operates the association button 73h displayed on this screen, the display on the display unit 14 transitions to the application selection screen 85 as shown in FIG. 31.

On the application selection screen 85, icons for launching various applications used by the user are displayed. In FIG. 31, multiple icons such as "Launch Reading Mode", "Format Registration", "Reading Target Setting", and "User Application" are shown. The user operates the cursor 79 to select the icon of the desired user application 90.

When transitioning from the reading target setting screen 74 to the application selection screen 85, an input field selection panel 86 is displayed in a part (here, the lower part) of the application selection screen 85. The input field selection panel 86 includes a selection button 86a, a completion button 86b, and a cancel button 86c. The user confirms the selection of the user application 90 by operating the selection button 86a while the icon of the desired user application 90 is selected with the cursor 79. Furthermore, if the display unit 14 is a touch panel display, the user application 90 may be selected when the user touches the icon of the user application 90.

Furthermore, when the completion button 86b is operated, the setting information related to the input fields 91 selected up to that point is included in the reading target setting information 76 and stored, and the association with the user application 90 is completed. When the cancel button 86c is operated, the setting information related to the input fields 91 selected up to that point is cancelled. When either the completion button 86b or the cancel button 86c is operated, the display of the display unit 14 returns to the reading target setting screen 74 that was displayed before the user application association button 84a was operated.

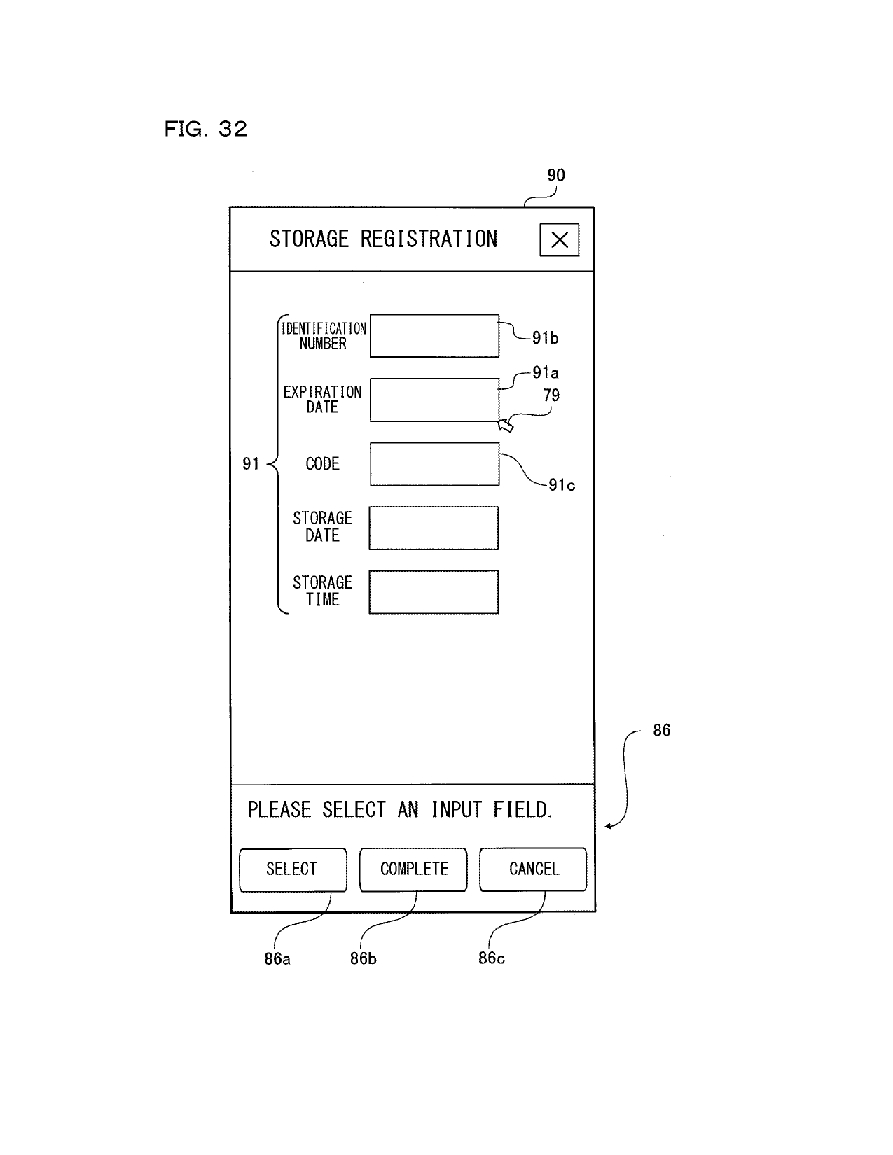

When an icon of the user application 90 is selected on the application selection screen 85, the display of the display unit 14 transitions to the screen of the user application 90. FIG. 32 shows a screen of the user application 90 having multiple input fields 91.

The user application 90 may have one or more input fields 91 including the first input field 91a, but in this case, multiple input fields 91 are provided. In FIG. 32, the first input field 91a corresponding to "expiration date" is displayed on the screen of the user application 90. Additionally, the user application 90 in FIG. 32 further has a second input field 91b different from the first input field 91a. The second input field 91b in FIG. 32 corresponds to "identification number". The user application 90 may also have more input fields 91, such as a third input field 91c corresponding to "code", for example.

The user selects the first input field 91a where the symbol information (reading result of relative reading process) of the symbol 20 at the reading target position 22 should be stored with the cursor 79 and operates the selection button 86a (or touches the first input field 91a).

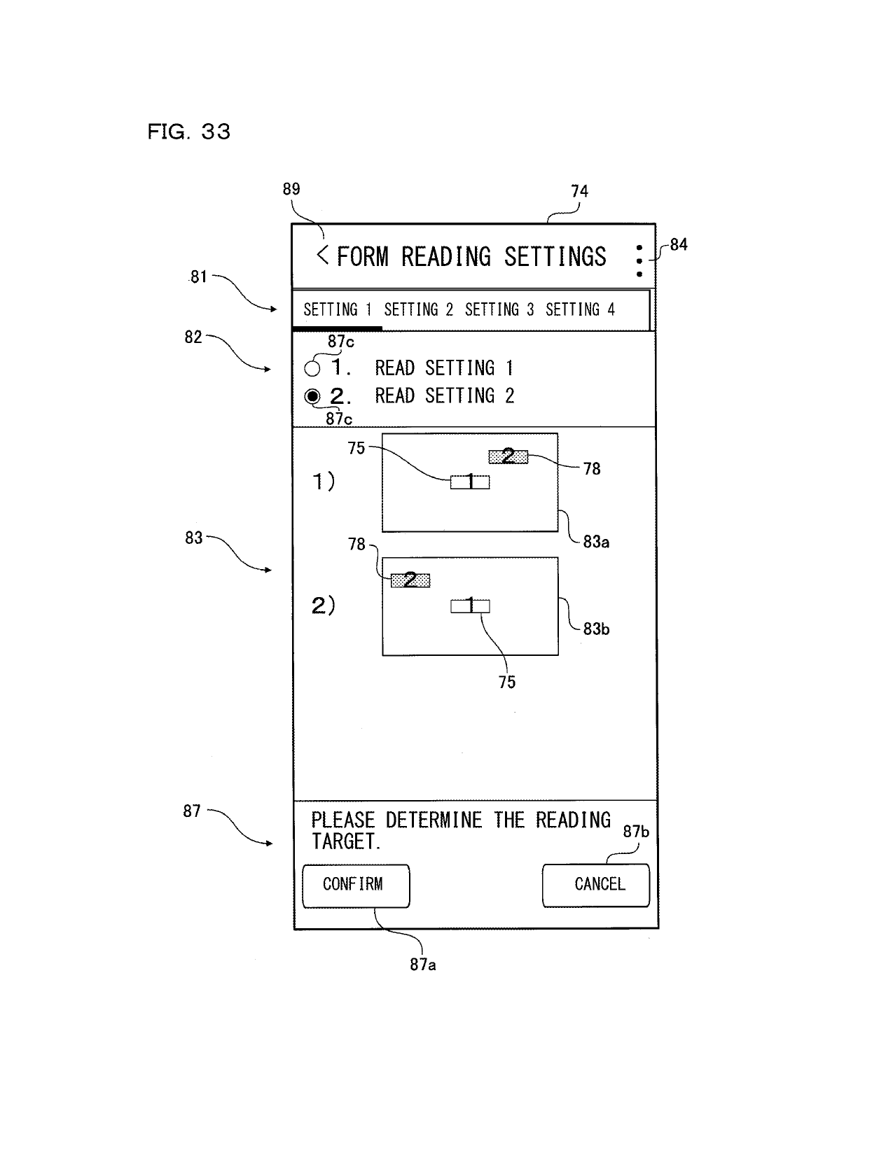

When the first input field 91a is selected, the display of the display unit 14 transitions to a state including the reading target setting screen 74 shown in FIG. 33. In this state, the reading target setting screen 74, compared to the state in FIG. 29, displays a reading target decision panel 87 instead of the operation panel area 73. The reading target decision panel 87 includes a decision button 87a and a cancel button 87b. Additionally, a radio button 87c for alternatively selecting either the reference position 75 or the user-specified position 78 is added to the setting name display area 82. If the cancel button 87b is operated, the setting information related to the previously selected input field 91 is canceled, and the display of the display unit 14 returns to the reading target setting screen 74 as it was before the user application association button 84a was operated.

The user selects the name of the reference position 75 or the user-specified position 78 corresponding to the symbol information to be stored in the first input field 91a selected in FIG. 32 using the radio button 87c. In FIG. 33, the name "Read Setting 2" of the user-specified position 78 corresponding to "Expiration Date" is selected by the radio button 87c. When the user operates the decision button 87a in this state, the user-specified position 78 is associated with the first input field 91a. Specifically, the reading target setting unit 58 stores in the storage unit 60 the reading target setting information 76 that further includes information associating the result of relative reading processing for the user-specified position 78 with the first input field 91a.

By associating the user-specified position 78 with the first input field 91a, regardless of whether the imaged target object 11 is the first type object 11a or the second type object 11b, the symbol information of "expiration date" at the reading target position 22 corresponding to the user-specified position 78 is stored in the first input field 91a.

When the decision button 87a is operated, the display on the display unit 14 returns to the application selection screen 85 shown in FIG. 31. If there are input fields 91 other than the first input field 91a that should be associated with the reference position 75 or the user-specified position 78, the user continues the association process. For example, it is preferable to associate the second input field 91b with the reference position 75. When the second input field 91b is associated with the reference position 75, the reading target setting information 76 further includes information that associates the result of relative reading processing with respect to the reference position 75 (the aiming position or the position of the symbol 20 adjacent to the aiming position) with the second input field 91b.

When the association between the reference position 75 or user-specified position 78 and the input field 91 is all completed, the user should operate the completion button 86b on the application selection screen 85 to complete the association.

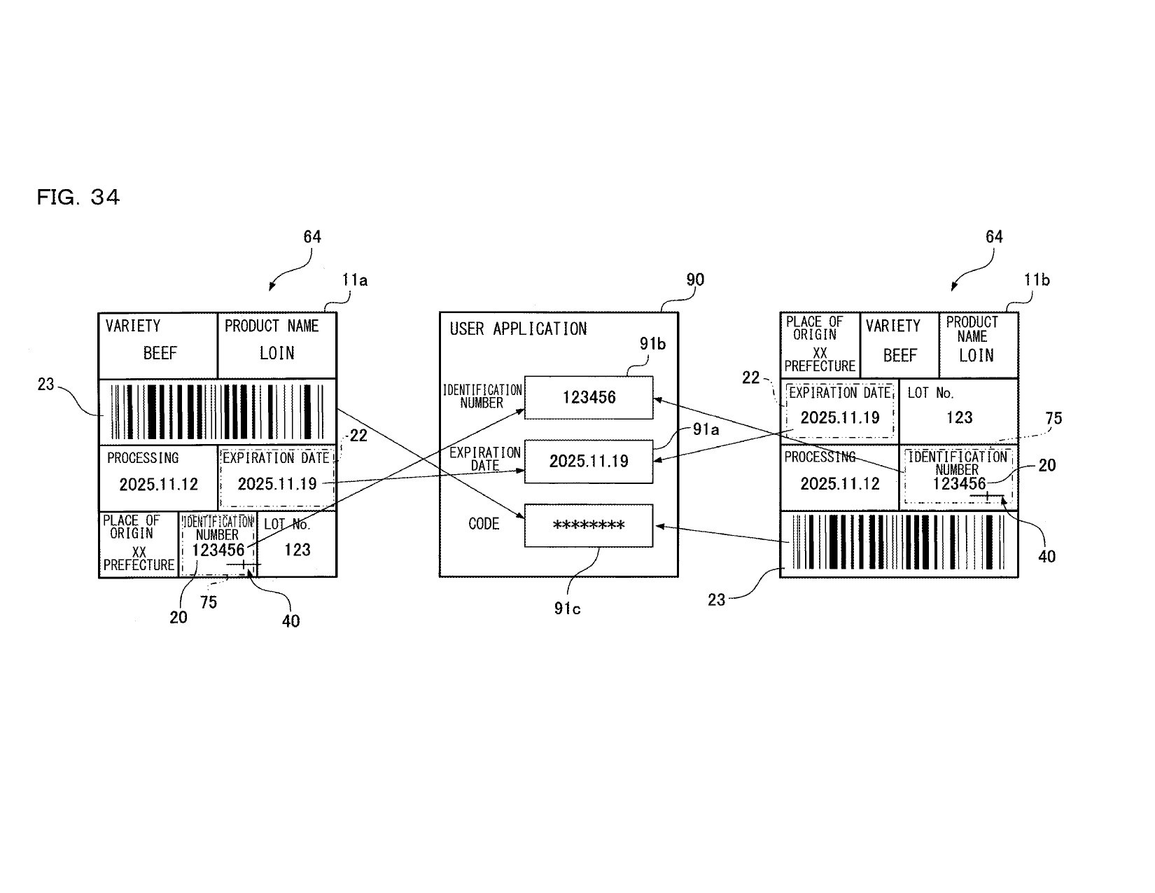

When the association between the reference position 75 or the user-specified position 78 and the input field 91 is established as described above, when relative reading processing is performed on the target object 11, the symbol information to be stored in the input field 91 is automatically read and stored. FIG. 34 shows the correspondence between the symbols 20 on the target object 11 (first type object 11a, second type object 11b) and the input fields 91 of the user application 90.

On the left side of FIG. 34, an operation image 64 capturing the first type object 11a is shown. On the right side of FIG. 34, an operation image 64 capturing the second type object 11b is shown. And in the center of FIG. 34, a screen of a user application 90 having multiple input fields 91 is shown. In actual operation images 64, the aimer light 40 is not included, and virtual lines (two-dot chain lines) surrounding the reference position 75 and the reading target position 22 are not displayed, but these are shown in FIG. 34 for explanation purposes.

Then, it is assumed that the user has previously associated the user-specified position 78 (reading target position 22) with the first input field 91a ("expiration date"), and associated the reference position 75 with the second input field 91b ("identification number"). Also in FIG. 34, it is assumed that the relative position of the barcode 23 with respect to the reference position 75 is associated with the third input field 91c ("code").

When the user performs a task (for example, storage registration in warehouse management) using the first type object 11a (for example, a receiving slip), they irradiate the aimer light 40 onto the first type object 11a such that the "identification number" becomes the reference position 75 and capture the operation image 64. At this time, it is preferable that the user specifies that the imaging target is the first type object 11a (using the first reading target setting information 76a), but the optical information reading device 10 may automatically determine this.

The relative reading processing unit 55 identifies the reading target position 22 based on the reference position 75 (the aiming position or the position of the symbol 20 adjacent to the aiming position) and the first reading target setting information 76a, and stores the result of the relative reading process for the reading target position 22 in the first input field 91a. As a result, the symbol information of the "expiration date" (in this case, the date "2025.11.19") at a position different from the "identification number" where the user irradiated the aimer light 40 is read and automatically stored in the first input field 91a.

At this time, the result of relative reading processing with respect to the reference position 75 (the aiming position or the position of the symbol 20 adjacent to the aiming position) (symbol information of "identification number", in this case the number "123456") may be automatically stored in the second input field 91b. Additionally, the result of relative reading processing for the barcode 23 (information represented by the barcode 23, in this case the code "********") may be automatically stored in the third input field 91c.

Similarly, when a user performs a task (for example, shipment registration in warehouse management) using a second type object 11b (for example, a shipping slip), they irradiate the aimer light 40 on the second type object 11b so that the "identification number" becomes the reference position 75, and capture an operation image 64. Then, the relative reading processing unit 55, based on the second reading target setting information 76b, performs relative reading processing on the reading target position 22, reference position 75, and barcode 23 in the second type object 11b, and stores the results in the first input field 91a, second input field 91b, and third input field 91c respectively.

In this way, by aligning the aimer light 40 with the reference position 75 and capturing the operation image 64, the user can obtain not only the symbol information of the "identification number" at the reference position 75 but also symbol information from positions different from the reference position 75. Furthermore, as the obtained symbol information is automatically stored in each of the input fields 91, the effort required for the user to operate the user application 90 and input into the input fields 91 is reduced.

Furthermore, when reading target setting information 76 related to multiple types of target objects 11 is set in advance, users can obtain the desired symbol information with a common operation for multiple types of target objects 11 with different symbol 20 arrangements (layouts). In other words, for any type of target object 11, symbol information can be obtained from reading target positions 22 that are in different locations depending on the type of target object 11, with the common operation of aligning the aimer light 40 with the reference position 75 and capturing the operation image 64. Therefore, symbol information can be read with a common operation regardless of the type of target object 11, reducing the workload on the user.

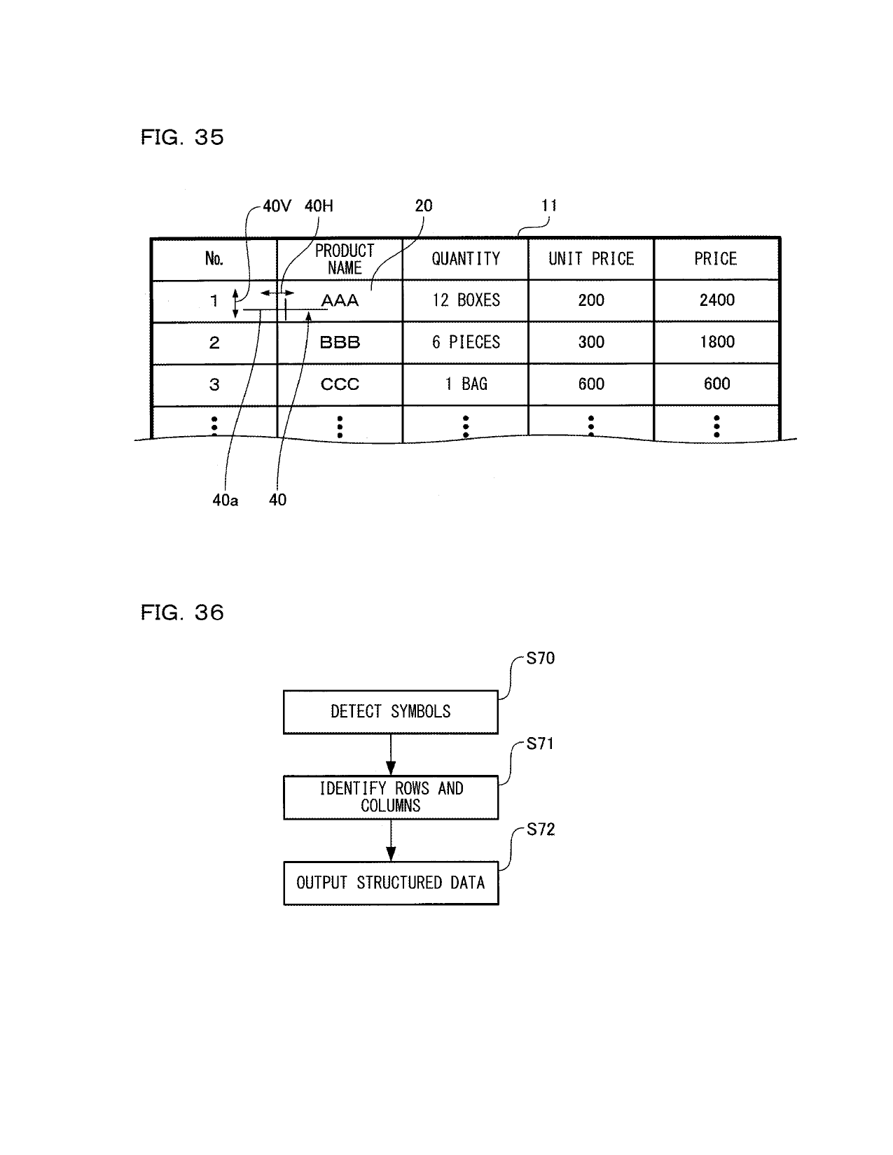

Next, a further example of the reading process in step S16 of FIG. 6 will be explained. As shown in FIG. 35, multiple symbols 20 may be attached to the target object 11 as a matrix aligned in the horizontal direction (row direction) and vertical direction (column direction). Such aligned multiple symbols 20 may represent structured data. For example, in the table processing method and table processing apparatus described in Japanese Unexamined Patent Application Publication No. H10-134120, ruled lines are extracted from an image, and further, table inner frames surrounded by the ruled lines are extracted. Item frames and data frames are extracted from the table inner frames, and the item names and entered contents described in each of the extracted item frames and data frames are recognized as characters. In this case, ruled lines are extracted from the image, but the process of extracting ruled lines from the image requires a large amount of calculation, necessitating a processor with high processing power. Additionally, in the above-mentioned table processing method and apparatus, if the image does not contain ruled lines, table inner frames cannot be extracted.

For example, in FIG. 35, multiple symbols 20 aligned in the row direction represent a set of data (record) having multiple attributes (fields, data items) such as "product name" and "unit price". And multiple symbols 20 aligned in the column direction represent attributes of each record. The target object 11 in FIG. 35 is, for example, an inventory sheet in warehouse management, and each record corresponds to a product existing in the warehouse. Here, the attributes possessed by each record represent "No." (number assigned to the product), "product name", "quantity", "unit price", and "price". It is defined how these attributes are attached to the target object 11, such as in the form of numerical values, character strings, or encoded codes (such as barcodes). It is preferable that the symbol information represented by these multiple symbols 20 is output as structured data.

Here, ruled lines that divide each symbol 20 vertically and horizontally are marked on the object 11 in FIG. 35. However, the optical information reading device 10 of this embodiment uses aimer light 40 (or virtual aimer) instead of ruled lines to identify the arrangement of symbols 20. When reading symbols 20 arranged in rows and columns, the user should irradiate the aimer light 40 (or adjust the position of the virtual aimer displayed on the display unit 14) so that the first direction 40H in which the first aimer light 40a extends aligns with the row direction of the rows and columns. If the first direction 40H is aligned with the row direction of the rows and columns, the second direction 40V intersecting the first direction 40H will align with the column direction of the rows and columns.

The row and column processing unit 56 (FIG. 4) of the optical information reading device 10 performs row and column processing to identify the row and column positions of each of the multiple symbols 20 in a matrix based on the extending direction of the aimer light 40. By performing row and column processing based on the extending direction of the aimer light 40, the row and column processing unit 56 can identify the row and column of each symbol 20 with limited computational capability without placing excessive computational load on a processor of a size that can be mounted in the handheld optical information reading device 10. Furthermore, by performing row and column processing based on the extending direction of the aimer light 40, the optical information reading device 10 can obtain structured data of the matrix from a target object 11 that does not have ruled lines.

The flowchart in FIG. 36 shows the flow of matrix processing. The row and column processing unit 56 first, in step S70, detects multiple symbols 20 included in the input image 62 by executing image processing on the input image 62 generated when the imaging unit 31 captures an image of the target object 11. The detection of symbols 20 is preferably performed using, for example, the machine learning model 61 (FIG. 5). Here, when the symbols 20 are character strings, first, character detection is performed, and then multiple characters estimated to have high relevance are concatenated as character strings.

When multiple symbols 20 included in the input image 62 are detected, the row and column processing unit 56, in step S71, based on the orientation of the aimer light 40, identifies the row and column where each of the multiple symbols 20 is positioned in the matrix.

Then, in step S72, the output unit 12 (FIG. 4) of the optical information reading device 10 outputs the symbol information represented by the multiple symbols 20 as structured data in a row-column format based on the rows and columns identified by the row and column processing unit 56. For example, it would be preferable if the structured data is displayed as an image on the display unit 14 of the output unit 12, or transmitted to the host computer 19 via the communication unit 16, or stored in the storage unit 60. The structured data to be output should be capable of collectively describing multiple records, and it would be preferable to use formats such as CSV (Character Separated Values) files, XML (Extensible Markup Language) files, tabular data files, JSON (JavaScript Object Notation) files, etc.

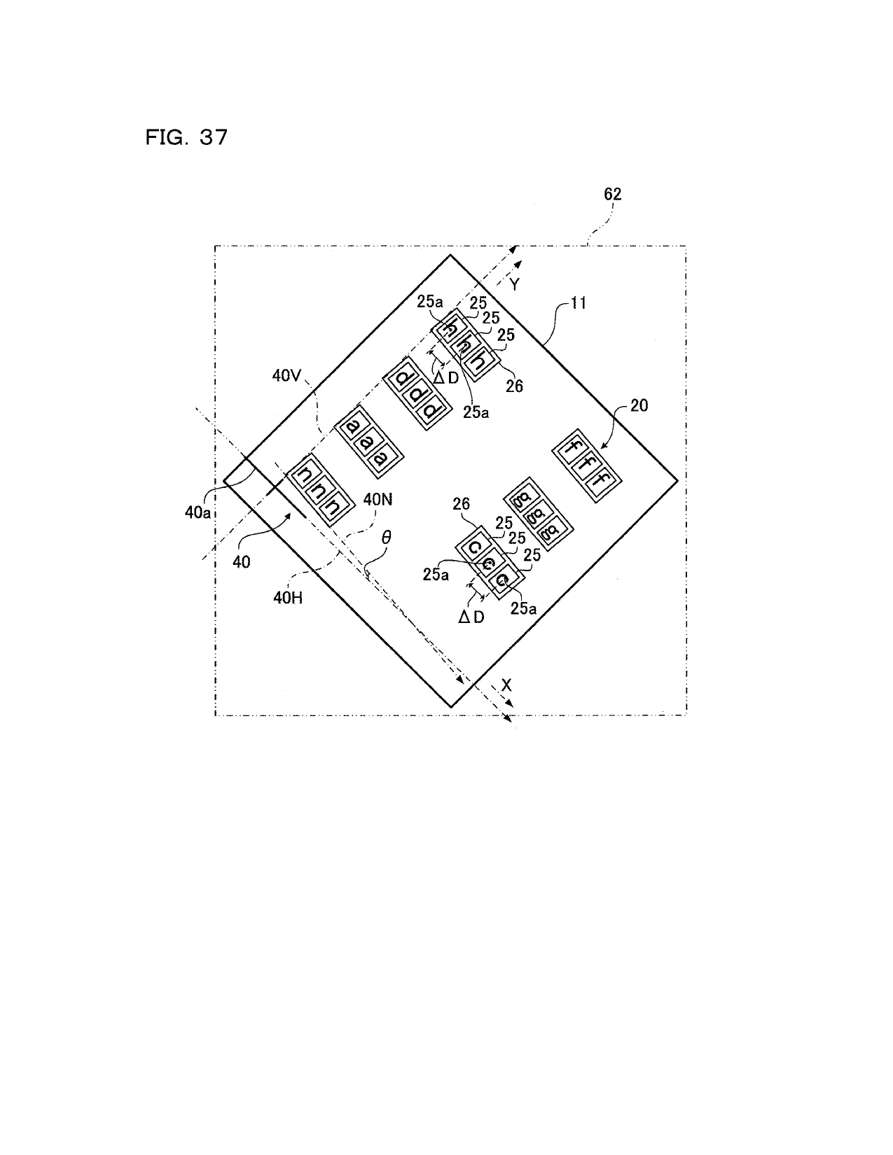

As one specific example of matrix processing, a case where the symbol 20 is a character string will be explained. FIG. 37 shows an example of an input image 62 obtained when an object 11 with multiple character strings attached as symbol 20 is captured in a tilted state. As shown in FIG. 37, depending on the orientation of the object 11 or the attitude of the optical information reading device 10, the object 11 may be captured in a state tilted from the outer frame of the input image 62. In this case, even if the object 11 is a rectangular paper surface, its four sides will be tilted from the outer frame (rectangle) of the input image 62. In this case, the alignment direction of each character included in the character string, and the row direction and column direction of the matrix to which the symbol 20 belongs, will also be oriented at an angle to the outer frame of the input image 62. In practice, the user tries to align the orientation of the object 11 with the outer frame of the input image 62 as much as possible when capturing, so the object 11 rarely tilts significantly. However, in FIG. 37, for the purpose of explanation, a state where the object 11 is greatly tilted with respect to the outer frame of the input image 62 is shown.

In this way, when the target object 11 is inclined with respect to the outer frame of the input image 62, the horizontal and vertical directions in the input image 62 do not coincide with the row and column directions of the matrix formed by the multiple symbols 20. However, the optical information reading device 10 of this embodiment can identify the row and column where each symbol 20 is located in the matrix by considering the first direction 40H in which the aimer light 40 extends.

When capturing an image of the target object 11, the user irradiates the aimer light 40 (or adjusts the position of the virtual aimer) so that the first direction 40H in which the first aimer light 40a of the aimer light 40 extends aligns as closely as possible with the direction of character alignment and the row direction of the rows and columns. As shown in FIG. 1, since the aimer light irradiation unit 32 is included in the same imaging module 13 as the imaging unit 31, the attitude of the aimer light irradiation unit 32 relative to the target object 11 is almost identical to that of the imaging unit 31. Therefore, in practice, if the first direction 40H aligns with the row direction of the rows and columns, the orientation of the outer frame of the input image 62 generated by the imaging unit 31 will also be close to the row and column directions of the rows and columns. Consequently, the first direction 40H rarely tilts significantly relative to the outer frame of the input image 62. However, for the purpose of explanation, FIG. 37 shows a state where the first direction 40H is tilted relative to the outer frame of the input image 62.

The row and column processing unit 56 first performs image processing on the input image 62 to detect multiple symbols 20 contained in the input image 62. Specifically, the row and column processing unit 56 can input the input image 62 into the machine learning model 61 to detect multiple symbols 20. In FIG. 37, the symbols 20 are multiple character strings, and each character string is composed of multiple characters 25. For example, the row and column processing unit 56 can input the input image 62 into the machine learning model 61 to obtain information on characters 25 output by the machine learning model 61. The information on characters 25 output by the machine learning model 61 includes the coordinates of the characters 25 in the input image 62. The machine learning model 61 can output information on characters 25 even if the characters 25 are tilted in the input image 62.

The row and column processing unit 56 identifies the positional relationships among multiple characters 25 based on the coordinates of the characters 25. Then, the row and column processing unit 56 selects at least two characters that are subject to judgment on whether to perform character concatenation to concatenate as a character string, based on the identified positional relationships. As a specific example, it is preferable for the row and column processing unit 56 to calculate the distance between characters 25. The coordinates of characters 25 output by the machine learning model 61 are, for example, represented as data indicating the coordinates of the four corners (4 points) of a rectangle surrounding the character 25. For instance, the row and column processing unit 56 calculates the center coordinates (coordinates of the center of the rectangle surrounding the character 25) for each character 25 based on the coordinates of the four corners of the character 25. Then, the row and column processing unit 56 calculates the distance between the center coordinates for each character 25 as the distance between characters 25. The distance between characters 25 can be calculated even if the characters 25 are tilted. Characters 25 with a short distance between them are likely to belong to the same character string.

FIG. 37 illustrates a specific example showing the distance ΔD between two characters 25 (alphabet "h") located at the upper left of the target object 11, and the distance ΔD between two characters 25 (alphabet "c") located at the bottom right of the target object 11. This distance ΔD is calculated as the distance between the centers 25a of the respective two characters 25.

The row and column processing unit 56 selects two characters with a sufficiently small distance ΔD (for example, less than 10 pixels) as targets for judging whether to perform character concatenation or not. In judging whether to perform character concatenation, it is preferable to consider not only the distance between characters 25 (positions of multiple characters) but also, for example, the relationship between the types of characters 25 (alphabet, kanji, etc.) and their sizes. Then, multiple characters 25 that are estimated to have high relevance based on the positions and sizes of multiple characters are grouped as a character string. For the purpose of explanation below, a character string consisting of multiple characters 25 grouped (connected) by the row and column processing unit 56 is called a concatenated character string 26. The row and column processing unit 56 obtains multiple concatenated character strings by connecting multiple characters based on the positions and sizes of multiple characters. In FIG. 37, characters 25 with small distances ΔD are connected to form seven concatenated character strings 26 (seven concatenated character strings 26 are obtained by the row and column processing unit 56).

Furthermore, when the row and column processing unit 56 identifies the positional relationships of multiple characters, the first direction 40H of the aimer light 40 may be considered. For example, the row and column processing unit 56 identifies the X direction (indicated by the symbol "X" in FIG. 37) corresponding to the first direction 40H in the input image 62, and the Y direction (indicated by the symbol "Y" in FIG. 37) perpendicular to the X direction. The X direction is typically parallel to the first direction 40H, but based on the attitude of the optical information reading device 10 and the inclination of the target object 11, a direction at an angle to the first direction 40H may be designated as the X direction.

Then, the row and column processing unit 56 sorts the multiple characters 25 based on their coordinates in the order they are arranged in the X direction and Y direction. For the sorted characters 25, the row and column processing unit 56 selects two characters aligned along either the X direction or Y direction and determines whether they should be subject to character concatenation. By sorting multiple characters 25 and then selecting candidates for character concatenation judgment, it becomes unnecessary to examine all combinations of characters 25, thereby reducing the processing time and processing load on the processor mounted in the optical information reading device 10.

Furthermore, the row and column processing unit 56 may calculate the orientation of at least one of the multiple symbols 20 (here, character strings, but they can also be encoded codes, etc.) and correct that orientation. In FIG. 37, as an example, the orientation of one of the symbols 20, the concatenated character string 26 in the lower left (a string of three concatenated alphabet "n"s), is shown forming an angle with respect to the first direction 40H. The orientation of the symbol 20 refers to its orientation within the input image 62, specifically, in the case where the symbol 20 is a concatenated character string 26, the alignment direction of the characters 25 becomes the orientation of the symbol 20. Also, when the symbol 20 is extracted from the input image 62, if the coordinates of the four corners (4 points) of the rectangle specified as the range of the symbol 20 are obtained, the direction of the edges of that rectangle becomes the orientation of the symbol 20. Moreover, when the row and column processing unit 56 detects the symbol 20, if it can detect that the symbol 20 is tilted with respect to the outer frame of the input image 62, the direction of that tilt becomes the orientation of the symbol 20.

Here, as an example, we will explain the case where the matrix processing unit 56 calculates the orientation of the concatenated character string 26. When the matrix processing unit 56 concatenates multiple characters 25 as a concatenated character string 26, coordinate data for the concatenated character string 26 is formed based on the coordinate data of the characters 25 that make up the concatenated character string 26. Specifically, among the coordinates of the four corners of the characters 25 that make up the concatenated character string 26, the minimum and maximum values of the horizontal coordinates in the input image 62, and the minimum and maximum values of the vertical coordinates become the coordinates of the four corners of the concatenated character string 26. The matrix processing unit 56 calculates the orientation of the edges of the rectangle surrounding the concatenated character string 26 from the coordinates of the four corners of the concatenated character string 26. In FIG. 37, a line 40N is shown along the direction of the bottom edge of the rectangle surrounding the concatenated character string 26 at the bottom left. The matrix processing unit 56 calculates the angle θ formed between the line 40N (the orientation of the concatenated character string 26, which is a symbol 20) and the first direction 40H.

The matrix processing unit 56, which calculates the angle θ, performs rotation correction on at least one of the input image 62 and the coordinates of the symbol 20 based on the angle θ. Specifically, the input image 62 and the coordinates of the symbol 20 (either one or both) are rotated so that the angle θ calculated from the corrected input image 62 and the coordinates of the symbol 20 becomes smaller (preferably zero). By performing such rotation correction, even if the first direction 40H of the aimer light 40 does not align with the row direction or column direction of the matrix attached to the target object 11, an input image 62 and coordinates of the symbol 20 with a small deviation of the first direction 40H from the row direction or column direction are obtained, thereby improving the reading accuracy of the symbol 20.

Furthermore, the machine learning model 61 may be capable of not only outputting information about tilted characters 25 in the input image 62, but also concatenating multiple characters 25 located in close proximity to form concatenated character strings 26. However, the machine learning model 61 alone cannot determine whether multiple concatenated character strings 26 are aligned in the same row or column in a matrix. Therefore, the row and column processing unit 56 separately performs the determination of whether multiple concatenated character strings 26 are aligned in the same row or column.

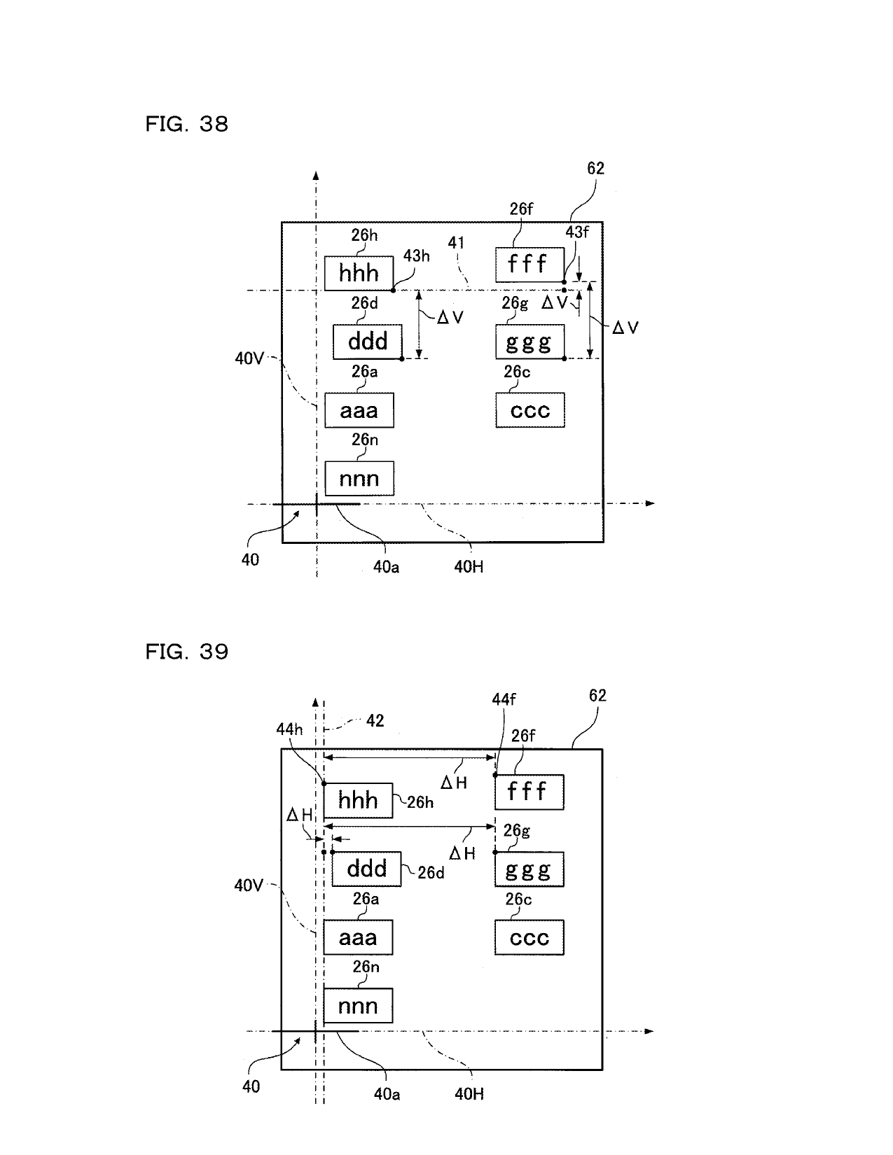

Next, referring to FIG. 38, we will explain the first distance ΔV used to determine whether multiple symbols 20 (in this case, concatenated character strings 26) within the input image 62 are aligned in the same row or not. For the purpose of explanation, in FIG. 38 and beyond, it is assumed that the first direction 40H of the aimer light 40 is parallel to the horizontal direction of the input image 62's outer frame, and the orientation of each concatenated character string 26 is also parallel to the first direction 40H. Furthermore, the row and column processing unit 56 can effectively handle an input image 62 without inclination, as shown in FIG. 38, by appropriately correcting the coordinates of the input image 62 and symbols 20.

FIG. 38 shows seven concatenated character strings 26 as symbols 20. Hereinafter, these concatenated character strings 26 are distinguished by assigning them the reference numerals 26h, 26f, 26d, 26g, 26a, 26c, and 26n, respectively. The row and column processing unit 56 selects two of the multiple concatenated character strings 26 in the input image 62 as a first symbol and a second symbol, and determines whether the first symbol and the second symbol are aligned in the same row in the matrix. As an example, the case where the concatenated character string 26h in the upper left is the first symbol and the concatenated character string 26f in the upper right is the second symbol will be explained.

The row and column processing unit 56 defines a first reference point 43h for the first symbol, which is the concatenated character string 26h. The first reference point 43h can be any one of the coordinates included in the concatenated character string 26h, but in this example, the coordinates of the bottom right end of the concatenated character string 26h are defined as the first reference point 43h.

FIG. 38 shows a first line 41 that passes through the first reference point 43h and is parallel to the first direction 40H of the aimer light 40. The matrix processing unit 56 calculates a first distance ΔV between this first line 41 and the second symbol, which is the concatenated character string 26f. Specifically, a first reference point 43f (in this case, the bottom right end) is also defined for the second symbol, which is the concatenated character string 26f, and the distance between the first line 41 and the first reference point 43f is calculated as the first distance ΔV.

The row and column processing unit 56 determines that the first symbol and the second symbol are aligned in the same row when the first distance ΔV is sufficiently small (for example, below a threshold such as 10 pixels). In FIG. 38, since the first distance ΔV between the concatenated character string 26h (first symbol) and the concatenated character string 26f (second symbol) is small, it is determined that the concatenated character string 26h (first symbol) is aligned in the same row as the concatenated character string 26f (second symbol).

The row and column processing unit 56 calculates and determines the first distance ΔV for all combinations of concatenated character strings 26 as the first symbol and the second symbol. FIG. 38 shows the first distance ΔV when the concatenated character string 26h is set as the first symbol, and the concatenated character strings 26d and 26g are set as the second symbol. Since the concatenated character strings 26d and 26g (second symbol) have a large first distance ΔV with respect to the concatenated character string 26h (first symbol), it is determined that the concatenated character string 26h (first symbol) is located in a different row from the concatenated character strings 26d and 26g (second symbol).

By calculating and determining the first distance ΔV for all combinations of two concatenated character strings 26, in FIG. 38, the combinations of "concatenated character string 26h and concatenated character string 26f", "concatenated character string 26d and concatenated character string 26g", and "concatenated character string 26a and concatenated character string 26c" are determined to be positioned in the same row, while all other combinations are determined to be positioned in different rows.

Next, referring to FIG. 39, we will explain the second distance ΔH used to determine whether or not each of the multiple symbols 20 (concatenated character strings 26) within the input image 62 is aligned in the same column. As an example, we will explain the case where the concatenated character string 26h in the upper left is the first symbol and the concatenated character string 26f in the upper right is the second symbol.

The row and column processing unit 56 defines a second reference point 44h for the first symbol, which is the concatenated character string 26h. The second reference point 44h can be any one of the coordinates included in the concatenated character string 26h, but here, as an example, the coordinates of the upper left end of the concatenated character string 26h are defined as the second reference point 44h.

FIG. 38 shows a second line 42 that passes through the second reference point 44h and intersects with the first direction 40H. The matrix processing unit 56 calculates a second distance ΔH between this second line 42 and the second symbol, which is the concatenated character string 26f. Specifically, a second reference point 44f (upper left end) is also defined for the second symbol, which is the concatenated character string 26f, and the distance between the second line 42 and the second reference point 44f is calculated as the second distance ΔH.

The row and column processing unit 56 determines that the first symbol and the second symbol are aligned in the same column when the second distance ΔH is sufficiently small (for example, below a threshold such as 10 pixels). In FIG. 39, since the second distance ΔH between the concatenated character string 26h (first symbol) and the concatenated character string 26f (second symbol) is large, it is determined that the concatenated character string 26h (first symbol) is positioned in a different column from the concatenated character string 26f (second symbol).

The row and column processing unit 56 calculates and determines the second distance ΔH for all combinations of concatenated character strings 26 as the first symbol and the second symbol. FIG. 39 shows the second distance ΔH when the concatenated character string 26h is set as the first symbol, and the concatenated character strings 26d and 26g are set as the second symbol. As a result, since the second distance ΔH between the concatenated character string 26h (first symbol) and the concatenated character string 26d (second symbol) is small, it is determined that the concatenated character string 26h is aligned in the same column as the concatenated character string 26d (second symbol). On the other hand, since the second distance ΔH between the concatenated character string 26h (first symbol) and the concatenated character string 26g (second symbol) is large, it is determined that the concatenated character string 26h is positioned in a different column from the concatenated character string 26g (second symbol).

The calculation and determination of the second distance ΔH is performed for all combinations of two concatenated character strings 26, and as a result, in FIG. 39, the combination of "concatenated character string 26h, concatenated character string 26d, concatenated character string 26a, concatenated character string 26n" and the combination of "concatenated character string 26f, concatenated character string 26g, concatenated character string 26c" are determined to be positioned in the same column, respectively, while all other combinations are determined to be positioned in different columns.

The row and column processing unit 56 thus identifies the rows and columns in which each of the multiple symbols 20 (concatenated character strings 26) is positioned in the matrix. The output unit 12 outputs the symbol information represented by the multiple symbols 20 as structured data of the matrix (for example, a CSV file) based on the identified rows and columns.

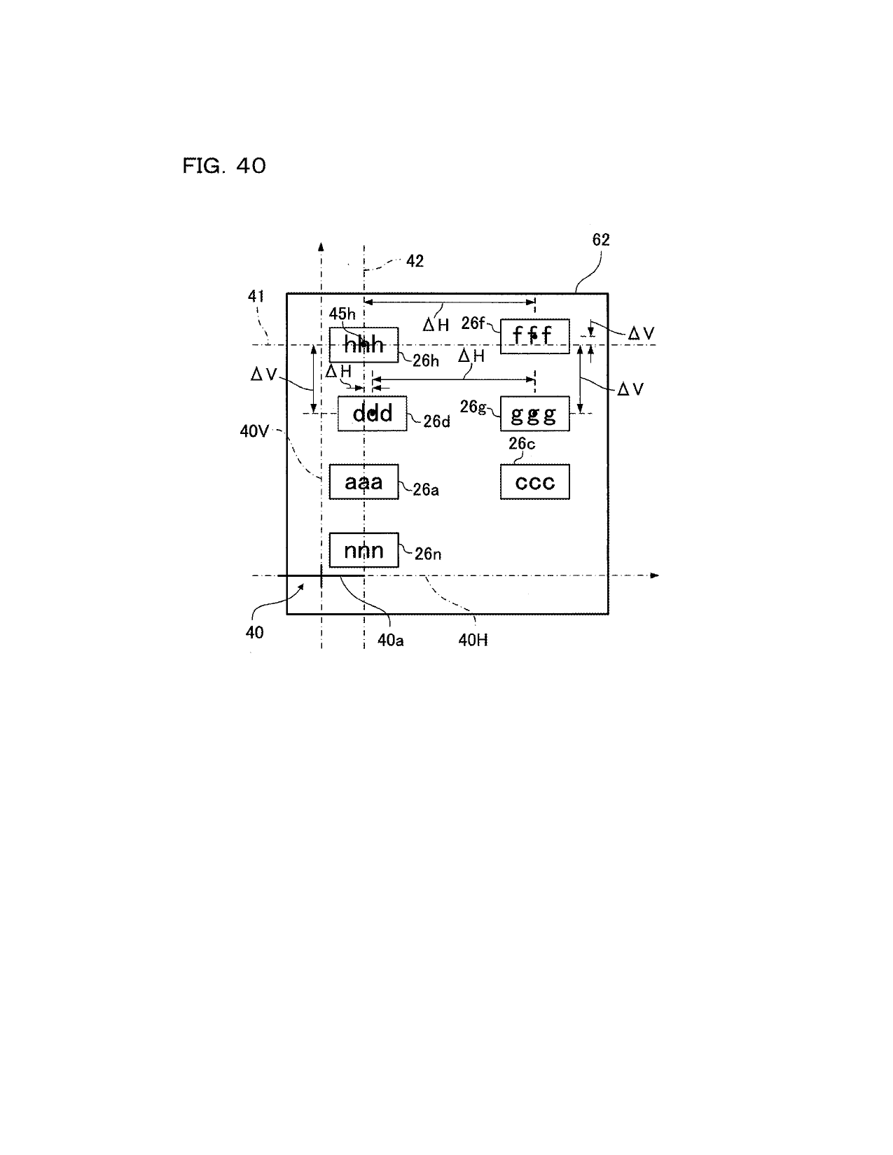

Furthermore, while the above description assumed that the first reference point 43h and the second reference point 44h were different, they may also be the same. FIG. 40 shows a case where the first reference point and the second reference point are the same common reference point 45h (the coordinate at the center of the concatenated character string 26h). As shown in FIG. 40, even when the first reference point and the second reference point are the same common reference point 45h, it is possible to consider the first line 41 and the second line 42 passing through the common reference point 45h. The row and column processing unit 56 can calculate the first distance ΔV and the second distance ΔH for combinations of two concatenated character strings 26, and identify the row and column where each of the concatenated character strings 26 is positioned in the matrix.

With regard to where to position the first reference point 43h and the second reference point 44h in the concatenated character string 26, it is preferable that they are determined according to the format information predetermined for the format of the concatenated character string 26. For example, if it is predetermined that the concatenated character string 26 is to be left-aligned, it is preferable that the leftmost position of the concatenated character string 26 be set as the first reference point 43h and the second reference point 44h.

When matrix processing is performed on the symbol 20 attached to the target object 11, it is preferable that format information related to a matrix consisting of multiple symbols 20 is pre-registered through a pre-setting. The format information related to the matrix includes the number of rows and columns contained in the target object 11. It is preferable that the format information further includes format patterns to be read by the row and column processing unit 56. Before performing a task including matrix processing, the user performs pre-setting for matrix processing in advance. For example, matrix processing pre-setting is initiated by selecting the "List Setting" item from the settings menu screen displayed on the display unit 14 of the optical information reading device 10. When the matrix processing pre-setting is initiated, a pre-setting screen for accepting various pre-settings related to matrix processing is displayed on the display unit 14 (or the monitor of the host computer 19).

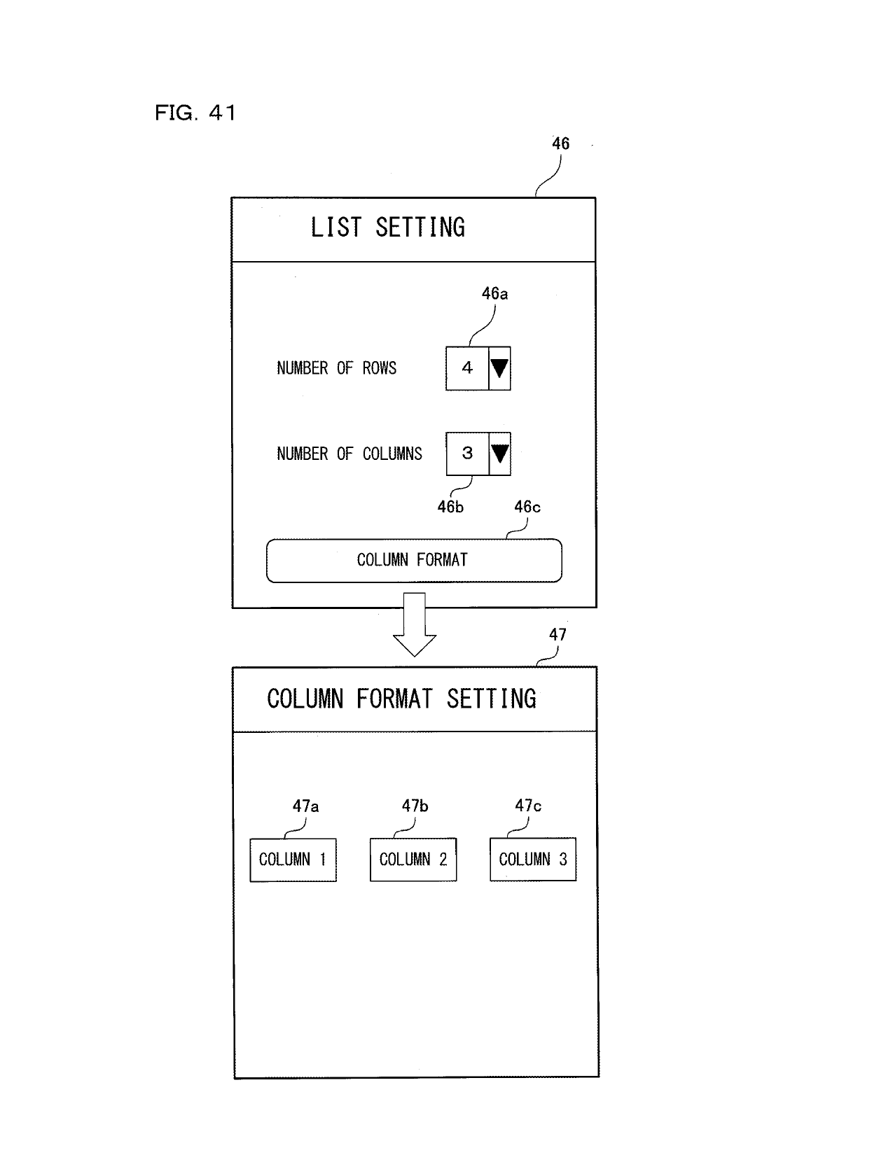

FIG. 41 shows a list setting screen 46 and a column format setting screen 47 as an example of a pre-setting screen for row and column processing. The display unit 14 first displays the list setting screen 46. The list setting screen 46 in FIG. 41 includes a row number registration field 46a, a column number registration field 46b, and a column format button 46c.

The user can define the number of rows and columns of the matrix attached to the target object 11 using the row number registration field 46a and the column number registration field 46b. For example, the user can set the number of rows and columns by inputting numerical values into the row number registration field 46a and the column number registration field 46b, or by selecting numerical values from a pull-down list. The user can also set the number of rows or columns as "indefinite". For instance, when multiple symbols 20 aligned in the row direction of the matrix constitute a single record with multiple data items, and multiple symbols 20 aligned in the column direction represent the data items of each record, the number of data items (number of columns) may be known, but the number of records (number of rows) may be unknown. In such cases, it is preferable to set the unknown number as "indefinite".

In FIG. 41, the number of rows is set to "4" and the number of columns is set to "3". After setting the number of rows and columns, the user next operates the column format button 46c. When the column format button 46c is operated, the display on the display unit 14 transitions to the column format setting screen 47. The column format setting screen 47 displays a number of column format registration buttons corresponding to the number of columns set in the list setting screen 46. In FIG. 41, three buttons are displayed: the first column format registration button 47a, the second column format registration button 47b, and the third column format registration button 47c. These buttons correspond to each column (data item) in the row and column structure.

When any of the first column format registration button 47a, second column format registration button 47b, or third column format registration button 47c is operated, the display unit 14 transitions to a screen for registering the format pattern of the reading target (symbol 20) that the row and column processing unit 56 reads for each column. On the screen for registering the format pattern, the user registers the format pattern for each column.

The screen for registering format patterns is similar to the format registration screen 38 shown in FIG. 10, and includes, for example, a format registration field for registering the format of the character string to be read. However, when the reading target is a symbol 20 other than a character string, for example, when it is an encoded code such as a barcode, it is preferable that the standard type of the encoded code can be registered.

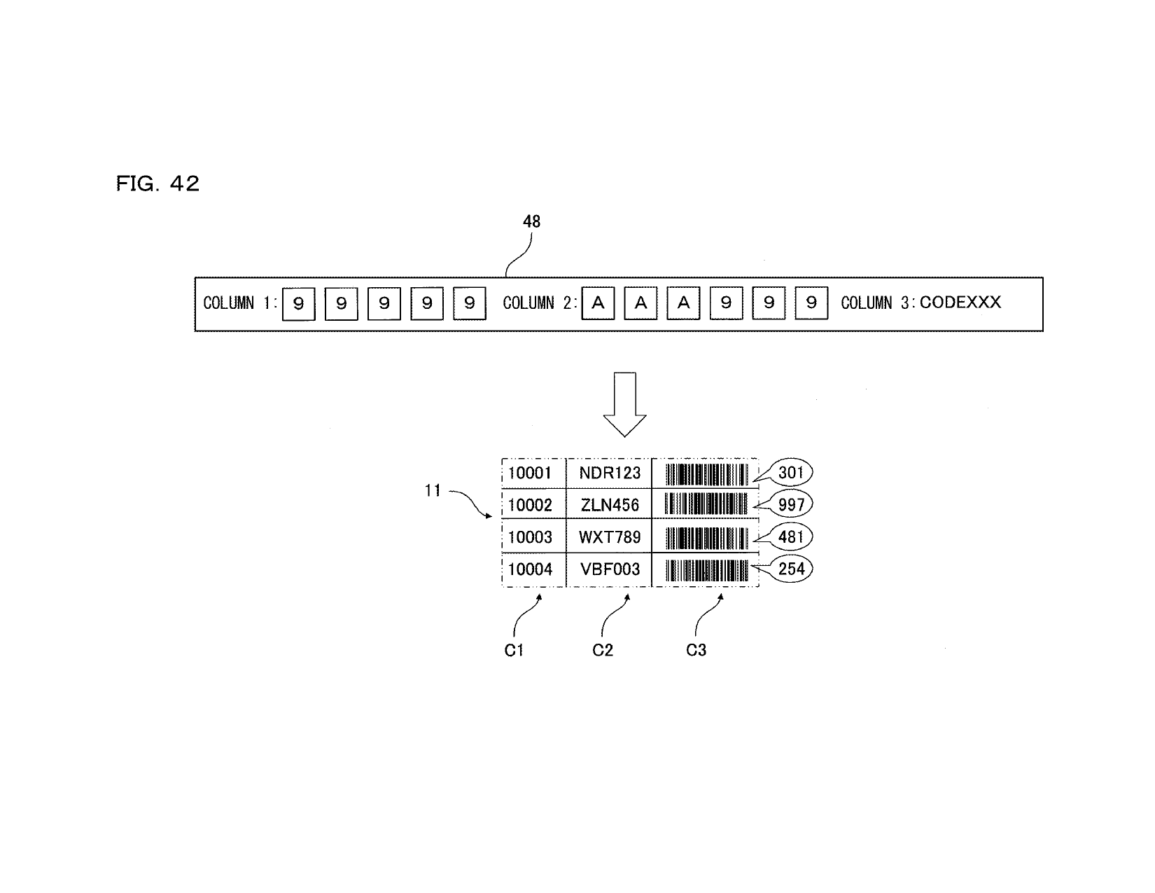

FIG. 42 shows an example of a registered format pattern 48 and an example of an input image 62 of a reading target to which character strings and the like are attached in accordance with this format pattern 48.

FIG. 42 shows format patterns 48 for three columns. In these format patterns 48, as in FIG. 10, "A" represents alphabet and "9" represents numbers. For the first column ("Column 1"), a character string format with five consecutive numbers is registered. For the second column ("Column 2"), a character string format with three alphabets followed by three numbers is registered. And for the third column ("Column 3"), instead of a character string format, a standard type of encoded code "CODEXXX" is registered. This indicates that "Column 3" contains an encoded code rather than a character string, and the appropriate code standard type for decoding this encoded code is "CODEXXX". For example, multiple standard type options such as JAN code, CODE128, etc. are prepared, and it is advisable for the user to select the standard type corresponding to the encoded code to be read from these options.

The format pattern 48 registered by the user and the information including the number of rows and columns are acquired by the format information acquisition unit 59 shown in FIG. 4 and stored as format information 65 in the storage unit 60 shown in FIG. 5. In addition to being registered by the user, the format information 65 may also be obtained by estimation from the reading history information of the optical information reading device 10.

As shown in FIG. 42, when format information 65 including a format pattern 48 is stored, the row and column processing unit 56 determines that the rows and columns included in the target object 11 shown in FIG. 42 match the format information 65. The rows and columns included in the target object 11 shown in FIG. 42 have 4 rows and 3 columns, which coincide with the number of rows and columns set in the list setting screen 46 (FIG. 41). The first column C1 has a character string consisting of 5 numeric characters, which matches the setting for "Column 1". The second column C2 has a character string with 3 alphabetic characters followed by 3 numeric characters, which matches the setting for "Column 2". The third column C3 has an encoded code (in this case, a barcode) attached. If the encoded code in the third column C3 can be decoded according to the "CODE XXX" standard, the third column C3 will also match the setting for "Column 3". FIG. 42 shows the decoding result of the barcode in the third column C3 (in this case, a code represented by 3 digits) in a speech bubble.

The output unit 12 of the optical information reading device 10 outputs the structured data 49 of the matrix determined by the row and column processing unit 56 to match the format information 65, and stores it in the storage unit 60 (FIG. 5). The user application 90 stored in the storage unit 60 can use the structured data 49 as master data 92 for the later-described verification process by cooperating with the row and column processing unit 56.

The verification process is a process of confirming whether the symbol information of the symbol 20 attached to the target object 11 is included in the master data 92 previously stored in the storage unit 60. The user application 90 cooperates with the row and column processing unit 56 and may be used for the verification process. For example, in an inventory check operation, which is a type of warehouse management task, a verification process may be performed to confirm whether the products remaining in the warehouse match the information listed on an inventory sheet that enumerates the product inventory.

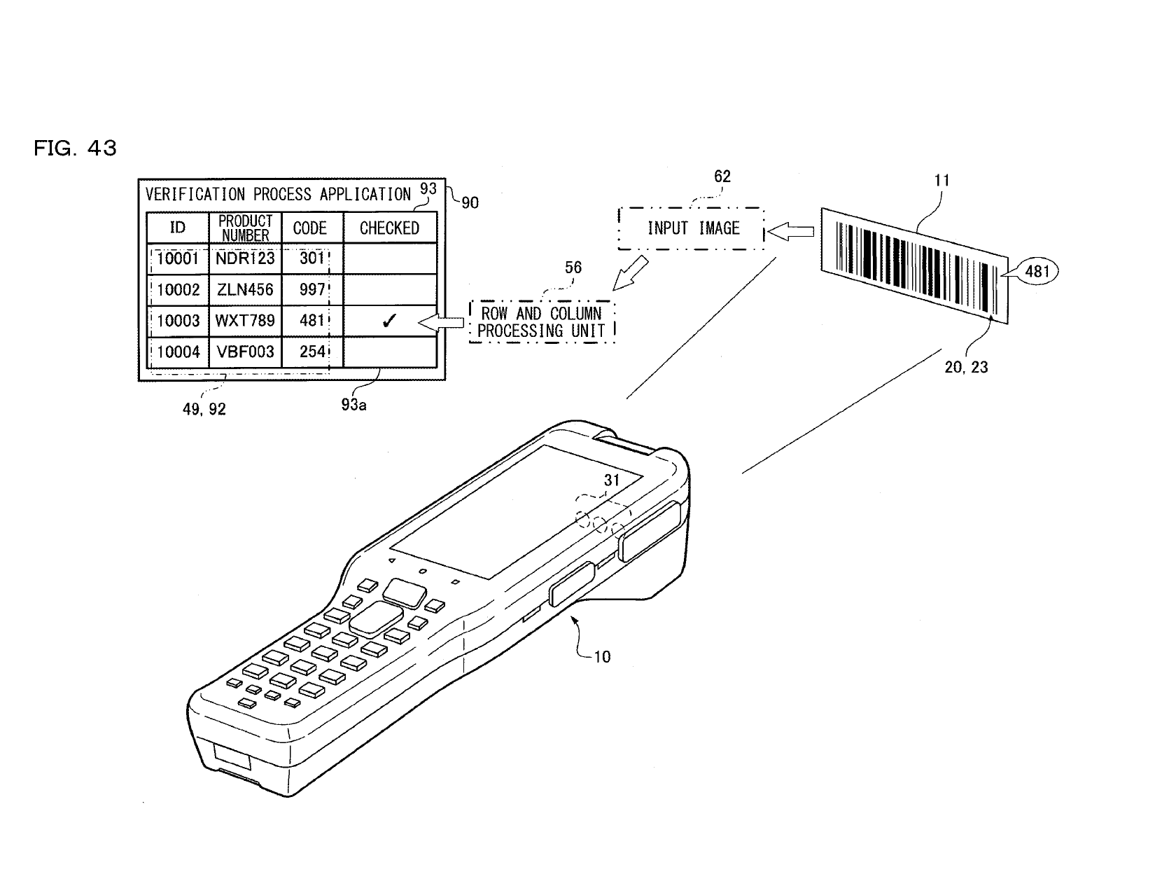

FIG. 43 shows an example where structured data 49 is used as master data 92 in a verification process. Prior to the verification process being performed, a user uses the optical information reading device 10 to capture an image of a target object 11 (for example, an inventory sheet) on which multiple symbols 20 are attached in a matrix. The structured data 49 of the matrix attached to the target object 11 is stored in the storage unit 60.

When the user application 90 (verification process application) is launched for the verification process, the user application 90 uses the stored structured data 49 as master data 92 for the verification process. The user application 90 generates collation data 93 by adding a checked flag field 93a for the verification process to this master data 92 (structured data 49). The checked flag field 93a is a new column direction data item corresponding to each record (row direction data) of the master data 92. The checked flag field 93a can switch between the "unchecked" state (confirmation flag is not set) and the "checked" state (confirmation flag is set) corresponding to each record.

In the verification process, the user captures the target object 11 with the imaging unit 31 while the user application 90, which serves as the verification process application, is running. In the verification process, the row and column processing unit 56 acquires the symbol information represented by the symbol 20 attached to the target object 11 captured by the imaging unit 31, and sends it to the user application 90. The user application 90 checks whether the information obtained by the imaging unit 31 and the row and column processing unit 56 is included in the master data 92.

When the user application 90 confirms that the symbol information of the symbol 20 attached to the target object 11 captured by the imaging unit 31 is included in the master data 92 (corresponding to any of the records), it sets the corresponding confirmation flag. In other words, in the collation data 93, the checked flag field 93a of the record corresponding to the symbol information confirmed to be included in the master data 92 switches from the "unchecked" state to the "checked" state (the confirmation flag is set).

A barcode 23 representing the numerical value "481" as a symbol 20 is attached to the target object 11 shown in FIG. 43. The imaging unit 31 generates an input image 62 that includes the barcode 23. The row and column processing unit 56 detects the barcode 23 contained in the input image 62 and obtains the symbol information represented by the barcode 23 (in this case, the code represented by the numerical value "481").

The user application 90 cooperates with the row and column processing unit 56 to confirm whether the information obtained by the imaging unit 31 and the row and column processing unit 56 is included in the master data 92. In this case, since the code represented by the numerical value "481" is included in the master data 92, the checked flag field 93a of the record (data in the row direction) corresponding to that code in the collation data 93 is switched to the "checked" state.

For example, in an inventory check operation, a user performs a verification process using the user application 90. When a barcode 23 attached to a product remaining in the warehouse is captured by the imaging unit 31, if the checked flag field 93a of the collation data 93 becomes "checked", the user can confirm that the product matches the one listed on the inventory sheet. When all the checked flag fields 93a of the collation data 93 become "checked", the user can confirm that the products remaining in the warehouse match the information listed on the inventory sheet that enumerates the product inventory.

Furthermore, in the above examples, when the information obtained by the imaging unit 31 and the row and column processing unit 56 is included in the master data 92, the user application 90 sets the confirmation flag in the checked flag field 93a. However, the matching of information may be confirmed by other methods. For example, the user application 90 may create copy data of the master data 92 as collation data 93, and when the information obtained by the imaging unit 31 and the row and column processing unit 56 is included in the master data 92, it may delete the corresponding record from the collation data 93. For instance, in an inventory check operation, when all records are deleted from the collation data 93, the user can confirm that the products remaining in the warehouse match the information listed on the inventory sheet that enumerates the product inventory.

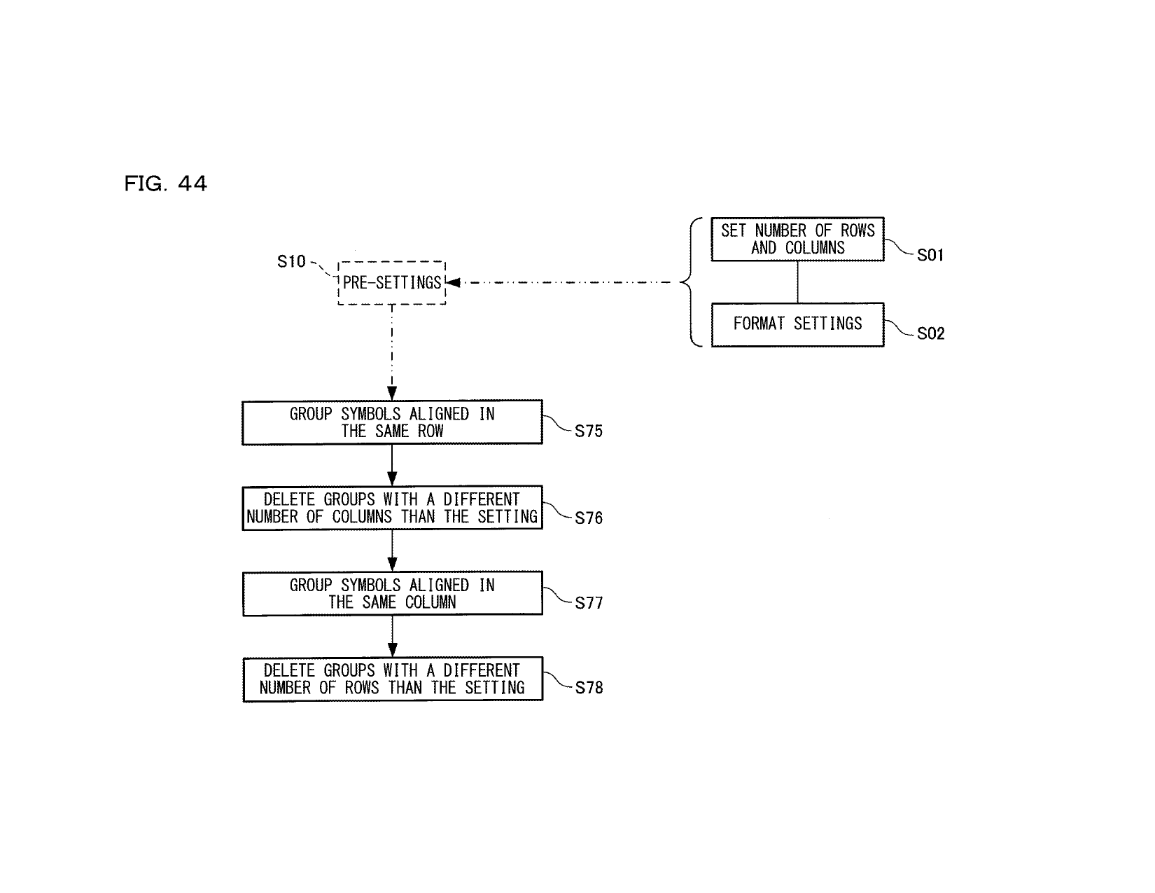

Next, referring to FIG. 44, we will explain the process by which the row and column processing unit 56 excludes information that does not match the format information 65 from the structured data 49. FIG. 44 is a flowchart showing the flow of the process in which the row and column processing unit 56 excludes information that does not match the format information 65.

As shown in FIG. 44, in the pre-setting of step S10 executed prior to the row and column processing, "row and column number setting" of step S01 and "format setting" of step S02 are performed.

In step S01 "Row and Column Number Setting", as shown in FIG. 41, the user sets the number of rows and columns included in the target object 11. In step S02 "Format Setting", the user sets format patterns 48 as shown in FIG. 42 for each of the columns. The format information acquisition unit 59 (FIG. 4) of the optical information reading device 10 acquires format information 65 including the number of rows and columns set by the pre-setting, and stores it in the storage unit 60 (FIG. 5).

When matrix processing is executed after such pre-settings have been made, the row and column processing unit 56 groups symbols 20 that are aligned in the same row in the input image 62 in step S75 of FIG. 44. In determining whether multiple symbols 20 are aligned in the same row, it is preferable to make a judgment based on the first distance ΔV, as shown in FIG. 38, for example.

The number of symbols 20 aligned in the same row becomes the number of columns in that row (group). In step S76 of FIG. 44, the row and column processing unit 56 compares the number of columns (column count) of each group with the number of columns set in step S01. Then, if there is a group with a different number of columns from the setting, that group (row) is deleted.

Next, in step S77, the row and column processing unit 56 groups symbols 20 aligned in the same column in the input image 62. When determining whether multiple symbols 20 are aligned in the same column, it is preferable to make a judgment based on the second distance ΔH, as shown in FIG. 39, for example.

The number of symbols 20 aligned in the same column becomes the number of rows in that column (group). In step S78 of FIG. 44, the row and column processing unit 56 compares the number of rows (row count) in each group with the number of rows set in step S01. Then, if there is a group with a number of rows different from the setting, that group (column) is deleted.

Thus, the row and column processing unit 56 determines whether the rows and columns included in the target object 11 match the format information 65, and deletes the rows and columns that do not match the format information 65. The output unit 12 of the optical information reading device 10 outputs the structured data 49 of the rows and columns that the row and column processing unit 56 has determined to match the format information 65. At this time, the rows and columns deleted by the row and column processing unit 56 are not included in the structured data 49. Therefore, the output unit 12, based on the determination result of the row and column processing unit 56, outputs the structured data 49 excluding the rows and columns that do not match the format information 65.

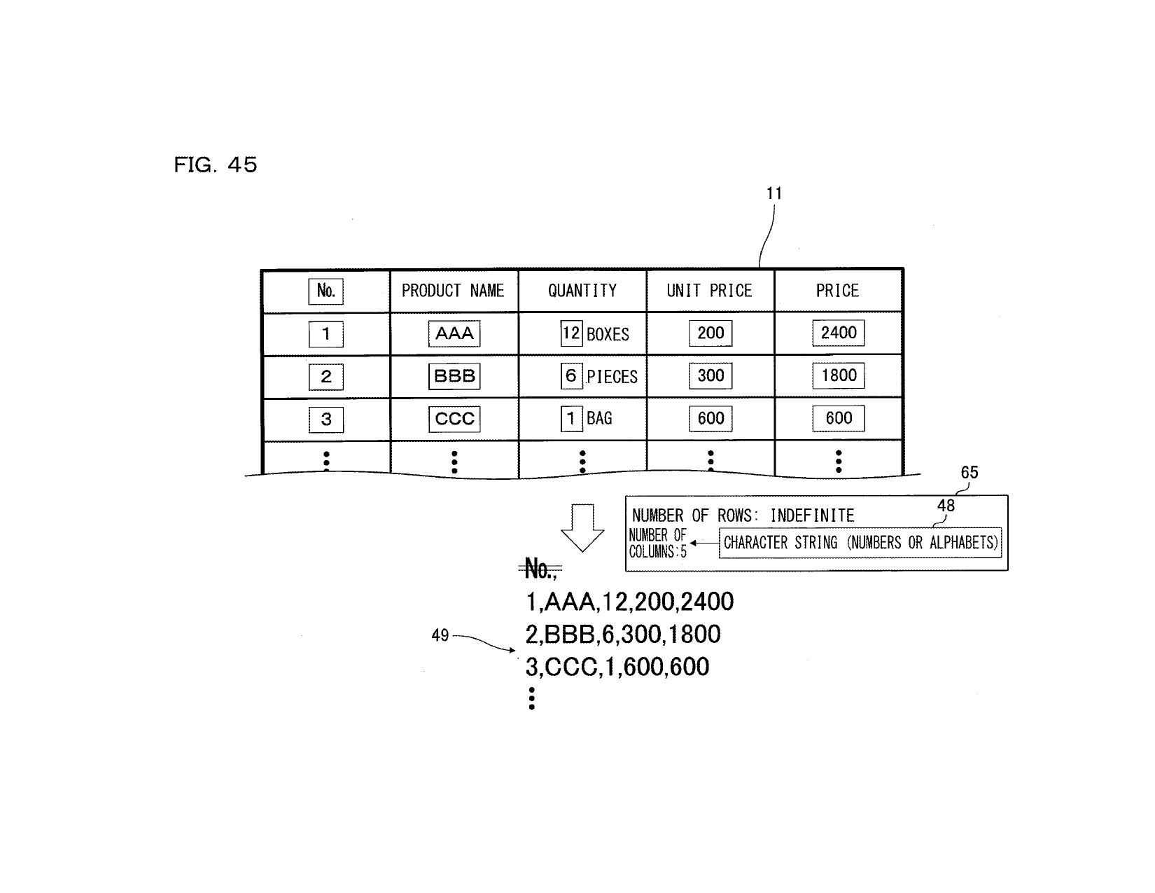

Referring to FIG. 45, an example where information that does not match the format information 65 is excluded from the structured data 49 will be explained. The object 11 shown in FIG. 45 has a matrix with 5 columns and an indefinite number of rows. Each field in the matrix of the object 11 contains numbers, alphabets, and kanji characters.

In FIG. 45, it is assumed that in the pre-settings related to rows and columns, the number of rows is set to "indefinite" and the number of columns is set to "5". And the format pattern 48 for each column is assumed to be set as a character string consisting of numbers or alphabets.

The row and column processing unit 56 obtains information for each row by reading the symbol information of character strings that match the format pattern 48. For example, information for one row in CSV format data using commas as separators is represented in a format such as "1,AAA,12,200,2400". This row has 5 columns, which matches the format information 65.

The target object 11 in FIG. 45 has fields (headers) indicating the names of data items, and one of the data item names includes the character string "No.". The row and column processing unit 56 determines that the character string "No." matches the format pattern 48, and acquires the information of the row represented as "No.," in CSV format. However, this row has only one column, so it does not match the format information 65. Therefore, the row and column processing unit 56 deletes the row represented as "No.,". Consequently, the row ("No.,") that does not match the format information 65 is excluded from the structured data 49 output by the output unit 12. This allows the output unit 12 to output structured data 49 that matches the format information 65 predetermined in the pre-setting.

In the above matrix processing, the row and column processing unit 56 determined whether multiple symbols 20 were aligned in the same column based on the second distance ΔH (FIG. 39) in the input image 62. However, whether multiple symbols 20 are aligned in the same column may be determined using the format pattern 48.

For example, when the target object 11 is captured from a distance, multiple symbols 20 aligned in the same column on the target object 11 may appear to be not aligned in the same column in the input image 62 due to perspective. In such cases, by using the format pattern 48 to determine whether multiple symbols 20 are aligned in the same column, the column direction is correctly identified.

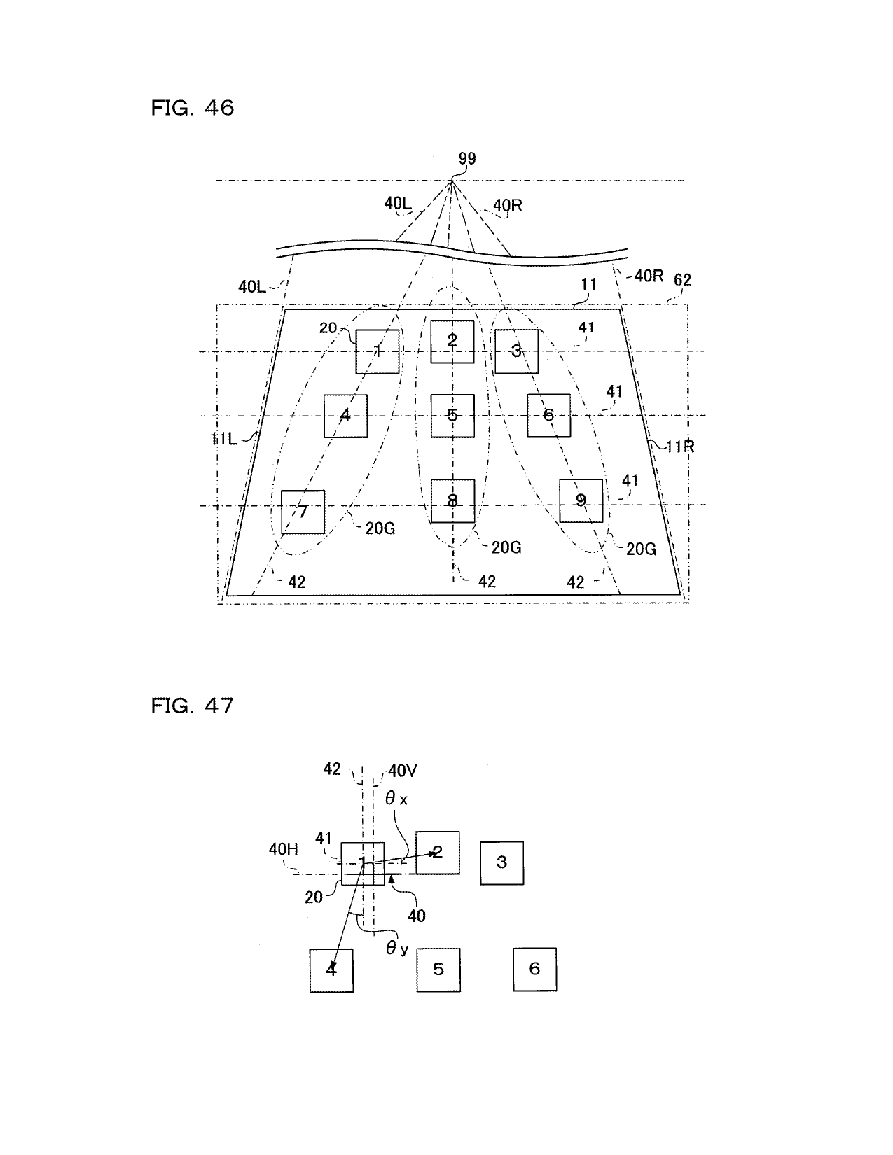

FIG. 46 is a diagram explaining matrix processing considering perspective. Multiple symbols 20 (in this case, nine) are attached to the target object 11 as a matrix aligned in row and column directions. However, when the target object 11 is imaged from a distance, in the input image 62, the symbols 20 on the front side (lower side in FIG. 46) appear to be spread out in the left-right direction due to perspective, compared to the symbols 20 on the back side (upper side in FIG. 46), and may not appear to be aligned in the same column as the symbols 20 on the back side.

The target object 11 shown in FIG. 46 is originally a rectangular paper surface, but appears as a trapezoid in the input image 62 due to being captured from a distance. Here, for the purpose of explanation, the shape of the target object 11 is shown to appear significantly deformed from its original shape in the input image 62.

In such a case, it is preferable for the row and column processing unit 56 to determine whether multiple symbols 20 are aligned in the same column using the format pattern 48. Specifically, first, as in FIG. 38, the row and column processing unit 56 identifies the row direction (identifies multiple symbols 20 aligned in the same row) by calculating the first distance ΔV. The effect of perspective on the first distance ΔV is small, and the row and column processing unit 56 can correctly identify the row direction (direction of the first line 41).

After one of the row direction and column direction (in the example of FIG. 46, the row direction) is specified, the row and column processing unit 56 groups multiple symbols that match the format pattern 48 in the input image 62 as a symbol group 20G. Then, a straight line connecting this symbol group 20G is set as the second line 42. The row and column processing unit 56 then calculates the second distance ΔH between the second line 42 and each character string to specify the other of the row direction and column direction (in the example of FIG. 46, specifying multiple symbols 20 aligned in the same column). The symbol 20 is at least either a character string or a code (barcode, two-dimensional code, etc.) in which symbol information is encoded.

Furthermore, the straight line connecting the symbol group 20G refers to a straight line connecting multiple symbols (such as character strings, etc.) included in the symbol group 20G. If there are two symbols included in the symbol group 20G, the second line 42 becomes a straight line connecting the reference points (for example, the centers) of each symbol. In the case where there are three or more symbols included in the symbol group 20G, it would be preferable to draw the most appropriate second line 42 using methods such as the least squares method, so that the distance between the second line 42 and the reference points of each symbol becomes as small as possible.

Multiple symbols (such as character strings) that match the format pattern 48 preset in the pre-settings are likely to be aligned in the same column. Therefore, by identifying multiple symbols 20 aligned in the same column as described above, even when the target object 11 is imaged from a distance, the row and column processing unit 56 can correctly acquire the symbol information represented by multiple symbols 20 arranged in rows and columns as structured data 49.

For example, when symbol 20 is a character string, if the format of the character string is specified as format pattern 48, the row and column processing unit 56 can determine multiple character strings that match the format specified by format pattern 48 as character strings aligned in the same column. Additionally, even when symbol 20 is not a character string, the row and column processing unit 56 should use format pattern 48 to determine whether multiple symbols 20 are aligned in the same column. For instance, multiple symbols 20 representing encoded codes (e.g., barcodes) that match the standard type (e.g., CODE128) specified in format pattern 48 should be determined to be aligned in the same column. In this case, the calculation of the second distance ΔH may not be necessary. Moreover, in the above example, the explanation was based on the order where the row and column processing unit 56 first identifies the row direction based on the direction indicated by the aimer light 40, and then identifies the column direction using format pattern 48, but this is not limiting. The order may be such that the row and column processing unit 56 first identifies the column direction based on the direction indicated by the aimer light 40, and then identifies the row direction using format pattern 48. In this case, the row and column processing unit 56 can identify the row direction by sequentially searching for symbols 20 that match the format, number of digits, or code type specified for each column.

Furthermore, as shown in FIG. 46, when the target object 11 appears to be a trapezoid in the input image 62, the row and column processing unit 56 may perform projective transformation on the input image 62. Projective transformation is a process that converts the original coordinate system to a different coordinate system. In this case, through projective transformation, the coordinates of each symbol within the target object 11 that appears trapezoidal are converted to coordinates within the originally rectangular target object 11.

When the target object 11 appears to be trapezoidal in the input image 62, it is considered that a virtual line 40L extending the left edge 11L of the target object 11 in the input image 62 and a virtual line 40R extending the right edge 11R intersect at a vanishing point 99 at infinity. Similarly, it is considered that multiple second lines 42 connecting symbols 20 aligned in the column direction also intersect at the vanishing point 99.

Therefore, the matrix processing unit 56 acquires the coordinates of the four corners of the target object 11 in the input image 62. The matrix processing unit 56 can, for example, identify the coordinates of the four corners of the target object 11 by detecting positions where the contrast change becomes large (edges) in the input image 62. Furthermore, in the case where the matrix attached to the target object 11 is a matrix surrounded by ruled lines, the coordinates of the four corners of the ruled lines may be used instead of the coordinates of the four corners of the target object 11.

The row and column processing unit 56 calculates a projective transformation matrix necessary for projective transformation so that the coordinates of the four corners of the target object 11 are converted to the coordinates of the four corners of the input image 62. In the coordinate system after the projective transformation using the calculated projective transformation matrix, the virtual line 40L, the virtual line 40R, and multiple second lines 42 become parallel, and as in FIG. 39, it becomes possible to specify the column direction using the second distance ΔH.

Furthermore, the row and column processing unit 56 may perform row direction identification (identification of symbols 20 aligned in the same row) and column direction identification (identification of symbols 20 aligned in the same column) by considering the angle between symbols 20 instead of the distance between symbols 20.

FIG. 47 is a figure explaining matrix processing considering the angle between symbols 20. The matrix processing unit 56 draws a first line 41 parallel to the first direction 40H of the aimer light 40, and a second line 42 parallel to the second direction 40V intersecting the first direction 40H, passing through the reference point (for example, the center) of the symbol 20.

The row and column processing unit 56 calculates a first angle θx formed by the line segment connecting the reference points of the two symbols 20 and the first line 41. If this first angle θx is sufficiently small (for example, below a predetermined threshold), it is determined that the two symbols 20 are aligned in the same row.

Furthermore, the row and column processing unit 56 calculates a second angle θy formed by the line segment connecting the reference points of two symbols 20 and the second line 42. If this second angle θy is sufficiently small (for example, falls below a predetermined threshold), the two symbols 20 are determined to be aligned in the same column. Moreover, in the identification of row direction and column direction, both the distance and angle between symbols 20 may be considered.

Further features of the embodiment related to the present disclosure are defined by the following numbered sentences:

Clause 1. An optical information reading device that captures an image of an object on which multiple symbols are arranged in a matrix with rows aligned in a row direction and columns aligned in a column direction intersecting the row direction, and reads symbol information represented by the multiple symbols, comprising:

an aimer light irradiation unit that irradiates aimer light extending in a first direction intersecting an irradiation direction toward the object;

an imaging unit having an imaging field of view toward the irradiation direction and generating an input image containing the symbols attached to the object by capturing an area within the imaging field of view;

a row and column processing unit that executes row and column processing based on the input image;

an output unit that outputs the symbol information represented by the multiple symbols

attached to the object as a structured data of the matrix structured based on the result of the row and column processing by the row and column processing unit;

wherein the row and column processing unit:

detects the multiple symbols included in the input image by executing image processing on the input image,

for every two of the multiple symbols as a first symbol and a second symbol,

calculates a first distance between a first line and the second symbol, the firs line passing through a first reference point defined for the first symbol and parallel to the first direction,

calculates a second distance between a second line and the second symbol, the second line passing through a second reference point defined for the first symbol and intersecting the first direction,

determines whether the first symbol and the second symbol are aligned in the same row in the matrix and whether the first symbol and the second symbol are aligned in the same column in the matrix based on the first distance and the second distance between the first symbol and the second symbol, thereby identifying the row and column where each of the multiple symbols is positioned in the matrix, and

the output unit outputs the symbol information represented by the multiple symbols as the structured data of the matrix based on the row and column identified by the row and column processing unit.

Clause 2. An optical information reading device that captures an image of an object on which multiple symbols are arranged in a matrix with rows aligned in a row direction and columns aligned in a column direction intersecting the row direction, and reads symbol information represented by the multiple symbols, comprising:

an imaging unit that generates an input image containing the symbols attached to the object by capturing an area within an imaging field of view;

a display unit that displays the input image and superimposes a virtual aimer extending in a first direction on the input image to define a aiming position;

a row and column processing unit that executes row and column processing based on the input image;

an output unit that outputs the symbol information represented by the multiple symbols attached to the object as structured data of the matrix structured based on the result of the row and column processing by the row and column processing unit;

wherein the row and column processing unit:

detects the multiple symbols included in the input image by executing image

processing on the input image,

for every two of the multiple symbols as a first symbol and a second symbol,

calculates a first distance between a first line passing through a first reference point defined for the first symbol and parallel to the first direction, and the second symbol,

calculates a second distance between a second line passing through a second reference point defined for the first symbol and intersecting the first direction, and the second symbol,

determines whether the first symbol and the second symbol are aligned in the same row in the matrix and whether the first symbol and the second symbol are aligned in the same column in the matrix based on the first distance and the second distance between the first symbol and the second symbol, thereby identifying the row and column where each of the multiple symbols is positioned in the matrix, and

the output unit outputs the symbol information represented by the multiple symbols as the structured data of the matrix based on the row and column identified by the row and column processing unit.

Clause 3. The optical information reading device according to clause 1 or 2, further comprising a format information acquisition unit that acquires format information including the number of rows and the number of columns contained in the object,

wherein the row and column processing unit determines whether the identified rows and columns match the format information, and

the output unit outputs the structured data excluding the rows and columns that do not match the format information based on the determination result of the row and column processing unit.

Clause 4. The optical information reading device according to clause 3, wherein the format information includes format patterns to be read for each of the columns.

Clause 5. The optical information reading device according to clause 4, wherein the row and column processing unit identifies one of the row direction and the column direction by calculating the first distance, and then identifies the other of the row direction and the column direction by calculating the second distance using a line connecting a group of symbols matching the format pattern as the second line.

Clause 6. The optical information reading device according to clause 1 or 2, further comprising a storage unit that stores a user application cooperating with the imaging unit and the row and column processing unit and used for collation processing, and the structured data,

wherein the user application uses the structured data as master data for the collation processing

and confirms whether information obtained by the imaging unit and the row and column processing unit is included in the master data.

Clause 7. The optical information reading device according to clause 1 or 2, wherein the multiple symbols are character strings, and the row and column processing unit: detects multiple characters and obtains multiple concatenated character strings by concatenating the multiple characters based on the positions and sizes of the multiple characters.

Clause 8. The optical information reading device according to clause 7, wherein the row and column processing unit sorts the detected multiple characters in order of alignment in an X direction corresponding to the first direction and in order of alignment in a Y direction perpendicular to the X direction, and selects at least two characters aligned continuously along the X direction or the Y direction as candidates for determining whether to concatenate.

Clause 9. The optical information reading device according to clause 1 or 2, wherein the row and column processing unit:

calculates an orientation of at least one of the multiple symbols,

calculates an angle formed between the calculated orientation and the first direction, and

executes rotation correction on at least one of the input image and the coordinates of the symbols based on the calculated angle.

Clause 10. An optical information reading device that captures an image of an object on which multiple symbols are arranged in a matrix with rows aligned in a row direction and columns aligned in a column direction intersecting the row direction, and reads symbol information represented by the multiple symbols, comprising:

an aimer light irradiation unit that irradiates aimer light extending in a first direction intersecting an irradiation direction toward the object;

an imaging unit having an imaging field of view toward the irradiation direction and generating an input image containing the symbols attached to the object by capturing an area within the imaging field of view;

a row and column processing unit that executes row and column processing based on the input image;

an output unit that outputs the symbol information represented by the multiple symbols attached to the object as structured data of the matrix structured based on the result of the row and column processing by the row and column processing unit;

a storage unit that stores format information including format patterns to be read for each of the columns of the matrix;

wherein the row and column processing unit:

detects the multiple symbols included in the input image by executing the row and column processing on the input image,

for every two of the multiple symbols as a first symbol and a second symbol,

calculates a first distance between a first line passing through a first reference point defined for the first symbol and parallel to the first direction, and the second symbol,

determines whether the first symbol and the second symbol are aligned in one of the same row and the same column in the matrix based on the first distance between the first symbol and the second symbol, thereby identifying one of the same row and the same column where each of the multiple symbols is positioned in the matrix,

estimates that the symbols matching the format pattern are positioned in the other of the same row and the same column in the matrix, and

the output unit outputs the symbol information represented by the multiple symbols as the structured data of the matrix based on the row and column identified by the row and column processing unit.

Clause 11. An optical information reading device that captures an image of an object on which multiple symbols are arranged in a matrix with rows aligned in a row direction and columns aligned in a column direction intersecting the row direction, and reads symbol information represented by the multiple symbols, comprising:

an imaging unit that generates an input image containing the symbols attached to the object by capturing an area within an imaging field of view;

a display unit that displays the input image and superimposes a virtual aimer extending in a first direction on the input image to define a aiming position;

a row and column processing unit that executes row and column processing based on the input image;

an output unit that outputs the symbol information represented by the multiple symbols attached to the object as structured data of the matrix structured based on the result of the row and column processing by the row and column processing unit;

a storage unit that stores format information including format patterns to be read for each of the columns of the matrix;

wherein the row and column processing unit:

detects the multiple symbols included in the input image by executing the row and column processing on the input image,

for every two of the multiple symbols as a first symbol and a second symbol,

calculates a first distance between a first line passing through a first reference point defined for the first symbol and parallel to the first direction, and the second symbol,

determines whether the first symbol and the second symbol are aligned in one of the same row and the same column in the matrix based on the first distance between the first symbol and the second symbol, thereby identifying one of the same row and the same column where each of the multiple symbols is positioned in the matrix,

estimates that the symbols matching the format pattern are positioned in the other of the same row and the same column in the matrix, and

the output unit outputs the symbol information represented by the multiple symbols as the structured data of the matrix based on the row and column identified by the row and column processing unit.

Meanwhile, the embodiments are exemplary in all aspects and not limiting. The scope of the present disclosure is indicated not by the foregoing description but by the claims, and it is intended to include all modifications within the meaning and scope equivalent to the claims. Among the configurations described in the embodiments, those other than the configurations described as one aspect of the present disclosure in the "Means for Solving the Problem" are optional configurations and can be deleted or modified as appropriate.

The present disclosure provides an optical information reading device and has industrial applicability.

What is claimed is:

1. An optical information reading device that sets a aiming position on a target object with multiple character strings attached, captures an image, and reads at least one character string, comprising:
an imaging unit that captures an area within an imaging field of view and generates an input image containing the multiple character strings attached to the target object;
a storage unit that stores a machine learning model that detects multiple characters contained in the input image;
a character string processing unit that obtains multiple character string candidates from the input image based on the multiple characters detected by the machine learning model;
wherein the character string processing unit narrows down the multiple character string candidates to an output character string to be output based on at least one of a character string likelihood indicating a plausibility as a character string, a distance to the aiming position in the input image, or a degree of matching with a format pattern predetermined by a user, for each of the multiple character string candidates.

2. The optical information reading device according to claim 1, further comprising an aimer light irradiation unit that irradiates an aimer light defining the aiming position in an irradiation direction towards the target object within the imaging field of view.

3. The optical information reading device according to claim 1, further comprising:
a display unit that displays an image generated by the imaging unit,
wherein the display unit superimposes a virtual aimer defining the aiming position on the image generated by the imaging unit.

4. The optical information reading device according to claim 1, wherein
the character string processing unit narrows down the multiple character string candidates to the output character string based on at least one of the character string likelihood or the distance to the aiming position, for at least one character string candidate whose degree of matching with the format pattern exceeds a predetermined matching degree threshold.

5. The optical information reading device according to claim 4, wherein
when there are plural character string candidates whose degree of matching with the format pattern exceeds the matching degree threshold and whose character string likelihood exceeds a predetermined likelihood threshold, the character string processing unit selects, from the plural character string candidates, one character string candidate with a shortest distance to the aiming position as the output character string.

6. The optical information reading device according to claim 4, wherein
the character string processing unit:
calculates a character string position likelihood as a composite score based on the character string likelihood and the distance to the aiming position for the character string candidate whose degree of matching with the format pattern exceeds the matching degree threshold, and
sets the character string candidate with the highest character string position likelihood as the output character string.

7. The optical information reading device according to claim 1, wherein
the character string processing unit:
sorts the multiple character string candidates in order of shorter distance to the aiming position,
for each of the multiple character string candidates, in the sorted order, determines whether the degree of matching with the format pattern exceeds a predetermined matching degree threshold and whether the character string likelihood exceeds a predetermined likelihood threshold, and
when a character string candidate whose degree of matching with the format pattern exceeds the matching degree threshold and whose character string likelihood also exceeds the likelihood threshold is found, sets that character string candidate as the output character string.

8. The optical information reading device according to claim 1, wherein the character string processing unit calculates the character string likelihood using a result of evaluating each of the multiple character string candidates based on predetermined likelihood conditions.

9. The optical information reading device according to claim 8, wherein the character string processing unit calculates the character string likelihood based on at least one of:
a score indicating character likelihood output by the machine learning model,
at least one of spacing, height, or contrast variation of each character included in the character string candidate,
size of blank areas before and after an arrangement of characters included in the character string candidate,
reading history information, which is information related to previously read character strings, or
information related to dates,
as the likelihood conditions.

10. The optical information reading device according to claim 1, wherein
the machine learning model includes a first model and a second model having a larger number of parameters than the first model,
the character string processing unit
calculates a string confidence indicating an appropriateness as the output character string for a first plurality of character string candidates obtained from the input image using the first model, and
obtains a second plurality of character string candidates from the input image using the second model, when the string confidence does not exceed a predetermined confidence threshold.

11. The optical information reading device according to claim 10,
wherein the character string processing unit evaluates that the string confidence of the character string candidate is higher as the distance between the aiming position and the character string candidate in the input image is closer.

12. The optical information reading device according to claim 2, wherein
the aimer light is a light extending in a first direction intersecting the irradiation direction, and
the character string processing unit narrows down the multiple character string candidates to the output character string based on a degree of agreement between an extending direction of the character string candidate and the first direction, and the distance between the character string candidate and the aiming position in the input image.

13. The optical information reading device according to claim 1, wherein the machine learning model detects multiple characters included in the input image and outputs a position and a size of each of the detected multiple characters, and the character string processing unit obtains the multiple character string candidates by concatenating the multiple characters based on the position and the size of the multiple characters.

14. The optical information reading device according to claim 13, wherein
the character string processing unit has an AI processing core and multiple image processing cores corresponding to the AI processing core,
the AI processing core detects the multiple characters included in the input image using the machine learning model, and transmits information related to the detected multiple characters to the multiple image processing cores, and
the multiple image processing cores calculate the character string likelihood based on the information related to the detected multiple characters.
